(19) United States
(12) Patent Application Publication
(10) Pub. No.: US 2014/0197588 A1
(43) Pub. Date: Jul. 17, 2014

(54) TOOL GUIDE SYSTEMS AND RELATED METHODS

(71) Applicant: Premysl-Uhrik LLC, Littleton, CO (US)

(72) Inventors: Premysl Ducek, Aurora, CO (US); Craig Ulrich, Highlands Ranch, CO (US); Mark Woodward, Lakewood, CO (US)

(73) Assignee: Premysl-Uhrik LLC, Littleton, CO (US)

(21) Appl. No.: 14/212,615

(22) Filed: Mar. 14, 2014

Related U.S. Application Data
(63) Continuation-in-part of application No. 12/985,008, filed on Jan. 5, 2011.
(60) Provisional application No. 61/923,106, filed on Jan. 2, 2014.
(60) Provisional application No. 61/800,673, filed on Mar. 15, 2013.

(51) Int. Cl. B25H 1/02; B25H 1/10

(52) U.S. Cl. CPC B25H 1/02; B25H 1/10
USPC 269/290; 29/428

(57) ABSTRACT

Some embodiments include a system. The system includes a base member configured to be coupled a support structure, a multidirectional arm coupled to the base member, and a track coupled to the multidirectional arm. The track can be configured to receive a tool and can comprise a proximal end and a distal end opposite the proximal end. Other embodiments of related systems and methods are also disclosed.

### CROSS-REFERENCE TO RELATED APPLICATIONS

This application claims the benefit of U.S. Provisional Patent Application Ser. No. 61/923,106, filed Jan. 2, 2014, and U.S. Provisional Patent Application Ser. No. 61/800,673, filed Mar. 15, 2013. Further, this application is a continuation-in-part application of U.S. Non-Provisional patent application Ser. No. 12/985,008, filed Jan. 5, 2011. U.S. Non-Provisional patent application Ser. No. 12/985,008, U.S. Provisional Patent Application Ser. No. 61/923,106, and U.S. Provisional Patent Application Ser. No. 61/800,673 are incorporated herein by reference in their entirety.

### FIELD OF THE INVENTION

This invention relates generally to a tool guide system, and relates more particularly to such a tool guide system permitting guided movement of a tool about a working plan in multiple directions, and methods of providing the same.

### DESCRIPTION OF THE BACKGROUND

A need or potential for benefit exists for a tool guide that can permit guided movement of a tool about a working plane in multiple directions.

### BRIEF DESCRIPTION OF THE DRAWINGS

To facilitate further description of the embodiments, the following drawings are provided in which:

FIG. 1 illustrates a partial perspective view of a work table, according to an embodiment;

FIG. 2 illustrates a perspective view of one end of an exemplary support member, according to the embodiment of FIG. 1;

FIG. 3 illustrates a perspective view of an other end of the exemplary support member, according to the embodiment of FIG. 1;

FIGS. 4A-4D illustrate cross sectional views of various embodiments of a support member;

FIG. 5A illustrates a cross sectional view taken along section line 5A-5A of FIG. 5B of an exemplary clamp engaged with the exemplary support member, the clamp being configured to clamp a work piece to the support member, according to the embodiment of FIG. 4C;

FIG. 5B illustrates a side view of the exemplary clamp engaged with the exemplary support member, according to the embodiment of FIG. 4C;

FIG. 6 illustrates a perspective view of a work table, according to another embodiment;

FIG. 7 illustrates a partial top view of the work table when configured in an exemplary extended position, according to the embodiment of FIG. 6;

FIG. 8 illustrates a rear, side view of the work table, according to the embodiment of FIG. 6;

FIGS. 9 & 10 illustrate additional partial top views of the work table progressing between being configured in the exemplary extended position to an exemplary collapsed position, according to the embodiment of FIG. 6;

FIG. 11 illustrates a partial top view of the work table when configured in the exemplary collapsed position, according to the embodiment of FIG. 6;

FIG. 12 illustrates a partial top view of the work table supporting a work piece indexed with respect to the work table and including first and second attachment members of an exemplary first tool guide attached to opposite ends of the work table, according to the embodiment of FIG. 6;

FIG. 13 illustrates a cross sectional view of the first attachment member taken along section line 13-13 of FIG. 12, according to the embodiment of FIG. 6;

FIG. 14 is a partial top view of the work table including an exemplary first tool guide track of the first tool guide engaged with the first and second attachment members, according to the embodiment of FIG. 6;

FIG. 15 illustrates a partial left side view of the work table including the first tool guide track engaged with the first and second attachment members, according to the embodiment of FIG. 6;

FIG. 16 illustrates a partial top view of an exemplary second tool guide attached to the work table, according to the embodiment of FIG. 6;

FIG. 17A illustrates a partial left side view of the second tool guide configured in an exemplary work position, according to the embodiment of FIG. 6;

FIG. 17B illustrates a partial left side view of the second tool guide configured in an exemplary auxiliary position, according to the embodiment of FIG. 6;

FIG. 18 illustrates a partial top view of an exemplary third tool guide attached to the work table, according to the embodiment of FIG. 6;

FIG. 19 illustrates a partial top view of an exemplary fourth tool guide attached to the work table, according to the embodiment of FIG. 6;

FIG. 20 illustrates a partial top view of the work table including an exemplary drop-in tool, according to the embodiment of FIG. 6;

FIG. 21 illustrates a partially exploded perspective view of an exemplary tool attachment member, according to the embodiment of FIG. 6;

FIG. 22A illustrates a left side view of an exemplary longitudinal index member of the work table in a retracted position, according to the embodiment of FIG. 6;

FIG. 22B illustrates a left side view of the exemplary longitudinal index member of the work table in an extended position, according to the embodiment of FIG. 6;

FIG. 23 illustrates a partial top view of a work table configured in an exemplary collapsed position, according to an embodiment;

FIG. 24 illustrates a top, front, ride side view of a support structure of a system when the support structure is configured in a support structure extended configuration, according to an embodiment;

FIG. 25 illustrates a top, front, ride side view of the support structure when the support structure is configured in a support structure collapsed configuration, according to the embodiment of FIG. 24;

FIG. 26 illustrates a top, front, ride side view of a work table of the system configured in a work table resting configuration, according to the embodiment of FIG. 24;

FIG. 27 illustrates a cross member, according to an embodiment;

FIG. 28 illustrates a cross member proximal coupling mechanism coupled to a cross member and configured in an active configuration, according to an embodiment;

FIG. 29 illustrates a ride side view of the work table of the system configured in a work table angled configuration of one or more work table angled configurations, according to the embodiment of FIG. 24;

FIG. 30 illustrates a partial right side view of the work table of the system implementing a first tool guide, according to the embodiment of FIG. 24;

FIG. 31 illustrates a top, front, ride side view of the work table of the system implementing the first tool guide, according to the embodiment of FIG. 24;

FIG. 32 illustrates a perspective view of a left tool guide receiver of the first tool guide when the left tool guide receiver is decoupled from the work table, according to the embodiment of FIG. 24;

FIG. 33 illustrates a top view of the work table of the system implementing a second tool guide when a work piece is disposed over the work table, according to the embodiment of FIG. 24;

FIG. 34 illustrates a front, top, right side view of the work table of the system implementing a vacuum accessory element and the first tool guide when the work piece is disposed over the work table, according to the embodiment of FIG. 24;

FIG. 35 illustrates a perspective view of a vacuum hose of the vacuum accessory element coupled to a boom arm of the vacuum accessory element, according to the embodiment of FIG. 24;

FIG. 36 illustrates a perspective view of a boom mount of the vacuum accessory element coupled to a second member of the support structure, according to the embodiment of FIG. 24;

FIG. 37 illustrates a top, front, ride side view of the work table of the system implementing multiple surface inserts, according to the embodiment of FIG. 24;

FIG. 38 illustrates an exemplary sheet insert of the multiple sheet inserts coupled to a cross member, according to the embodiment of FIG. 24;

FIG. 39 illustrates a front, top, right side view of a base structure, according to an embodiment;

FIG. 40 illustrates a top, front, ride side view of a system, according to an embodiment;

FIG. 41 illustrates a perspective view of a second vacuum accessory element, according to an embodiment;

FIG. 42 illustrates a perspective view of a system, according to an embodiment;

FIG. 43 illustrates a front, top, right side view of a tool guide when the tool guide is decoupled from a support structure, according to the embodiment of FIG. 42;

FIG. 44 illustrates a base member of the tool guide of FIG. 43 securely coupled to the support structure when a first coupling member and a second coupling member of the base member are engaged, according to the embodiment of FIG. 42;

FIG. 45 illustrates the base member of FIG. 44 coupled to the support structure in an unsecured manner when the first coupling member and the second coupling member of the base member are disengaged, according to the embodiment of FIG. 42;

FIG. 46 illustrates a coupling channel of a track of the tool guide of FIG. 43 decoupled from a track locking mechanism of a track stand of the tool guide, according to the embodiment of FIG. 42;

FIG. 47 illustrates a cross sectional view of the track of FIG. 46 taken along line 47-47 in FIG. 46 showing first and second extension(s) of the coupling channel of the track and showing a tool channel of the track, according to the embodiment of FIG. 42;

FIG. 48 illustrates a rear, bottom, left side view of the tool guide of FIG. 43 when the tool guide is decoupled from a support structure, according to the embodiment of FIG. 42;

FIG. 49 illustrates a front, top, left side view of a longitudinal index member of the system of FIG. 42 when the longitudinal index member is decoupled from a support structure, according to the embodiment of FIG. 42;

FIG. 50 illustrates a tool guide of a system coupled to a support structure of a saw horse, according to an embodiment;

FIG. 51 illustrates a tool guide of a system coupled to a support structure of a work table, according to an embodiment;

FIG. 52 illustrates a flow chart for an embodiment of a method of providing a system;

FIG. 53 illustrates an exemplary activity of providing a tool guide, according to the embodiment of FIG. 52;

FIG. 54 illustrates an exemplary activity of providing a base member, according to the embodiment of FIG. 53;

FIG. 55 illustrates an exemplary activity of providing a multidirectional arm, according to the embodiment of FIG. 53;

FIG. 56 illustrates an exemplary activity of providing a track, according to the embodiment of FIG. 53;

FIG. 57 illustrates a cross sectional view of the cross member of FIG. 27 taken along line 57-57 of FIG. 27, according to the embodiment of FIG. 27;

FIG. 58 illustrates the cross member proximal coupling mechanism of FIG. 28 in the active configuration, coupling the cross member to a member, according to the embodiment of FIG. 28;

FIG. 59 illustrates the cross member proximal coupling mechanism of FIG. 28 coupled to the cross member and configured in an inactive configuration, according to the embodiment of FIG. 28; and

FIG. 60 illustrates cross members coupled between sidewalls of a truck bed of a vehicle, according to an embodiment.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

In many embodiments, the terms “left,” “right,” “front,” “back,” “top,” “bottom,” “over,” “under,” “proximal,” “distal,” “lateral,” “laterally,” “longitudinal,” “longitudinally,” and the like in the description and in the claims, if any, may be used for descriptive purposes and not necessarily for describing permanent relative positions and/or directions. It is to be understood that the terms so used are interchangeable under appropriate circumstances such that the embodiments of the invention described herein are, for example, capable of operation in other orientations than those illustrated or otherwise described herein. Further, in various embodiments, one or more of these terms and the like in the description and in the claims, if any, may be used for associative descriptive purposes so as to indicate an association between like or similarly modified elements.

The terms “couple,” “coupled,” “couples,” “coupling,” and the like should be broadly understood and refer to connecting two or more elements or signals, electrically, mechanically and/or otherwise. Two or more electrical elements may be electrically coupled but not be mechanically or otherwise coupled; two or more mechanical elements may be mechanically coupled, but not be electrically or otherwise coupled; two or more electrical elements may be mechanically coupled, but not be electrically or otherwise coupled. Coupling may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

The absence of the word “removably,” “removable,” and the like near the word “coupled,” and the like does not mean that the coupling, etc. in question is or is not removable.

### DETAILED DESCRIPTION

Some embodiments include a work table. The work table can comprise a frame having laterally extending, opposing side members. The frame can comprise a tool guide retention member that extends along at least a portion of the frame. The work table also can comprise multiple support members that can be removably coupled to the opposing side members. The support members can extend between the opposing side members. Each of the support members can be lockably positionable along substantially an entire length of the opposing side members. The support members can be adapted to support a work piece in a working plane when attached to the opposing side members.

Further, a number of feature refinements and additional features can be provided with the work table. These features can be, but need not be, used in any particular combination with any other features provided herein.

For example, the work table also can comprise at least one tool guide. The tool guide(s) can be engageable with the tool guide retention member so as to secure the tool guide(s) to the frame. Further, the work table can comprise at least one selectively positionable work piece index member attached to the frame. The work piece index member(s) can each have an extended position and a retracted position. When in the extended position, the work piece index member(s) can extend through the working plane. Further, when in the retracted position, the work piece index member(s) may not extend through the working plane.

In some embodiments, the tool guide retention member can comprise a channel. The channel can be engaged by a first tool guide of the tool guide(s) to dispose a tool with respect to the frame. The first tool guide can comprise first and second guide members that are each moveably engageable with the frame. The first guide member and second guide member can engage a first tool track to dispose the first tool track between the first guide member and second guide member. The first and second guide members can comprise posts (e.g., extending through the working plane) that have a narrowed end that is engageable with the first tool track to maintain the first tool track in a relative position with respect to the work table.

In further embodiments, the tool guide(s) can comprise a second tool guide. The second tool guide can comprise a cantilevered tool track extending from a base member that can be engaged with the channel to retain the base member against the frame. The cantilevered tool track can be configured in a work position such that the cantilevered tool track extends in a plane substantially parallel to the working plane (e.g., the cantilevered tool track may lay flush against the surface of the work piece). Additionally, the second tool guide can comprise a pivot member coupling the cantilevered tool track to the base member. In these embodiments, the cantilevered tool track can be moveable by the pivot member from the work position to an auxiliary position such that the cantilevered tool track extends away from the working plane.

In many embodiments, at least one of the support members can comprise a groove extending along at least a portion of the support member. The groove can receive an attachment member of a clamp engageable with the groove and a clamping member operatively connected to the attachment member. The clamping member may be contactable with the work piece to urge the work piece against the at least one support member.

In still further embodiment, the tool guide(s) can comprise a third tool guide. The third tool guide can comprise a post member to which a tool can be coupled and rotated about the work piece.

Further, the support members can comprise a wooden work piece contact surface such that the support member has a surface adjacent to the working plane that has similar physical properties (e.g., hardness) to the work piece.

Other embodiments include a collapsible work table. The collapsible work table comprises a rectangular frame that has a slideable side that is slidingly engaged with a first and a second end member. The sliding side can be positioned in a collapsed position and an extended position along the length of the first and second end members. The first and second end members are pivotal with respect to a stationary side positioned parallel with and/or proximate to the slideable side when the slideable side is in the collapsed position. The collapsible work table also comprises multiple support members that are attachable to the frame to extend between the slideable side and the stationary side of the frame when the slideable side is in the extended position. The support members can be adapted to support a work piece in a working plane.

Further, a number of feature refinements and additional features can be provided with the work table. These features can be, but need not be, used in any particular combination with any other features provided herein.

In various embodiment, when in the collapsed position, the slideable side can be positioned adjacent to the stationary side. Further, when in the extended position, the slideable side can be positioned in a spaced apart fashion from the stationary side member. The slideable side can comprise hinges at opposing ends of the slideable side. The hinges can be slidingly engageable with channels provided at the first and second end members, respectively.

In many embodiments, the collapsible work table also can comprise multiple base members. The base member can be attached to the stationary side. The base members can be moveable between a stowed position and a deployed position. Accordingly, when in the stowed position, the plurality of base members can be arranged substantially parallel and adjacent to the stationary side. Further, when in the deployed position, the base members can be substantially perpendicular to and extend away from the stationary side member. Also, the collapsible work table can comprise multiple projections extending from the slideable side. Each of the projections can receive one of the base members, respectively, when the base members are in the deployed position. The projections can situate the base members with respect to the slideable side.

Further still, the base members can comprise a “V” shaped portion. This “V” shaped portion can be adapted to coordinate with a correspondingly shaped recess in a stand upon which the collapsible work table can be positioned when then base members are in the deployed position.

Further embodiments include an attachment member. The attachment member can comprise a channel attachment member having a channel engagement member. The channel engagement member can be slideably disposable in a channel. The attachment member also can comprise a tool attachment member. The tool attachment member can have a tool clamping portion to secure a tool base with respect to the tool attachment member The channel attachment member and the tool attachment member can be adjustably positionable to vary a position of the tool attachment member with respect to the channel engagement member.

Further, a number of feature refinements and additional features can be provided with the work table. These features can be, but need not be, used in any particular combination with any other features provided herein.

For example, the channel engagement member can be deflectable with respect to the tool attachment member to secure the attachment member along a length of a channel in which the channel engagement member is disposed. Additionally, the channel attachment member and the tool attachment member can be adjustably positionable in a vertical dimension with respect to a work piece.

Meanwhile, some embodiments include a system. The system comprises a base member configured to be coupled to a support structure, a multidirectional arm coupled to the base member; and a track coupled to the multidirectional arm. The track can be configured to receive a tool. Further, the track can comprise a proximal end and a distal end opposite the proximal end. The system also comprises a working plane and a reference frame comprising an x-axis, a y-axis, and a z-axis. The x-axis and the y-axis can be approximately perpendicular to each other and approximately parallel to the working plane. Further, the z-axis can be approximately perpendicular to the x-axis, the y-axis, and the working plane. When the base member is coupled to the support structure: (i) the multidirectional arm can permit the track to be positioned over and approximately parallel to the working plane, (ii) the multidirectional arm can permit the track to be selectively rotated about the z-axis, and (iii) the multidirectional arm can permit the distal end of the track to be selectively rotated toward the z-axis from approximately parallel to the working plane.

Further embodiments include a method of providing a system. The system comprises a working plane and a reference frame comprising an x-axis, a y-axis, and a z-axis. Meanwhile, the x-axis and the y-axis can be approximately perpendicular to each other and approximately parallel to the working plane, and the z-axis can be approximately perpendicular to the x-axis, the y-axis, and the working plane. Further, the method can comprise: providing a base member configured to be coupled to a support structure; providing a multidirectional arm; coupling the multidirectional arm to the base member; providing a track, the track being configured to receive a tool and comprising a proximal end and a distal end opposite the proximal end; and coupling the track to the multidirectional arm. Further still, providing the multidirectional arm can comprise configuring the multidirectional arm such that when the base member is coupled to the support structure: (i) the multidirectional arm permits the track to be positioned over and approximately parallel to the working plane; the multidirectional arm permits the track to be selectively rotated about the z-axis; and the multidirectional arm permits the distal end of the track to be selectively rotated toward the z-axis from approximately parallel to the working plane.

Various embodiments include a system. The system comprises a tool guide, a working plane, and a reference frame. The tool guide comprises a base member configured to be coupled to a support structure. Further, the base member comprises at least one coupling member, and the support structure comprises at least one coupling receiver configured to receive the at least one coupling member to couple the base member to the support structure. The tool guide also comprises a multidirectional arm coupled to the base member and comprises a track coupled to the multidirectional arm. The track can being configured to receive a tool and can comprise a proximal end and a distal end opposite the proximal end. Further still, the reference frame comprises an x-axis, a y-axis, and a z-axis. The x-axis and the y-axis are approximately perpendicular to each other and approximately parallel to the working plane. Further, the z-axis is approximately perpendicular to the x-axis, the y-axis, and the working plane. When the base member is coupled to the support structure: (i) the multidirectional arm permits the track to be positioned over and approximately parallel to the working plane, (ii) the multidirectional arm permits the track to be selectively rotated about the z-axis, (iii) the multidirectional arm permits the distal end of the track to be selectively rotated toward the z-axis from approximately parallel to the working plane, (iv) the multidirectional arm permits a track height of the track to be selectively adjusted, and (v) the base member is configured to be selectively translated along the support structure. The track height can be an approximate distance of the track over the working plane when the track is approximately parallel to the working plane.

Furthermore, some embodiments include a system. The system comprises a cross member comprising a central member, a cross member proximal coupling mechanism, and a cross member distal coupling mechanism. The central member comprises a central member proximal end and a central member distal end opposite the central member proximal end. Further, the cross member proximal coupling mechanism can be coupled to the central member at the central member proximal end, and the cross member distal coupling mechanism can be coupled to the central member at the central member distal end. The cross member proximal coupling mechanism is configured to be coupled to a first structure comprising a first structure channel. Meanwhile, the first structure channel can be configured to receive the cross member proximal coupling mechanism when the cross member proximal coupling mechanism is coupled to the first structure. Likewise, the cross member distal coupling mechanism is configured to be coupled to a second structure comprising a second structure channel. Meanwhile, the second structure channel is configured to receive the cross member distal coupling mechanism when the cross member distal coupling mechanism is coupled to the second structure. The cross member proximal coupling mechanism can comprise a first locking mechanism. Further, the first locking mechanism can be operatively configured to apply pressure to the first structure in order to couple the cross member proximal coupling mechanism to the first structure and to lock cross member proximal coupling mechanism in position when cross member proximal coupling mechanism is coupled to the first structure.

Further embodiments include a system. The system comprises a cross member comprising a central member, a cross member proximal coupling mechanism, and a cross member distal coupling mechanism. The central member comprises a central member proximal end and a central member distal end opposite the central member proximal end. Further, the cross member proximal coupling mechanism can be coupled to the central member at the central member proximal end, and the cross member distal coupling mechanism can be coupled to the central member at the central member distal end. The cross member proximal coupling mechanism is configured to be coupled to a first structure and the cross member distal coupling mechanism is configured to be coupled to a second structure so that the central member extends between the first structure and the second structure. Meanwhile, the central member can comprise an extruded beam, the extruded beam can comprise at least one central member channel extending between the central member proximal end and the central member distal end, and the at least one central member channel can be configured to receive at least one sacrificial member configured to protect the central member.

Various embodiments include a system. The system comprises a cross member comprising a central member, a cross member proximal coupling mechanism, and a cross member distal coupling mechanism. The central member comprises a central member proximal end and a central member distal end opposite the central member proximal end. Further, the cross member proximal coupling mechanism can be coupled to the central member at the central member proximal end, and the cross member distal coupling mechanism can be coupled to the central member at the central member distal end. The cross member proximal coupling mechanism is configured to be coupled to a first structure comprising a first structure channel. Meanwhile, the first structure channel can be configured to receive the cross member proximal coupling mechanism when the cross member proximal coupling mechanism is coupled to the first structure. Likewise, the cross member distal coupling mechanism is configured to be coupled to a second structure comprising a second structure channel. Meanwhile, the second structure channel is configured to receive the cross member distal coupling mechanism when the cross member distal coupling mechanism is coupled to the second structure. The cross member proximal coupling mechanism can comprise a first locking mechanism. Further, the first locking mechanism can be operatively configured to apply pressure to the first structure in order to couple the cross member proximal coupling mechanism to the first structure and to lock cross member proximal coupling mechanism in position when cross member proximal coupling mechanism is coupled to the first structure. Meanwhile, the central member can comprise a first extruded beam; the first extruded beam can comprise a first central member channel and a second central member channel each extending between the central member proximal end and the central member distal end, the first central member channel can be configured to receive a first sacrificial member so that the first sacrificial member extends between the central member proximal end and the central member distal end, and the second central member channel can be configured to receive a second sacrificial member so that the second sacrificial member extends between the central member proximal end and the central member distal end. Also, the central member can be configured to support a work piece when the cross member proximal coupling mechanism is coupled to the first structure and the cross member distal coupling mechanism is coupled to the second structure, the work piece can be configured to be shaped by a tool; and the first sacrificial member and the second sacrificial member can be configured to protect the central member from the tool when the tool is shaping the work piece.

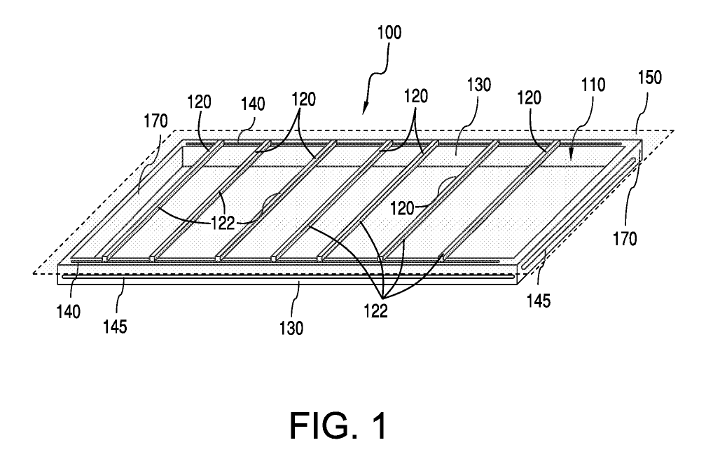

FIG. 1 illustrates a partial perspective view of work table 100, according to an embodiment. Work table 100 comprises frame 110. Frame 110 can define a perimeter of work table 100. In many embodiments, work table 100, frame 110, and/or the perimeter defined by frame 110 can comprise a generally rectangular shape or another regular shape (e.g. a square shape, a triangular shape, a pentagonal shape, etc.). Meanwhile, in other embodiments, work table 100, frame 110, and/or the perimeter defined by frame 110 can comprise an irregular shape or a non-closed shape, such as, for example, when one or more of longitudinally extending end members 170 are omitted.

Frame 110 can comprise one or more frame features (e.g., channels, grooves, etc.). Accordingly, in some embodiment, frame 110 can comprise an extruded material forming the one or more frame features. The frame features can be provided on one or more faces (e.g., each face) of the members of frame 110. The frame features can extend along part or all of a length of the face(s) of the members of frame 110. Frame 110 can comprise any suitable material, such as, for example, metal (e.g., aluminum, iron, titanium, etc.), metal alloy (e.g., steel, etc.), wood, polymer, composites (e.g., carbon fiber), etc. Work table 100 can be supported by any suitable structure. For example, work table 100 can be disposed upon multiple saw horses (not shown) to elevate and support work table 100. In other embodiments, work table 100 can be mounted to a structure, such as, for example, a wall.

Frame 110 can comprise opposing laterally extending side members 130. Also, longitudinally extending end members 170 can extend between laterally extending side members 130 at opposing ends of frame 110. In some embodiments, longitudinally extending end members 170 can be omitted. In other embodiments, longitudinally extending end members 170 are part of frame 110. One or both of laterally extending side members 130 and/or one or both of longitudinally extending end members 170 can comprise tool guide retention member 145. Tool guide retention member 145 can comprise a channel extending along at least a portion of frame 110. Tool guide retention member 145 can engage one or more tool guides in a manner as discussed in greater detail below. In many embodiments, the frame features of frame 110 can comprise tool guide retention member 145.

In many embodiments, laterally extending side members 130 can be approximately parallel to each other, and/or longitudinally extending side members 170 can be approximately parallel to each other. Meanwhile, in these or other embodiments, laterally extending side members 130 and longitudinally extending side members 170 can be approximately perpendicular to each other.

Work table 100 also can comprise multiple support members 120. Each of support members 120 can be similar or identical to each other. In further embodiments, one or more support members of support members 120 can be different from one or more other support members of support members 120.

Support members 120 can be removably attached (e.g., arbitrarily) to frame 110 and/or each other. Further, support members 120 can be lockably positionable (e.g., arbitrarily) along frame 110 and/or each other when attached to frame 110 and/or each other.

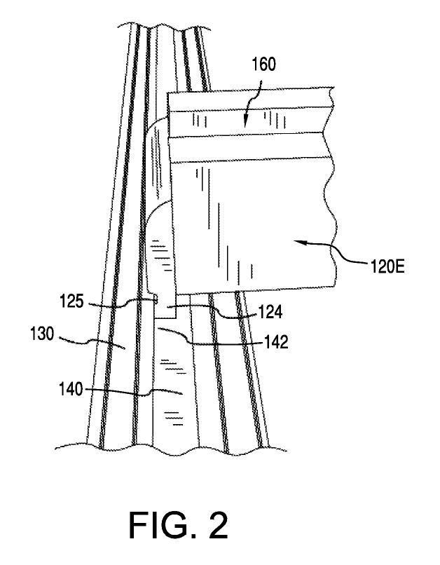

For example, in many embodiments, support members 120 can be removably attached to and/or lockably positionable along part or all of the length of laterally extending side members 130. In these or other embodiments, support members 120 can comprise tabs (e.g., tab 124 (FIGS. 2 & 3)) at each of the ends of support members 120. In specific embodiments, each tab can engage a support member attachment channel 140 provided at a respective one of laterally extending side members 130. Thus, in many examples, the location of support members 120 can be adjustable along the length of the side members 130 where the support member attachment channel 140 is provided. In turn, a user can arbitrarily position support members 120 where desired so that support members 120 are not limited to specific positions at frame 110 and/or each other. In these or other embodiments, support members 120 can be similarly removably attached to and/or lockably positionable along part or all of the length of longitudinally extending side members 170 and/or each other. In some embodiments, the frame features of frame 110 and/or tool guide retention member 145 can comprise support member attachment channel 140.

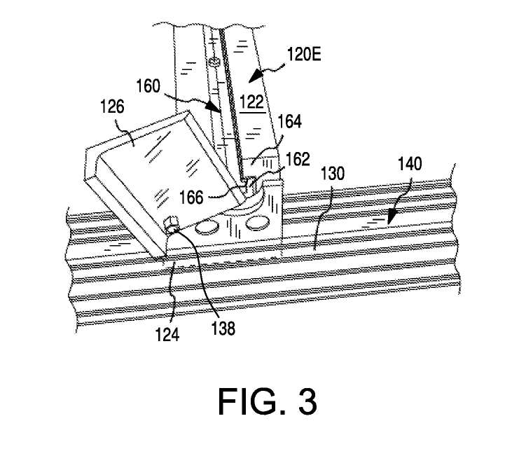

Meanwhile, each of support members 120 can comprise a locking mechanism (e.g., locking wedge 126 (FIG. 3)) configured to operably secure support members 120 to frame 110 and/or each other. For example, in some embodiments, in securing support members 120 to frame 110 and/or each other, the locking mechanism can be operable to prevent support members 120 from being detached from frame 110 and/or each other. Further, in these or other embodiments, in securing support members 120 to frame 110 and/or each other, the locking mechanism can be operable to lock support members 120 in the position(s) at which support members 120 are attached to frame 110 and/or each other.

Further, in these or other examples, when support member members 120 are attached to laterally extending side members 130, multiple support members 120 can extend between laterally extending side members 130, such as, for example, in a ladder configuration. In many embodiments, when multiple support members 120 extend between laterally extending side members 130, multiple support members 120 can be approximately parallel to each other and/or to longitudinally extending side members 170. Further, in these or other embodiments, multiple support members 120 can be approximately perpendicular to laterally extending side members 130.

Meanwhile, in various embodiments, one or more support members of support members 120 can be different from each other, for example, in length. These embodiments can be implemented, for example, when a distance between laterally extending side members 130 varies and where it is desirable to couple multiple ones of support members 120 between those laterally extending side members 130. Further, these embodiments can be implemented when coupling one or more support members of support members 120 between other support members of support members 120, for example, when a distance between the other support members differs from a distance between laterally extending side members 130.

In still other embodiments, support members 120 can be configured so that a length of one or more support members of multiple support members 120 can be adjusted. For example, in some embodiments, the support member(s) of multiple support members 120 can be telescopic such that the length of the support member(s) can be selectively increased or decreased.

Top surfaces 122 of support members 120 can coordinate to support a work piece above work table 100. The work piece can comprise any suitable material (e.g., wood, metal, polymer, ceramic, composite, etc.). Top surfaces 122 of support members 120 can each lie in or adjacent to working plane 150, in which the work piece (not shown at FIG. 1) is disposed when supported by work table 100. That is, working plane 150 can refer to a plane extending along an interface of a work piece and support members 120.

Support members 120 can comprise a sacrificial portion adjacent to the working plane 150. The sacrificial portions can be constructed of a material having physical properties similar or identical to the work piece. Accordingly, the sacrificial portions may comprise one or more material characteristics (e.g., hardness) similar to the work piece. For example, like the work piece, the material of the sacrificial portions can comprise wood, metal, polymer, ceramic, composite, etc. Accordingly, in the event that one or more sacrificial portions of support members 120 make contact with a tool (e.g., while support members 120 are supporting a work piece), damage to the tool and/or the remaining elements of support members 120 may be avoided. Also, damage to the work piece (e.g., scratching, scuffing, etc.) caused by a harder material contacting the work piece may be avoided. When the sacrificial portions of support members 120 have been sufficiently damaged and/or degraded, the damaged and/or degraded sacrificial portions can be replaced or resurfaced with minimal effort and cost.

In many embodiments, the material of the sacrificial portions can be selected such that the sacrificial portions can be manufactured by extrusion. Accordingly, as provided previously, polymer material(s) can be implemented for the material of the sacrificial portions. Using materials suitable for extrusion can permit the sacrificial portions to be rapidly and cheaply manufactured, which can be desirable for example, when sacrificial portions are replaceable.

In some embodiments, the material of the sacrificial portions also can comprise one or more material characteristics (e.g., coefficient of friction) different than the work piece. In these or other embodiments, the sacrificial portions can have a coefficient of friction that is greater than the work piece to assist with holding the work piece in place. However, in other embodiments, the coefficient of friction of the sacrificial portions and the work piece can be similar or identical to each other.

Turning ahead in the drawings, FIG. 2 illustrates a perspective view of one end of exemplary support member 120E of support members 120 (FIG. 1), according to the embodiment of FIG. 1. As indicated above, support member 120E can comprise a locking mechanism. The locking mechanism can be used to secure support member 120E to frame 110. For example, the locking mechanism can coordinate with one support member attachment channel 140 to lockably position support member 120E to frame 110. As shown in FIG. 2, a first end of support member 120E can be positioned such that tab 124 is disposable within support member attachment channel 140 at laterally extending side member 130. Tab 124 can comprise contour 125 that corresponds to support member attachment channel 140 so as to fit with projection 142 of support member attachment channel 140. In other embodiments, this first end of support member 120E can comprise a locking mechanism similar to the locking mechanism as shown at and described with respect to FIG. 3.

Turning ahead again in the drawings, FIG. 3 illustrates a perspective view of an other (e.g., opposite) end of support member 120E, according to the embodiment of FIG. 1. Tab 124 on this end of support member 120E can be disposed in support member attachment channel 140 (e.g., a second support member attachment channel 140) of laterally extending side member 130 (e.g., a second laterally extending side member 130). Locking wedge 126 can be provided on this end of support member 120E. Locking wedge 126 can comprise a generally tapered body and can pivot about pin 138. As such, locking wedge 126 can be pivoted about pin 138 such that a narrow end of locking wedge 126 is disposed into support member attachment channel 140 adjacent to tab 124. Upon advancement of locking wedge 126 into support member attachment channel 140, locking wedge 126 and tab 124 can act upon support member attachment channel 140 to lock support member 120 in place along support member attachment channel 140.

Also depicted in FIGS. 2 & 3, support member 120E can comprise groove 160. In some embodiments, support member 120E can comprise sleeve 162 fitted within groove 160. In these embodiments, sleeve 162 can reinforce groove 160. As shown, support member 120E can comprise one or more projections 164 (e.g., opposing projections) that define one or more shoulders 166, respectively, at groove 160. In many embodiments, a clamp can be provided that coordinates with groove 160 to impart a clamping force on shoulder(s) 166 and a work piece (not shown) to hold a work piece against support member 120E as described in more detail below.

Locking wedge 126 can be configured so as not to interfere with the end of channel 160 when locking wedge 126 is disposed into support member attachment channel 140 to lock support member 120E to laterally extending side member 130. In this regard, a top surface of locking wedge 126 can be disposed below the level of channel 160 such that access to channel 160 at the end of support member 120E adjacent to locking wedge 126 is maintained. Alternatively or additionally, locking wedge 126 can comprise a correspondingly shaped notch or other recess that allows channel 160 to be accessed without interference from locking wedge 126 when in the locked position.

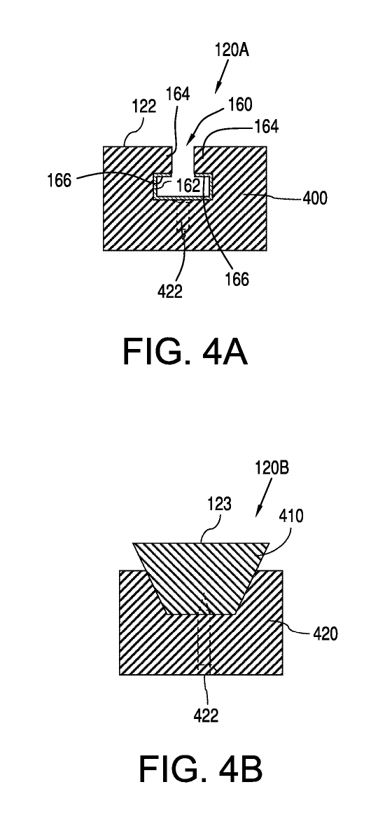

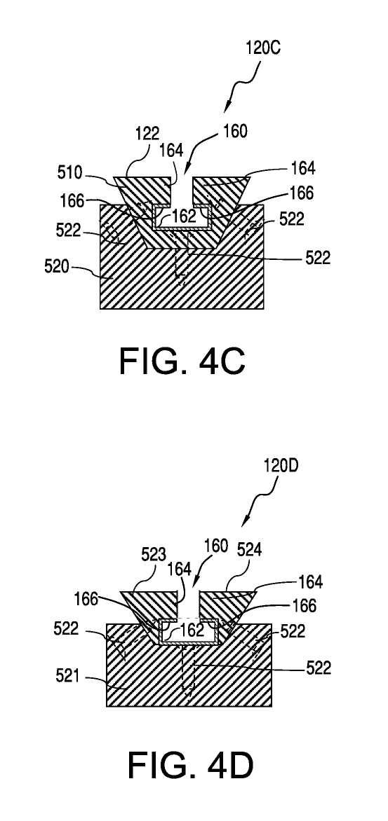

Turning ahead in the drawings, FIGS. 4A-4D depict various embodiments of support members designated as 120A, 120B, 120C, and 120D, respectively. Support members 120A, 120B, 120C, 120D, and/or 120E can be similar or identical to each other.

For example, FIG. 4A depicts a cross section of support member 120A, according to an embodiment. Support member 120A can comprise support member body 400 in which channel 160 can be defined. Further, support member 120A can comprise shoulder(s) 166 defined by projection(s) 164 and can be fitted with sleeve 162 therein. Sleeve 162 can be attached to support member body 400 by way of fastener 422. Top surface 122 and/or support body 400 of support member 120A can be made of a material similar or identical to that of the work piece. Sleeve 162 can be constructed from, for example, metal (e.g., aluminum, iron, titanium, etc.), metal alloy (e.g. steel, etc.), polymer, wood, composite, or another appropriate material. Meanwhile, groove 160, shoulder(s) 166, projection(s) 164, and/or sleeve 162 can be similar or identical to groove 160, shoulder(s) 166, projection(s) 164, and/or sleeve 162, respectively, of FIGS. 2 & 3.

FIG. 4B depicts a cross section of support member 120B, according to an embodiment. Support member 120B can comprise replaceable portion 410. Replaceable portion 410 can comprise continuous top surface 123. Continuous top surface 123 can be similar to top surface 122 (FIGS. 1 & 4A). However, in some embodiments, support member 120B can be devoid of a channel. Replaceable portion 410 can be constructed of a material with properties similar or identical to that of the work piece, as discussed above. Replaceable portion 410 can be removably attached to support member base 420. As such, fastener 422 can be provided to selectively attach removable portion 410 to support member base 420. Fastener 422 can be a screw, bolt, nail, or other appropriate type of fastener. Other arrangements can be provided to facilitate removal and attachment of removable portion 410 from support member base 420 (e.g. through coordinating projections and slots, hook and loop fasteners, or other mechanisms for removably attaching the two members).

FIG. 4C depicts a cross section of support member 120C, according to an embodiment. Support member 120C can comprise removable portion 510 in which can be defined groove 160 and base member 520. Further, support member 120C can comprise groove 160, shoulder(s) 166, projection(s) 164, and/or sleeve 162. Removable portion 510 can be removably attachable to support member base 520 (e.g., by fastener 522). Meanwhile, groove 160, shoulder(s) 166, projection(s) 164, and/or sleeve 162 can be similar or identical to groove 160, shoulder(s) 166, projection(s) 164, and/or sleeve 162, respectively, of FIGS. 2, 3, & 4A.

FIG. 4D depicts a cross section of support member 120D, according to an embodiment. Support member 120D can comprise base member 521, first removable portion 523, and/or second removable portion 524. Further, support member 120D can comprise groove 160, shoulder(s) 166, projection(s) 164, and/or sleeve 162. Base member 521 can be similar to base member 520 (FIG. 4C). Meanwhile, groove 160, shoulder(s) 166, projection(s) 164, and/or sleeve 162 can be similar or identical to groove 160, shoulder(s) 166, projection(s) 164, and/or sleeve 162, respectively, of FIGS. 2, 3, 4A, & 4C. In many embodiments, sleeve 162, first removable portion 523, and/or second removable portion 524 can be attached to base member 521 (e.g., by fastener(s) 522). In some embodiments, first and second removable portions 523 and 524 can each comprise one of projection(s) 164 and one of shoulder(s) 166 being defined thereby.

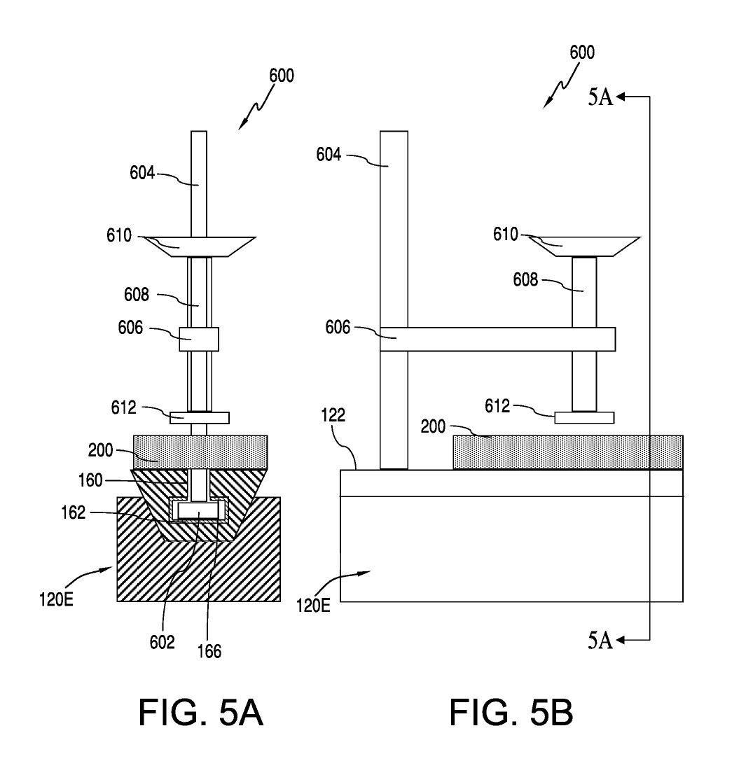

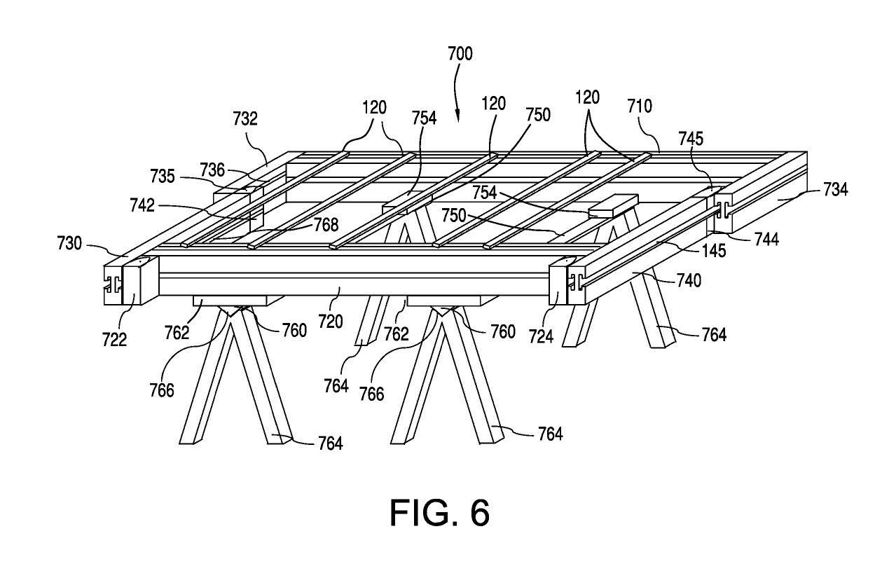

Turning ahead again in the drawings, FIG. 5A illustrates a cross sectional view taken along section line 5A-5A of FIG. 5B of an exemplary clamp engaged with support member 120C, the clamp being configured to clamp a work piece (e.g., work piece 200) to support member 120C, according to the embodiment of FIG. 4C. FIG. 5B illustrates a side view of the exemplary clamp engaged with support member 120C, according to the embodiment of FIG. 4C.

Groove 160 of support member 120C can receive clamp 600 to clamp work piece 200 against support member 120C. Clamp 600 can comprise attachment portion 602 adapted to fit in groove 160 and to engage shoulder(s) 166 of support member 120C. Attachment portion 602 can be attached to clamp mast 604 extending from attachment portion 602 which extends away from support member 120C. Mast 604 can be more narrow than attachment portion 602 so as to pass through the narrowest portion of groove 160 (i.e., the opening between shoulders 166). Mast 604 can engage clamp arm 606. Clamp arm 606 can be positioned along mast 604 by friction, a ratchet, or other suitable mechanism. Clamp arm 606 can support shank 608. Shank 608 can be threadably engaged with clamp arm 606 such that shank 608 can be advanced or retracted with respect to work piece 200.

Accordingly, handle 610 can be provided on an end of shank 608. Handle 610 can allow a user to selectively advance and/or retract shank 608 with respect to work piece 200. Clamping pad 612 can be provided at the opposite end of shank 608. Clamping pad 612 can be constructed of an appropriate material (e.g., one softer than work piece 200) so as reduce the likelihood of damage (e.g., a scratch, a scuff, etc.) to work piece 200. Additionally, clamping pad 612 can distribute the clamping force applied to work piece 200 to further reduce the likelihood of damage to work piece 200.

As such, clamp 600 can be positioned such that attachment member 602 is disposed within groove 160, as shown in FIG. 5A. Arm 606 can be lowered such that clamping pad 612 contacts work piece 200. Shank 608 can be threadably advanced toward work piece 200 by rotation of handle 610. As such, the force applied by clamping pad 612 can be countered by engagement of attachment member 602 with shoulders 166 of groove 160. In turn, work piece 200 can be clamped to support member 120C. Other appropriate types of clamps can be provided including other styles of clamps that can coordinate with groove 600 (e.g., ratchet-type quick release clamps etc.). Further still, clamps can be employed that engage a bottom surface of support member 120C to clamp work piece 200 to the top of support member 120C (e.g., in the case of a support member lacking a groove).

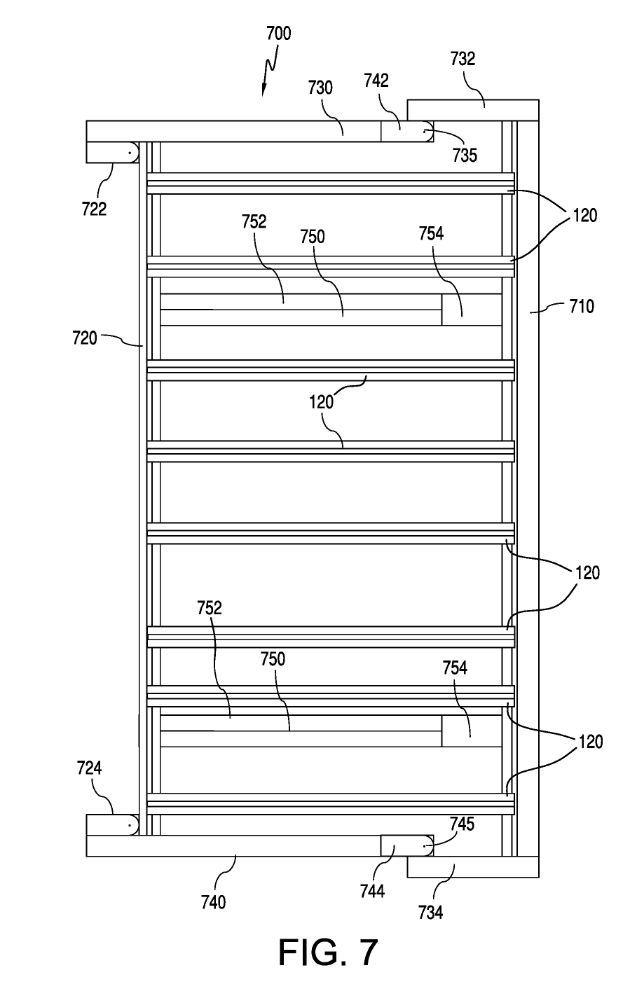

FIG. 6 illustrates a perspective view of work table 700, according to an embodiment. Meanwhile, FIG. 7 illustrates a partial top view of work table 700 when configured in an exemplary extended position, according to the embodiment of FIG. 6. Work table 700 can be similar to work table 100 (FIG. 1).

Work table 700 can comprise a multifunction table. Work table 700 can be collapsible such that, for example, work table 700 can be more easily transported or stored. Work table 700 can comprise stationary side member 710. Extension members 732 and 734 can be provided on opposing ends of the stationary side member 710. Extension members 732 and 734 can be attached to stationary side member 710, for example, using bolts, welding, or any other appropriate joining technique. Extension members 732 and 734 can extend perpendicularly with respect to stationary side member 710. Extension members 732 and 734 can define slot 736 (shown in FIG. 6) extending along substantially all of an interior face of extension members 732 and 734.

First hinge 742 can be attached to extension member 732 by engagement of first hinge 742 with slot 736 provided on an interior face of extension member 732. First hinge 742 can be slideably moveable along the interior face of extension member 732. Additionally, first hinge 742 can comprise pivot 735 that slides along with the remainder of first hinge 742. As such, hinge 742 can be slideable along extension member 732 and can facilitate pivotal movement about pivot 735. Hinge 742 can be attached to or provided integrally with first folding end member 730. In a like regard, second hinge 744 can be slideably moveable along an interior face of extension member 734. Second hinge 744 can facilitate pivotal movement about pivot 745 such that an attached second folding end member 740 is slideably moveable and pivotally moveable with respect to extension member 734 and pivot 745, respectively.

Sliding side member 720 can be provided opposite from and parallel to stationary side member 710. Sliding side member 720 can comprise third hinge 722 and fourth hinge 724 at opposite ends of sliding side member 720. Third and fourth hinges 722 and 724, in addition to being attached to sliding side member 720, can slide along a length of first and second folding end members 730 and 740 as will be discussed in greater detail below.

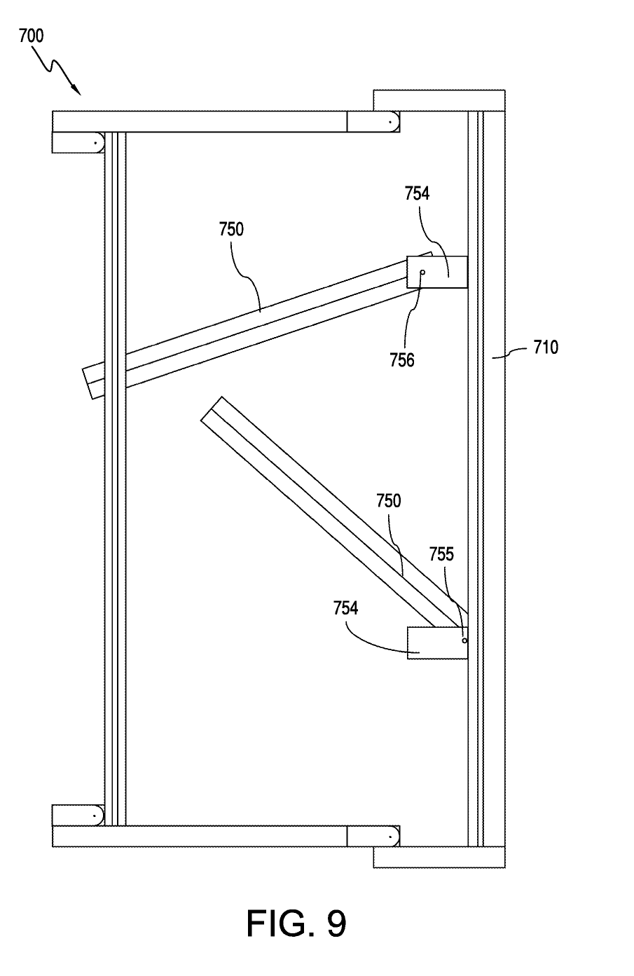

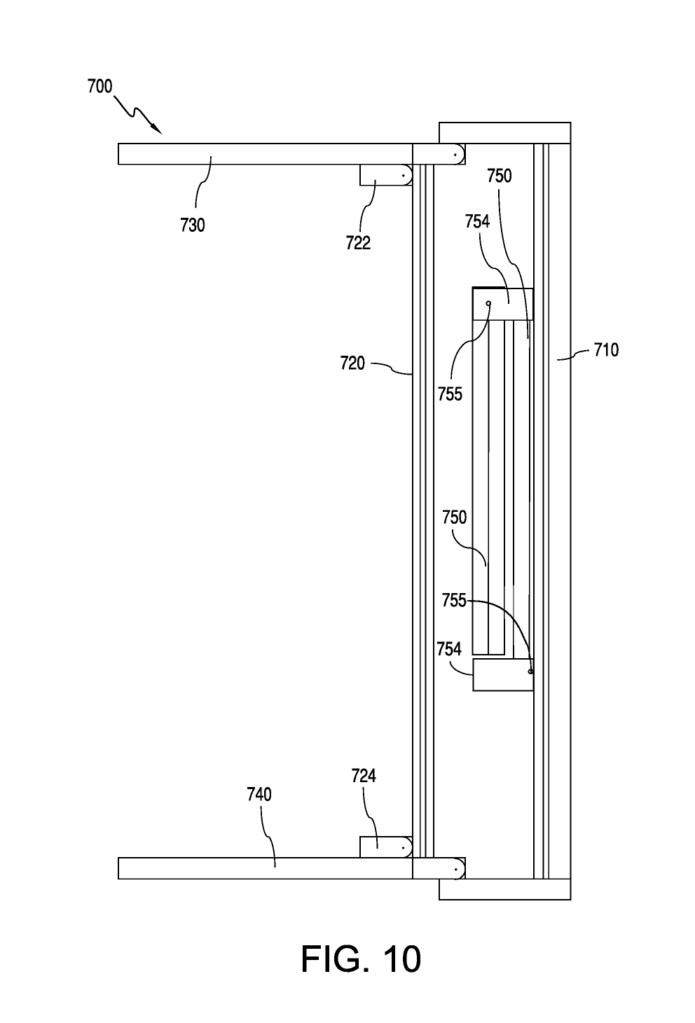

Additionally, stationary side member 710 can comprise attached thereto at least two base members 750. Base members 750 can be moveably attached to attachment portions 754, respectively, which are provided on stationary side member 710. Base members 750 can be moveable between a stowed position and a deployed position. When in the deployed position, base members 750 span substantially the entire width of work table 700 so as to be disposed adjacent to slideable side member 720 in the expanded position (as shown in FIGS. 6 & 7). Base member 750, for example, can be rotatable with respect to attachment portions 754 at pivots 755 such that they can be rotated from the deployed position shown in FIG. 7 to a stowed position. For example, FIG. 9 shows work table 700 with base members 750 in an intermediate position between the deployed position and stowed position. Further, in FIG. 10, base members 750 of work table 700 are in the stowed position. In this regard, base members 750 can be parallel and adjacent to the stationary side member 710 in the stowed position. As pivots 755 are offset with respect to attachment members 754, base members 750 can be arranged as shown in FIG. 10 such that base members 750 are parallel and adjacent to each other when in the stowed position.

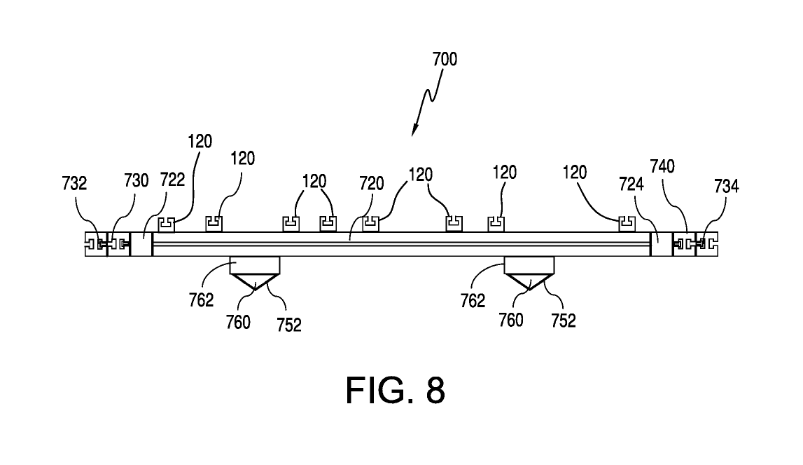

Turning back in the drawings, FIG. 8 illustrates a rear, side view of work table 700, according to the embodiment of FIG. 6. A generally “V” shaped portion 752 also can be provided on base members 750. As shown in FIG. 8, “V” shaped portion 752 can coordinate with correspondingly shaped projection 760 operatively attached to sliding side member 720. “V” shaped portion 752 can be correspondingly shaped to receive projection 760. Projection 760 can be adjustably moveable along the length of slideable side member 720. For example, projection 760 can be provided with sliding attachment 762 that coordinates with a slot provided on the underside of sliding side member 720.

As such, “V” shaped portion 752 can receive projection 760 to provide a suitably stable platform for work table 700 when resting upon one or more supports to support work table 700. For example, one or more saw horses 764 or other structures with correspondingly shaped depression 766 can receive “V” shaped channel 752 of base members 750. The nature of “V” shaped portion 752 can help reduce the potential work table 700 would slide with respect to saw horses 764. For example, sliding forces that could otherwise cause work table 700 to move or slide with respect to saw horses 764 could require an additional uplifting force to unseat “V” shaped portion 752 from the correspondingly shaped depression 766 on saw horses 764. Furthermore, while the foregoing describes a particular arrangement of “V” shaped portion 752, this particular arrangement is shown for demonstrative purposes such that any suitable matching shape can be used for base members 750 and each correspondingly shaped depression 766.

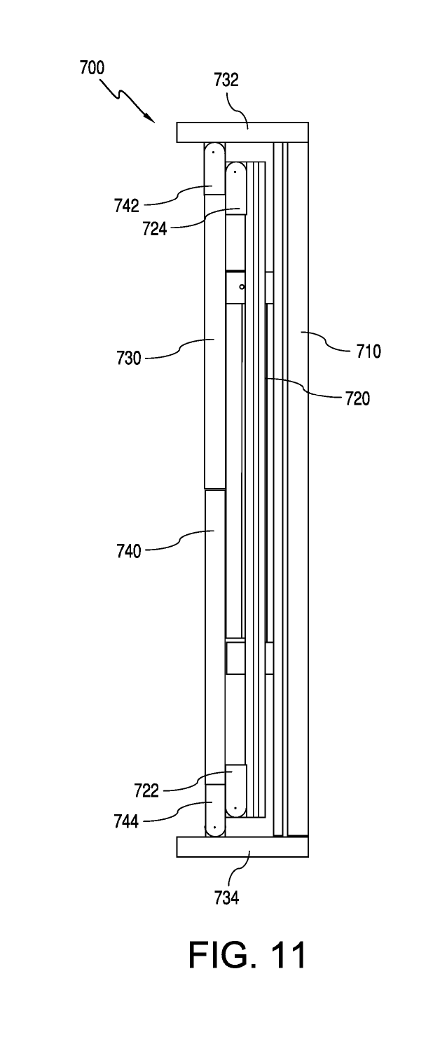

As shown in FIG. 9, and as referenced above, base members 750 can be rotated with respect to attachment portion 754. As such, base members 750 can be pivoted such that they are substantially parallel with static side member 710 when in the stowed position, as depicted in FIG. 10. Also as shown at FIG. 10, slideable side member 720 has been moved along with third and fourth hinges 722 and 724 toward stationary side member 710. As such, slideable side member 720 can be moved between an extended position (shown in FIG. 7) and a collapsed position (shown in FIG. 10). Slideable side member 720 can be spaced apart from the stationary side member 710 in the extended position and adjacent to the stationary side member 710 in the collapsed position. Repositioning can be facilitated as first and second hinges 722 and 724 can slideably engage slot 768 (shown in FIG. 6) on an interior face of first and second folding end members 730 and 740. In this regard, first and second folding end members 730 and 740 can be pivoted to a folded position as shown in FIG. 11. Thus, work table 700 can be collapsed for ease of transport or storage.

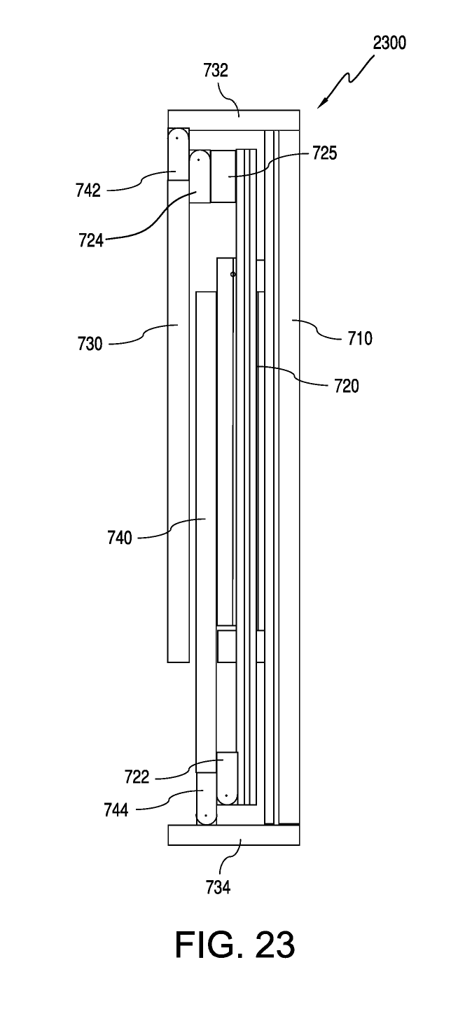

While not shown in FIG. 11, folding end members 730 and 740 can partially overlap rather than abut one another when in the folded position, as shown in FIG. 23 illustrating work table 2300, according to another embodiment. Work table 2300 can be similar to work table 700 (FIG. 7). However, in these embodiments, folding end members 730 and 740 can be offset along a length of extension members 732 and 734 when in the folded position. To accommodate an offset between folding end members 732 and 734, spacer 725 can be provided on one of hinges 722 or 724. For example, as shown in FIG. 23, spacer 725 can be provided at hinge 724. Alternatively, other hinge designs can be employed that allow sliding side member 720 to span between the offset folding end members 732 and 734 without the use of spacer 725. In this regard, differently sized tables (e.g., a square table) that comprise folding end members 730 and 740 that comprise lengths representing a larger portion of stationary side member 710 can be provided that allow the folding end members to be moved to a folded position (e.g., as shown in FIG. 23).

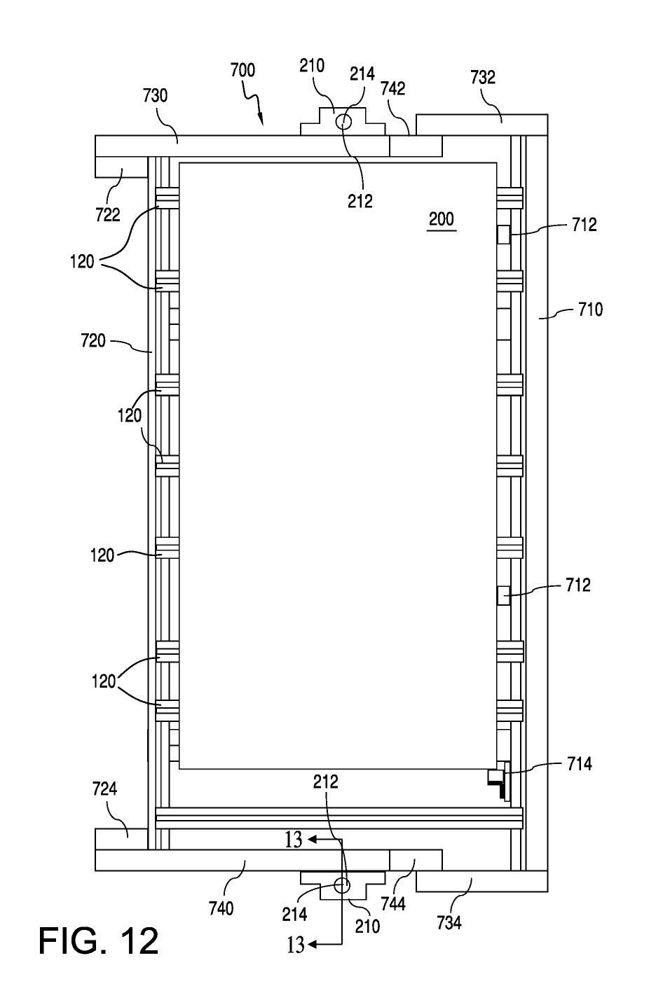

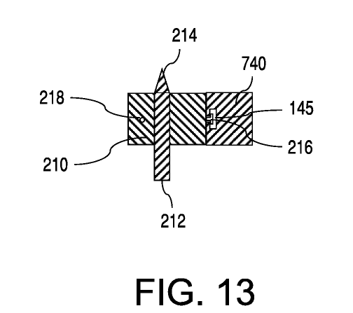

Turning ahead again in the drawings, with additional reference to FIGS. 12-15, an exemplary tool guide 202 is shown as can be used in conjunction with work table 700, according to the embodiment of FIG. 6. However, the tool guides disclosed herein can also be used with other embodiments of work table 700 and/or work table 100 (FIG. 1). Tool guide 202 can generally comprise two posts 212 supported by corresponding attachment members 210. Attachment members 210 can be slideably engaged with a respective tool guide retention member 145 provided in the first and second folding end members 730 and 740. For example, FIG. 13 illustrates a cross sectional view of one of attachment members 210 and folding end member 740 taken along section line 13-13, according to the embodiment of FIG. 6. Second folding end member 740 can comprise tool guide retention member 145. The shoulder of attachment bolt 216 can be disposed within tool guide retention member 145. A fastener, such as an adjustable handle, nut, or the like, can be engaged with the attachment bolt 216 to tighten attachment bolt 216 with respect to tool guide retention member 145 to secure the one of attachment members 210 to folding end member 740. One or more attachment bolts 216 can be provided.

Post 212 can be attached to attachment members 210 such that the height of post 212 can be adjusted depending on the thickness of work piece 200. As such, post 212 can be engaged by a clamping action of attachment member 210 (e.g., by set screw 218 or the like). Narrowed end 214 of post 212 can comprise a point, a ridge, or other narrowed shape (e.g., a frustoconical shape) at one end of post 212.

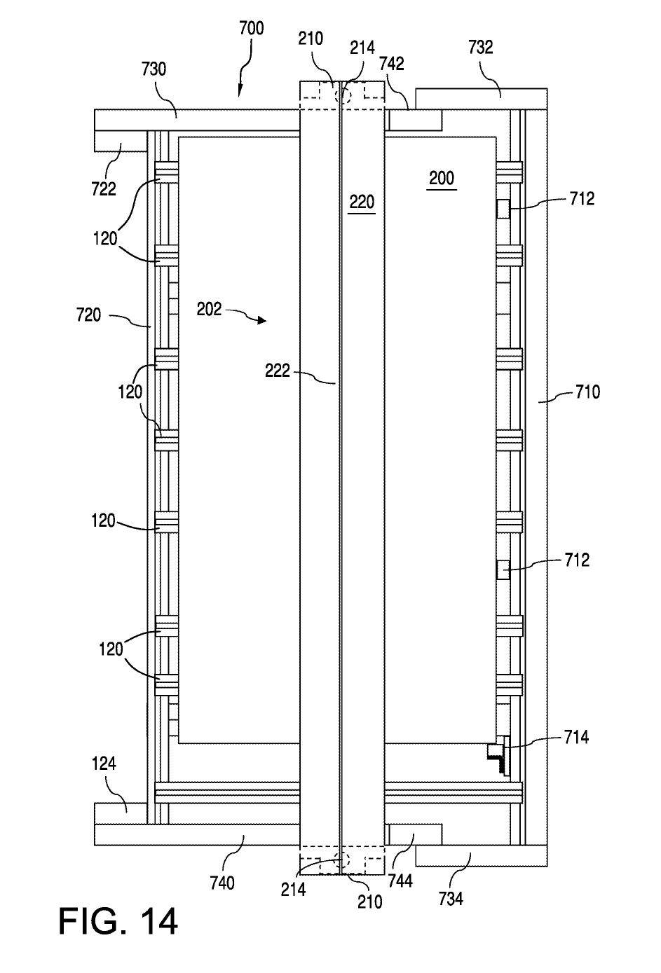

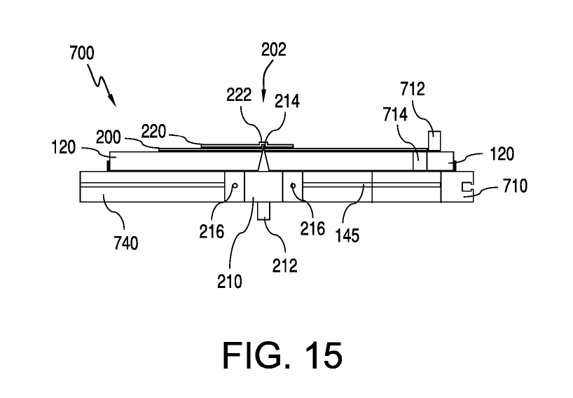

Narrowed end 214 of a respective one of posts 212 can engage tool guide track 220 (as shown in FIGS. 14 and 15). For example, crease 222 can be provided on tool guide track 220 such that narrowed ends 214 engage the underside of crease 222 to locate tool guide track 220 with respect to work piece 200. This engagement can prevent tool guide track 220 from moving longitudinally with respect to the work piece 200. Crease 222 also can project on the top side of tool guide track 220. A corresponding tool base can be provided that engages crease 222 on the top side of tool track 220 to guide a tool (not shown) along the length of tool guide track 220. Thus, the tool can be guided along tool track 220 with respect to work piece 200 to perform an operation (e.g., a cutting operation, a routing operation, etc.) on work piece 200.

Work piece 200 can be indexed on work table 700 with one or more lateral index members 712 and one or more longitudinal index members 714. As such, work piece 200 can be positioned in a known relative location with respect to work table 700. Lateral index members 712 can comprise a stanchion that projects through a working plane defined by top surfaces 122 of support members 120. Lateral index members 712 can be arranged on stationary side member 710 such that work piece 200 can be abutted against lateral index members 712 when lateral index members 712 are arranged so as to extend through the working plane. Thus, work piece 200 can be indexed laterally with respect to stationary side member 710 (e.g., to be substantially parallel thereto).

Longitudinal index member 714 also can be attached to stationary side member 710. Longitudinal index member 714 can extend longitudinally beyond the lateral index members 712, such that a longitudinal end of work piece 200 can be abutted against longitudinal index member 714. As such, work piece 200 can be indexed against a known position of longitudinal index member 714 as well (e.g., to be substantially perpendicular to stationary side member 710).

Lateral index members 712 can be rotatable such that lateral index members 712 are rotatable into a position such that they do not project through working plane 150. For example, lateral index members 712 can engage a slot on an interior face of stationary side 710. As such, an attachment bolt can secure the lateral index members 712 to stationary side 710. As the attachment bolt is loosened, lateral index members 712 can be rotated about the attachment bolt between an extended and retracted position. As such, lateral index members 712 can be provided in a retracted position when not in use such that the work piece 200 can be supported on work table 700 in any manner without contacting lateral index members 712. Also, lateral index members 712 can be adjustably rotated when in an extended position such that the portion of the lateral index members 712 extending beyond working plane 150 can be adjusted. Thus, the height of lateral index members 712 can be adjusted to accommodate work pieces 200 of various thicknesses.

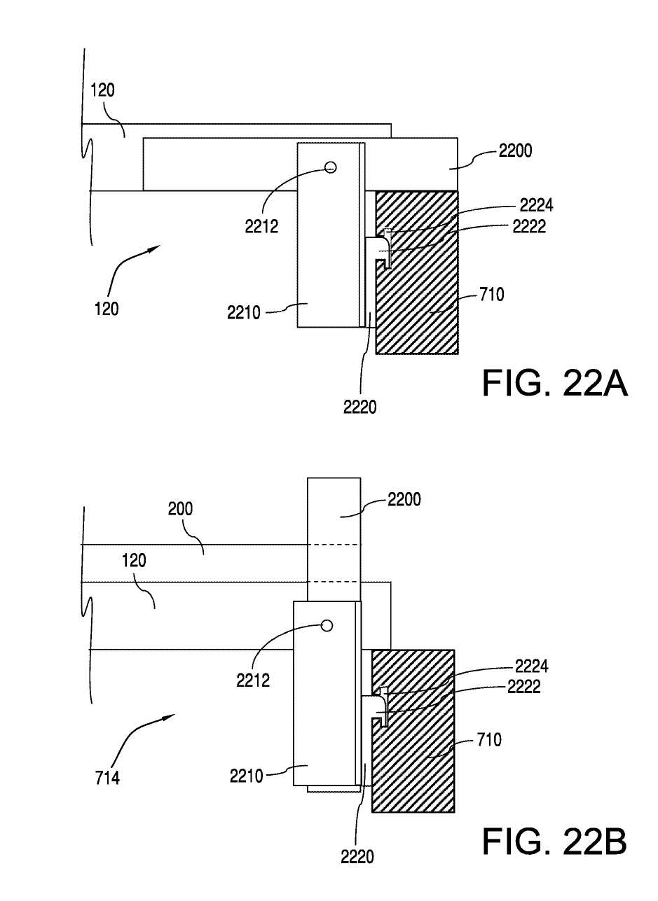

FIG. 22A illustrates a left side view of longitudinal index member 714 of work table 700 in a retracted position, according to the embodiment of FIG. 6. Further, FIG. 22B illustrates a left side view of longitudinal index member 714 in an extended position, according to the embodiment of FIG. 6.

Longitudinal index member 714 can generally comprise stanchion 2200 which is pivotable about pivot member 2212 between an extended and a retracted position. The retracted position is depicted in FIG. 22A and the extended position is depicted in 22B. Longitudinal index member 714 can comprise slot engagement member 2220 which comprises hooked portion 2222 that engages slot 2224 provided on stationary side member 710. Attached to slot engagement member 2220 can be angle member 2210. Angle member 2210 can comprise pivot member 2212 such that stanchion 2200 is pivotal thereabout. In this regard, when in the retracted position shown in FIG. 22A, stanchion 2200 may not extend above support member 120. However, when pivoted to the position shown in FIG. 22B, stanchion 2200 can extend above support member 120.

Additionally, because stanchion 2200 is provided to the inside of stationary side member 710, work piece 200, which is longitudinally indexed to an interior portion of stationary side member 710, can abut the stanchion 2200 at a lateral end thereof. Hooked portion 2222 can allow for rapid engagement and disengagement with slot 2224 such that longitudinal index member 714 can be positioned anywhere along the length of stationary member 710. Additionally, in that stanchion 2200 can be rapidly pivoted between the extended position and the retracted position, longitudinal index member 714 can be easily moved out of the way so as not to interfere with the work piece if so desired.

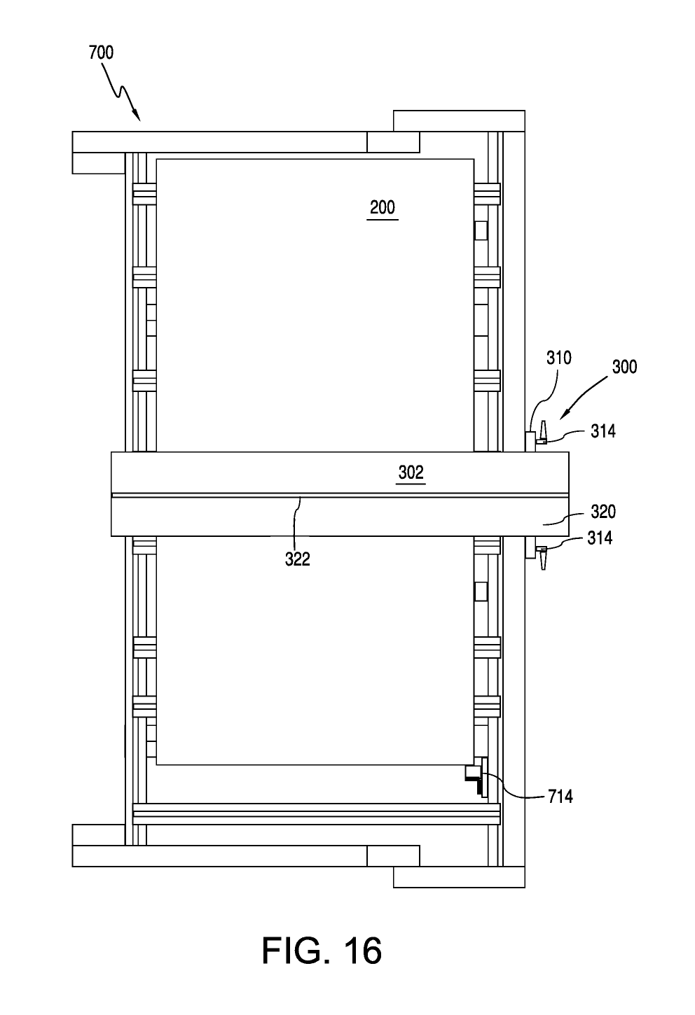

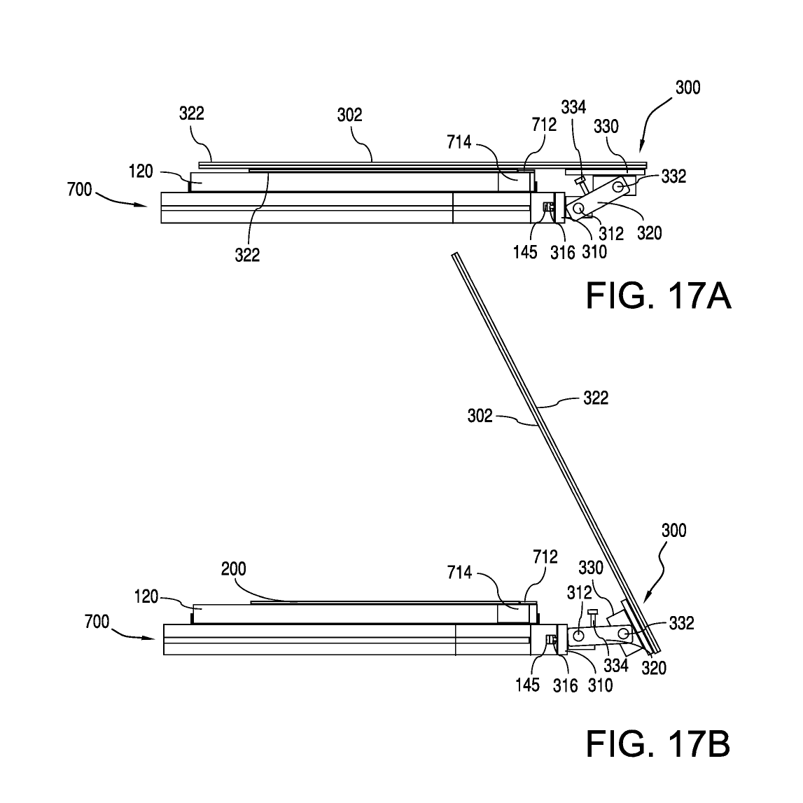

FIG. 16 illustrates a partial top view of tool guide 300 attached to work table 700, according to the embodiment of FIG. 6. Further, FIG. 17A illustrates a partial left side view of tool guide 300 configured in an exemplary work position, according to the embodiment of FIG. 6, and FIG. 17B illustrates a partial left side view of tool guide 300 configured in an exemplary auxiliary position, according to the embodiment of FIG. 6.

Tool guide 300 can comprise attachment member 310 secured to stationary side member 710. In a similar fashion to attachment members 210, attachment member 310 can comprise attachment bolt 316 that engages tool guide retention member 145 provided in stationary side member 710. Tool guide retention member 145 can be a slot against which a shoulder of attachment bolt 316 is engaged upon tightening of adjustable handle 314, a nut, or other appropriate fastener. Accordingly, tool guide 300 can be secured anywhere along substantially an entire length of stationary side member 710 along which tool guide retention member 145 extends.

Attachment member 310 can connect to first pivot 312. Pivot arm 320 also can connect to first pivot 312 such that pivot arm 320 is disposed for pivotal movement with respect to attachment member 310. Pivot arm 320 can also be attached to track support 330 at second pivot 332 so as to facilitate relative pivotal movement between pivot arm 320 and track support 330. Cantilevered tool guide track 302 can be attached to the track support 330. As such, the relative pivotal movement of the attachment member 310, pivot arm 320, and track support 330 can allow the cantilevered tool guide track 302 to be positioned flush against work piece 200 as shown in FIGS. 16 & 17A.

Adjustment bolt 334 can be provided that threadably engages pivot arm 320. Thus, track support 330 can contact the head of adjustment bolt 334 and limit the pivotal movement of track support 330 with regard to pivot arm 320. As such, adjustment of the height of adjustment bolt 334 can allow for different thicknesses of materials while maintaining cantilevered tool guide track 302 flushed with work piece 200. For example, unthreading adjustment bolt 334 with respect to pivot arm 320 can provide for a thicker work piece 200 whereas threadably engaging more of adjustment bolt 334 with pivot arm 320 can allow for a thinner work piece 200. The adjustable bolt 334 also can be provided on attachment member 310, and/or track support 330 to adjust the height at which cantilevered tool guide track 302 is positioned with respect to the work piece (i.e., to adjust for different work piece thicknesses). Crease 322 can be provided that can engage a corresponding tool base to guide a tool along cantilevered tool guide track 302 to perform an operation on work piece 200.

In order to provide additional rigidity to the assembly, track support 330 can comprise a projection which coordinates with crease 322 so as to prevent rotational movement of guide track 302 with respect to track support 330. Track 302 can be attached to track support 330 in any suitable manner. For example, track support 330 can be bolted to cantilevered tool guide track 302 such that the bolt engages crease 322, passes through track support 330, and is tightened so as to bolt cantilevered tool guide track 302 to track support 330.

As indicated previously, FIG. 17B depicts cantilevered tool guide track 302 in an auxiliary position wherein cantilevered tool guide track 302 is disposed away from work piece 200. That is, cantilevered tool guide track 302 extends away from the working plane. The auxiliary position can facilitate improved access to work piece 200. As such, cantilevered tool guide track 302 can be positioned in a work position (shown in FIGS. 16 & 17A) or the auxiliary position shown in FIG. 17B. In turn, work piece 200 can be retrieved or positioned when cantilevered tool guide track 302 is in the auxiliary position without having to move or remove the tool guide 300 from the desired position along stationary side member 710. As shown at FIG. 17B, lateral index members 712 can be adjusted with respect to the working plane (e.g., such that less of the index member 712 is provided above the working plane) to prevent interference with cantilevered tool guide track 302.

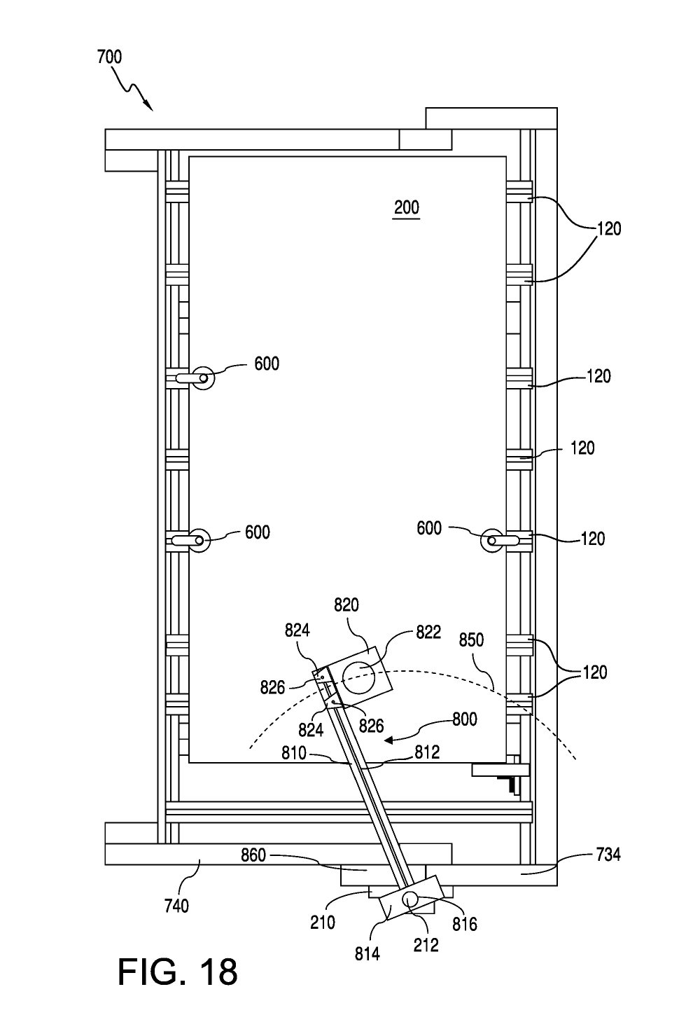

Turning forward again in the drawings, FIG. 18 illustrates a partial top view of tool guide 800 attached to work table 700, according to the embodiment of FIG. 6. Tool guide 800 can provide a guide to perform and operation through arc 850 with respect to work piece 200. Tool guide 800 can comprise a similar attachment member 210 as was described above with respect to tool guide 202. As such, attachment member 210 can be attached to either of first or second folding end members 730 and 740, stationary side member 710, or sliding side member 720, depending upon the operation needed.

Also, in the embodiment as shown in FIG. 18, the ends of the table comprise a non-continuous surface due to the junction of extension members 732 and 734 with foldable end members 730 and 740, respectively. It can be desirable to attach tool guide 800 in a manner that spans this non-continuous junction. Such an arrangement as shown in FIG. 18, where supplemental support piece 860 can be attached to the second end member 740 adjacent to the junction of extension member 734 and the second folding end member 740. In turn, supplemental support 860 also can comprise tool guide attachment member 145 that is spaced away from the end member 740 in a manner so as to align tool guide attachment member 145 on supplemental support piece 860 with tool guide attachment member 145 on extension member 734. As such, tool guide 800 can be attached to extension member 732 and supplemental support piece 860 in an example wherein tool guide 800 would otherwise overlap the junction between the non-continuous surfaces.

Attachment member 210 also can support post 212 as described above. Unlike post 212 as implemented with tool guide 202, post 212 as implemented with tool guide 800 can be substantially cylindrical adjacent to the intersection of post 212 and the working plane. In this regard, attachment member 210 described above with respect to tool guide 202 can be flipped and narrowed end 214 thereof may not be employed. Post 212 can be engaged by pivot guide 814. Pivot guide 814 can comprise a collar that surrounds post 212 and facilitates pivotal movement of pivot guide 814 with respect to post 212. Attached to pivot guide 814 can be arm 810. Arm 810 can define channel 812 that can receive one or more bolts 826. One or more bolts 826 also can pass through one or more corresponding brackets 824 that are secured to tool base 820. As such, tool 822 can be guided along arc 850 upon rotational movement of pivot guide 814 with respect to post 212. As the brackets 824, and in turn tool base 820, can be slideably positioned along the length of the arm 810, the radius of arc 850 can be adjusted as necessary.

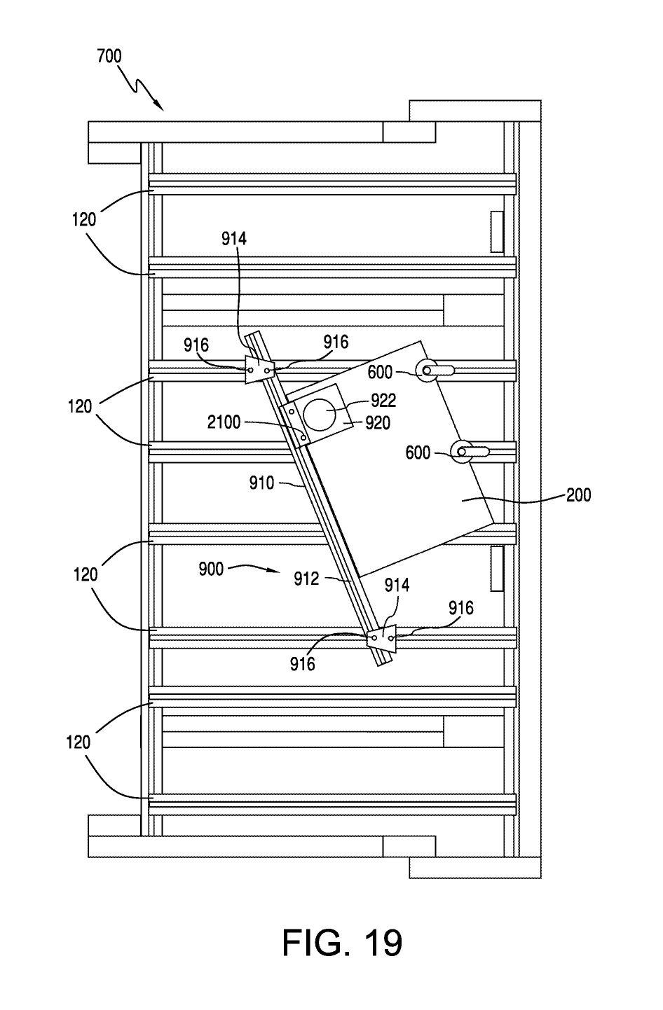

As the various operations can generate forces tending to cause work piece 200 to slide or move in the working plane (e.g., in a direction away from the index members 712 and 714), a number of clamps 600 can be provided to hold work piece 200 in place against support members 120. As discussed above, clamps 600 can cooperate with groove 160 defined in support members 120 to clamp work piece 200 to support members 120. This arrangement wherein clamps 600 are used to secure work piece 200 to support members 120 is also shown in FIG. 19.

Specifically, FIG. 19 illustrates a partial top view of tool guide 900 attached to work table 700, according to the embodiment of FIG. 6. Tool guide 900 can be employed to perform an operation on work piece 200. Tool guide 900 comprises beam 910 defining channel 912. Channel 912 can engage one or more beam attachment bolts 918 that in turn engage one or more brackets 914. Brackets 914 also can engage support member attachment bolt 916 that engages channel 160 of support member 120. As such, upon tightening of beam attachment bolt 918 and support member attachment bolt 916, beam 910 can be secured in place with respect to work piece 200. As attachment bolts 914 and 916 can be slideably adjusted with respect to beam 910 and support members 120, beam 910 can be positioned in any angle with respect to work table 700.

Channel 912 of beam 910 also can receive attachment member 2100. Attachment member 2100 can be attached to tool base 920. Thus, tool base 920 can be slideably attached to beam 910. As such, beam 910 can guide tool 922 in a desired path along the length of beam 910 to perform an operation on work piece 200.

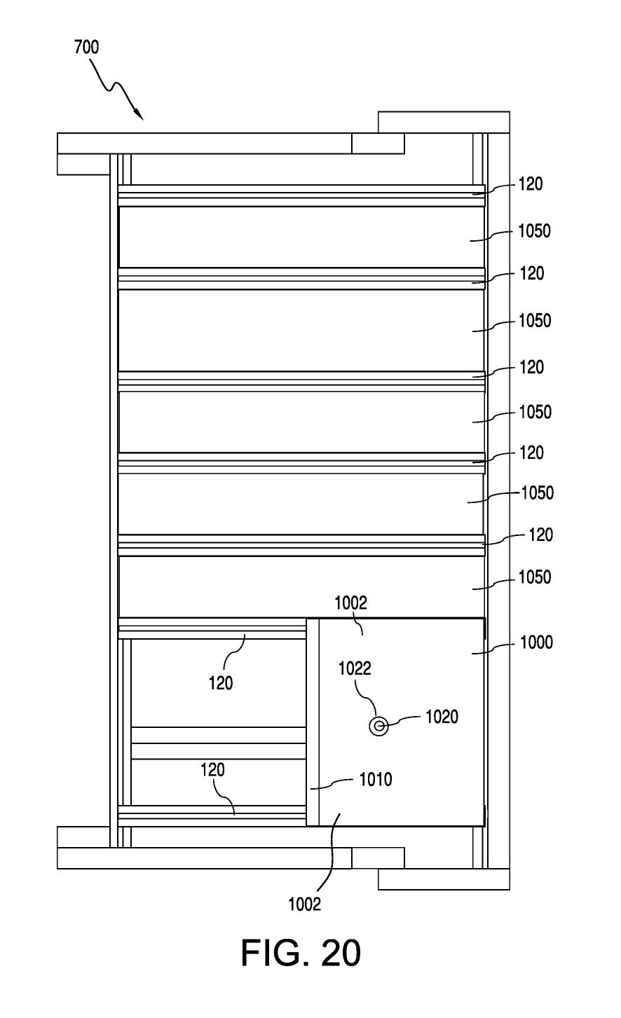

Turning ahead again in the drawings, FIG. 20 illustrates a partial top view of work table 700 including drop-in tool 1000, according to the embodiment of FIG. 6. Drop-in tool 1000 can be used in conjunction with work table 700. Drop-in tool 1000 can be a router, table saw, belt sander, miter saw, or any other appropriate tool. For example, drop-in tool 1000 can comprise a router having router bit 1020 extending through opening 1022. Router bit 1020 can in turn extend through the working plane. As stated above, alternative tools, such as table saws, miter saws, etc. can be used as well. Fence 1010 can be provided on drop-in tool 1000. Fence 1010 can be adjustable to accommodate different operations as needed.

Drop-in tool 1000 can be positioned between adjacent support members 120. In this regard, two adjacent support members 120 can be positioned such that the span between the two adjacent support members 120 is roughly the width of the drop-in tool 1000. Drop in tool 1000 can comprise wings 1002 which extend over the adjacent support members 120 and support drop-in tool 1000 on the support members 120. The space between the adjacent support members 120 can accommodate drop-in tool 1000 such that a portion of drop-in tool 1000 between the wings 1002 extends downward between the two adjacent support members 120. In other embodiments, drop-in-tool 1000 can couple to the adjacent support members 120 in any suitable manner (e.g., grooves, etc.). Thus, the body of the drop-in tool 1000 (including the motor, mechanisms, tool chassis, etc.) can be disposed between the adjacent support members 120. In this regard, drop-in tool 1000 can allow work table 700 to function as a table router, table saw, miter saw, surface sander, etc., depending on the nature of drop-in tool 1000.

Additionally, as shown in FIG. 20, sheet material 1050 can be positioned generally between adjacent support members 120 to form a solid table top for the work table 700. Sheet material 1050 can be of a thickness such that sheet material 1050 rests on the adjacent support members 120 and forms a substantially continuous surface with the adjacent support members 120. Thus, the top surface of sheet material 1050 also can lie in the working plane. Alternatively, or additionally, the thickness of sheet material 1050 can be selected to be above or below the level of the working plane.

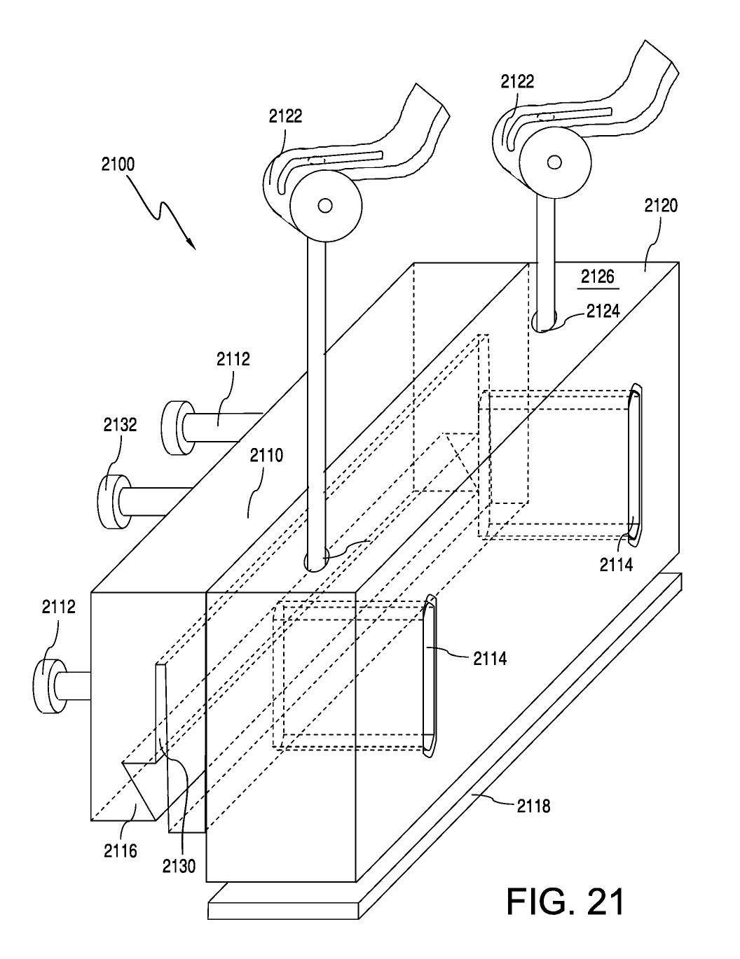

FIG. 21 illustrates a partially exploded perspective view of attachment member 2100 as shown at FIG. 19, according to the embodiment of FIG. 6. Attachment member 2100 can be configured to securing a tool to a beam, pivot arm, or the like. Attachment member 2100 can comprise channel attachment block 2110 affixed to tool attachment block 2120 by way of number of bolts 2112. Bolts 2112 can pass through slotted holes 2114 provided on tool attachment block 2120 such that the relative height of channel attachment block 2110 and tool attachment block 2120 can be changed. Bolt 2112 can pass through portion of channel attachment block 2110 and tighten against an interior face of cut 2130. Cut 2130 can allow for some deflection of channel engagement member 2116 with respect to tool attachment block 2120. As such, bolts 2112 can pass through a portion of channel attachment block 2110 so that tightening of bolts 2112 to secure channel attachment block 2110 to tool attachment block 2120 does not result in deflection of channel engagement member 2116 with respect to tool attachment block 2110.

Channel engagement member 2116 can be shaped to fit into a channel (e.g., channel 912 as shown in FIG. 19) provided on a beam, pivot arm, or the like. As such, channel engagement member 2116 can slide along the length of the channel when channel engagement member 2116 is in the neutral position with respect to tool attachment block 2120. That is, when channel engagement member 2116 is not deflected towards tool attachment block 2120, attachment member 2100 can slide smoothly along the channel. However, deflection bolt 2132 can be provided that threadably engages channel attachment block 2110 on opposing sides of cut 2130. As such, upon threadable advancement of deflection bolt 2132 with respect to channel attachment block 2110, cut 2130 can be pinched together. As such, channel engagement member 2116 can be deflected towards tool attachment block 2120. When engaged with a channel, this can cause this deflection of channel engagement member 2116 toward tool attachment block 2120 to cause channel engagement member 2116 to bind with respect to the channel such that movement along the channel can be limited. In this regard, deflection bolt 2132 can be tightened to secure attachment member 2100 along the length of the channel. In contrast, loosening or removal of deflection bolt 2132 can allow attachment member 2100 to slide freely along the length of the channel.

Tool attachment block 2120 also can comprise bottom plate 2118 which is clampingly engageable with tool attachment block 2120 by a number of cammed bolts 2122 that pass through holes 2124 provided through tool attachment block 2120 to engage bottom plate 2118. As such, cammed bolts 2122 can adjust the gap between bottom plate 2118 and tool attachment block 2120. In turn, cammed bolts 2122 can cam against top surface 2126 of tool attachment block 2120 in order to clamp bottom plate 2118 towards tool attachment block 2120. In this regard, a tool base can be clampingly secured between bottom plate 2118 and tool attachment block 2120. Bolts 2112 and slotted holes 2114 can be used to adjust the height of the tool such that the tool base can be disposed in an appropriate level with respect to the work piece.

Other additional features or refinements can be provided to any of the foregoing embodiments. For example, reference marks can be provided at various locations on an embodiment of a table. For example, a scale can be provided on the stationary side, the foldable end members, or the sliding side. Such a scale can be provided on any surface thereof to assist in performing an operation. The scale can be calibrated to an indexed position (e.g., as defined by index members) or other point (e.g., the table edge). Further still, the tool guides can comprise scales or other reference marks. This can comprise, without limitation, a scale on the support members, a beam or arm of a tool guide, a tool guide track, or other appropriate location. These reference marks and scales can provide distances or angle measurements to an indexed position of the work piece.

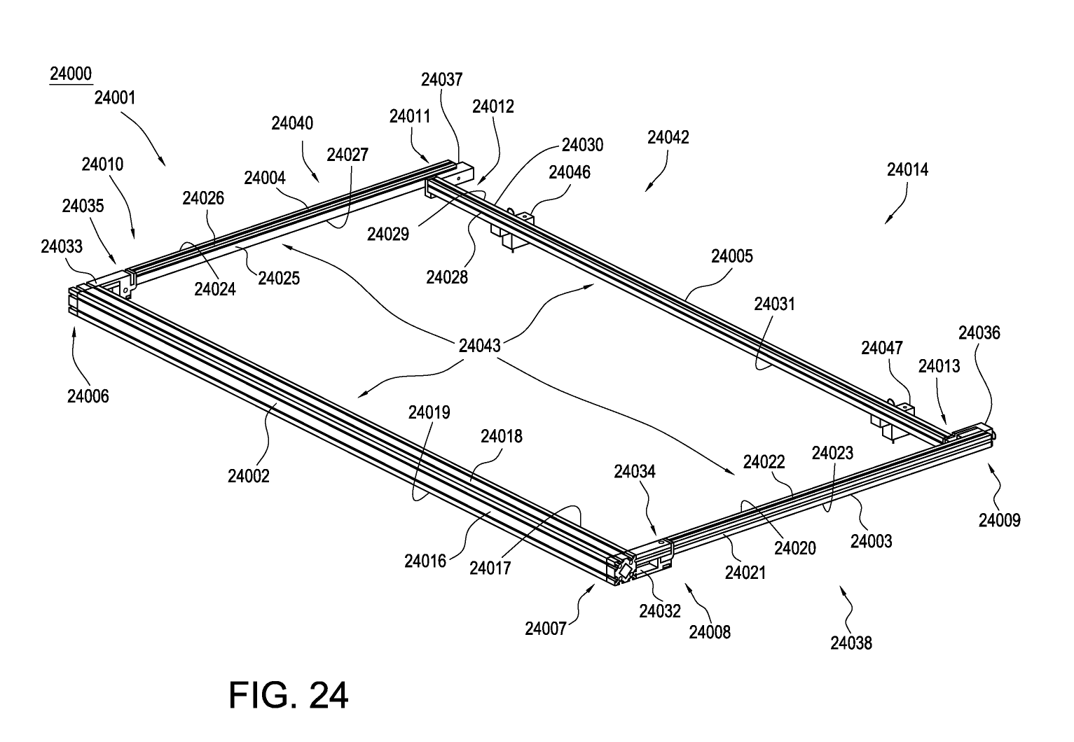

Turning ahead in the drawings, FIG. 24 illustrates a top, front, ride side view of support structure 24001 of system 24000 when support structure 24001 is configured in support structure extended configuration 24014, according to an embodiment. System 24000 is merely exemplary and is not limited to the embodiments presented herein. System 24000 can be employed in many different embodiments or examples not specifically depicted or described herein.

System 24000 comprises support structure 24001. Support structure 24001 comprises first member 24002, second member 24003, third member 24004, and fourth member 24005. First member 24002 can comprise first member left end 24006 and first member right end 24007; second member 24003 can comprise second member proximal end 24008 and second member distal end 24009; third member 24004 can comprise third member proximal end 24010 and third member distal end 24011; and/or fourth member 24005 can comprise fourth member left end 24012 and fourth member right end 24013.

Although first member 24002, second member 24003, third member 24004, and/or fourth member 24005 can comprise any suitable cross sectional shape (e.g., a circle, an oval, a triangle, a rectangle, etc.), in many examples, first member 24002, second member 24003, third member 24004, and/or fourth member 24005 can comprise a square and/or rectangular cross section. Accordingly, each of first member 24002, second member 24003, third member 24004, and/or fourth member 24005 can comprise one or more faces. For example, first member 24002 can comprise first member proximal face 24016, first member distal face 24017, first member top face 24018, and/or first member bottom face 24019; second member 24003 can comprise second member left face 24020, second member right face 24021, second member top face 24022, and/or second member bottom face 24023; third member 24004 can comprise third member left face 24024, third member right face 24025, third member top face 24026, and/or third member bottom face 24027; and/or fourth member 24005 can comprise fourth member proximal face 24028, fourth member distal face 24029, fourth member top face 24030, and/or fourth member bottom face 24031.

First member 24002 can comprise right end cap 24032 at first member right end 24007 and left end cap 24033 at first member left end 24006. Right end cap 24032 can comprise right end cap distal end 24034, and left end cap 24033 can comprise left end cap distal end 24035. Right end cap 24032 and/or left end cap 24033 can each extend distally from first member 24002. Further, system 24000 can comprise second member translation mechanism 24036, third member translation mechanism 24037, first member left base attachment mechanism (not shown at FIG. 24), first member right base attachment mechanism (not shown at FIG. 24), fourth member left base attachment mechanism 24046, and/or fourth member right base attachment mechanism 24047.

First member right end 24007 can be opposite first member left end 24006. Second member distal end 24009 can be opposite second member proximal end 24008. Third member distal end 24011 can be opposite third member proximal end 24010. Fourth member right end 24013 can be opposite fourth member left end 24012. In general, second member 24003 can be similar to third member 24004, and/or right end cap 24032 can be similar to left end cap 24033.

Second member 24003 (e.g., second member proximal end 24008) can be coupled to first member 24002 (e.g., first member right end 24007), such as, for example, at right end cap distal end 24034. Further, second member 24003 (e.g., second member distal end 24009) can be coupled to fourth member 24005 (e.g., fourth member right end 24013), such as, for example, via second member translation mechanism 24036. Second member translation mechanism 24036 can be configured for translation along second member 24003, such as, for example, at second member left face 24020. In some embodiments, support structure 24001 and/or second member 24003 can comprise second member translation mechanism 24036.

Third member 24004 (e.g., third member proximal end 24010) can be coupled to first member 24002 (e.g., first member left end 24006), such as, for example, at left end cap distal end 24035. Further, third member 24010 (e.g., third member distal end 24010) can be coupled to fourth member 24005 (e.g., fourth member left end 24012), such as, for example, via third member translation mechanism 24037. Third member translation mechanism 24037 can be configured for translation along third member 24004, such as, for example, at third member right face 24025. In some embodiments, support structure 24001 and/or third member 24004 can comprise third member translation mechanism 24037.

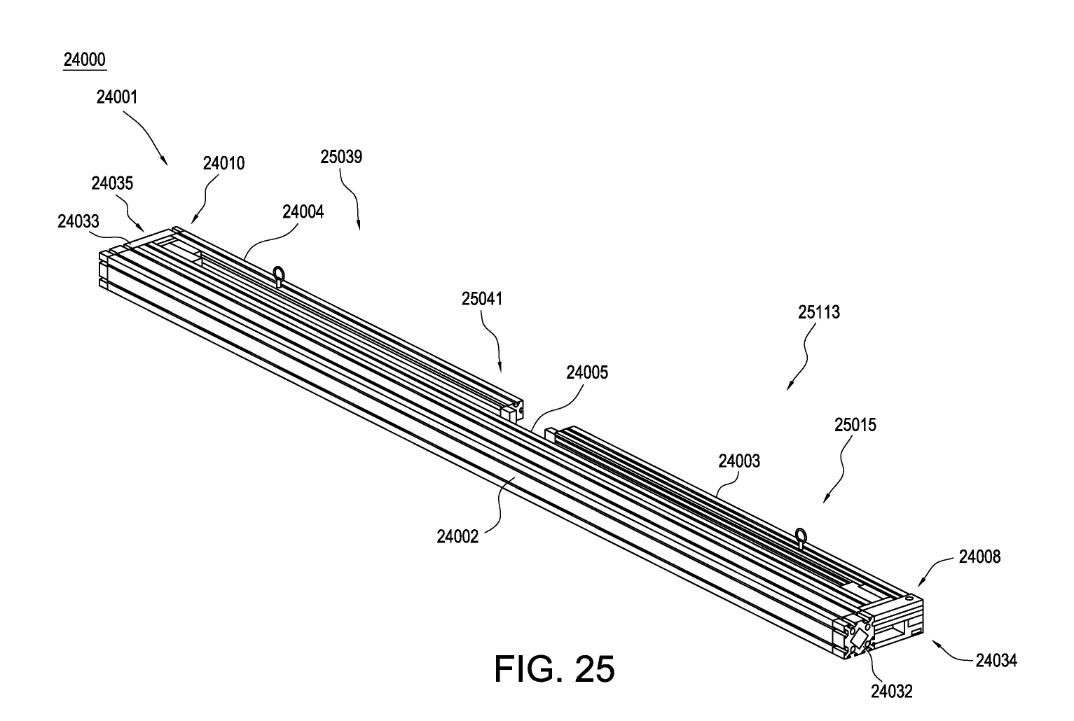

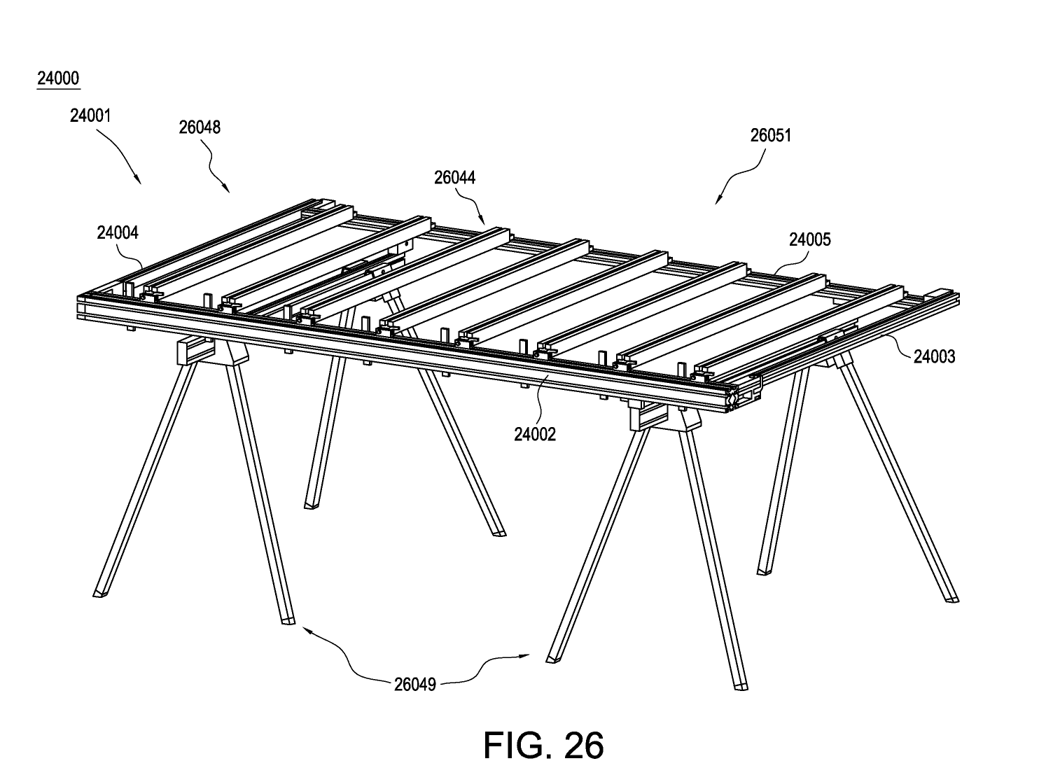

In many embodiments, support structure 24001 can be collapsible, such as, for example, for ease of transport and storage. Accordingly, in these embodiments, support structure 24001 can comprise support structure collapsed configuration 25113 (FIG. 25) and support structure extended configuration 24014. In other embodiments, support structure 24001 is not collapsible, in which examples support structure collapsed configuration 25113 (FIG. 25) can be omitted. FIG. 25 illustrates a top, front, ride side view of support structure 24001 of system 24000 when support structure 24001 is configured in support structure collapsed configuration 24014, according to the embodiment of FIG. 24.

In many embodiment, second member 24003 can comprise second member collapsed configuration 25015 (FIG. 25) and second member extended configuration 24038. In these embodiments, second member 24003 can be configured to rotate about second member proximal end 24008) between second member collapsed configuration 25015 (FIG. 25) and second member extended configuration 24038. Further, third member 24004 can comprise third member collapsed configuration 25039 (FIG. 25) and third member extended configuration 24040. In these embodiments, third member 24004 can be configured to rotate about third member proximal end 24010) between third member collapsed configuration 25039 (FIG. 25) and third member extended configuration 24040. Further still, fourth member 24005 can comprise fourth member collapsed configuration 25041 (FIG. 25) and fourth member extended configuration 24042. In these embodiments, fourth member 24005 can be configured to translate along second member 24003 (e.g., via second member translation mechanism 24036) and to translate along third member 24004 (e.g., via third member translation mechanism 24037) between fourth member collapsed configuration 25041 (FIG. 25) and fourth member extended configuration 24042.

When support structure 24001 is configured in support structure collapsed configuration 25113 (FIG. 25), second member 24003 can be configured in second member collapsed configuration 25015 (FIG. 25), third member 24004 can be configured in third member collapsed configuration 25039 (FIG. 25), and fourth member 24005 can be configured in fourth member collapsed configuration 25041 (FIG. 25). Meanwhile, when support structure 24001 is configured in support structure extended configuration 24014, second member 24003 can be configured in second member extended configuration 24038, third member 24004 can be configured in third member extended configuration 24040, and fourth member 24005 can be configured in fourth member extended configuration 24042.

In some embodiments, second member translation mechanism 24036 can be configured to rotate with second member 24003, and third member translation mechanism 24037 can be configured to rotate with third member 24004. Further, fourth member 24005 can be prevented from translating between fourth member collapsed configuration 25041 (FIG. 25) and fourth member extended configuration 24042 when second member 24002 is configured in second member collapsed configuration 25015 (FIG. 25) and/or when third member 24003 is configured in third member collapsed configuration 25039 (FIG. 25). For example, fourth member 24005 can be maintained in fourth member collapsed configuration 25041 (FIG. 25) when second member 24002 is configured in second member collapsed configuration 25015 (FIG. 25) and/or when third member 24003 is configured in third member collapsed configuration 25039 (FIG. 25).

One or more of the face(s) of first member 24002, second member 24003, third member 24004, and/or fourth member 24005 can comprise one or more channels 24043. Each of channel(s) 24043 can be similar or identical to the one or more frame features of frame 110 (FIG. 1), channel 140 (FIG. 1), and/or tool retention mechanism 145 (FIG. 1). Accordingly, channel(s) 24043 can facilitate coupling one or more of first member 24002, second member 24003, third member 24004, and/or fourth member 24005 together. Further, channel(s) 24043 can facilitate translation of second member translation mechanism 24036 along second member 24003 and/or third member translation mechanism 24037 along third member 24004.

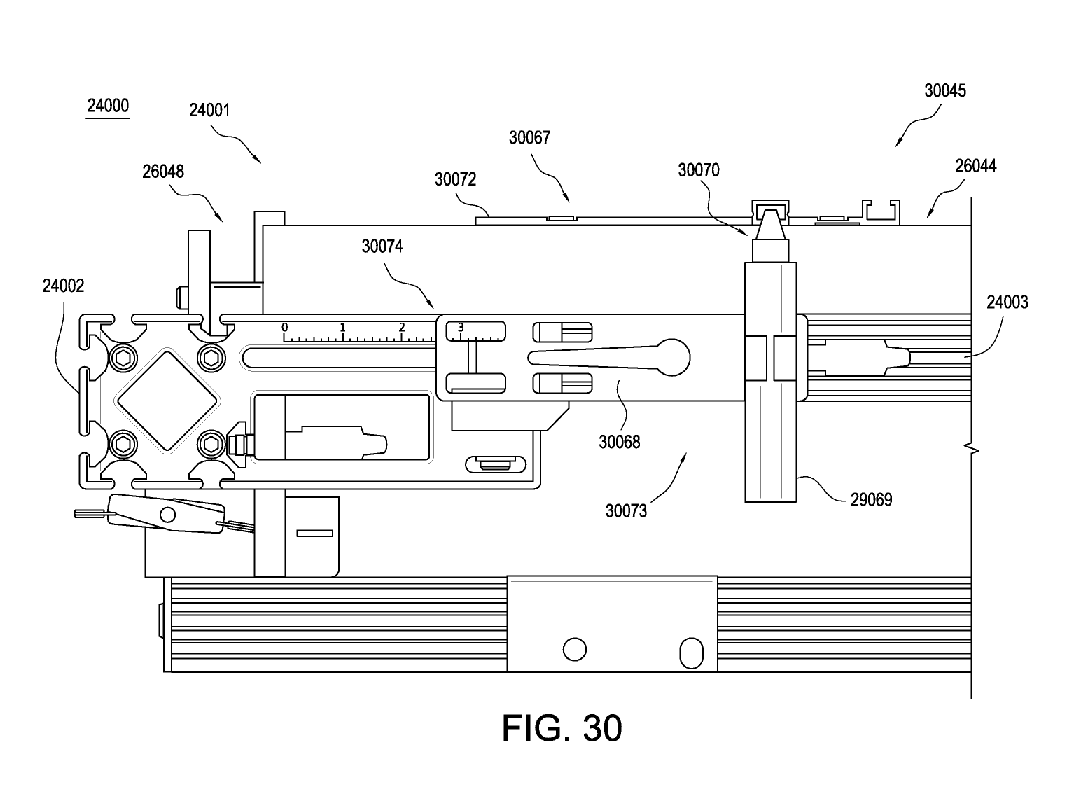

Meanwhile, channel(s) 24043 can be configured to permit one or more cross members 26044 (FIG. 26) to be coupled to support structure 24001, as described below. Further, channel(s) 24043 can be configured to permit one or more accessory elements 30045 (FIG. 30) to be coupled to support structure 24001. For example, accessory element(s) 30045 (FIG. 30) can comprise one or more of tool guides similar or identical to tool guide 202 (FIGS. 14 & 15), tool guide 300 (FIGS. 16-17B), tool guide 800 (FIG. 18), and/or tool guide 900 (FIG. 19). Further exemplary accessory elements (e.g., tool guides) of accessory element(s) 30045 (FIG. 30) are described below. In many embodiments, multiple of accessory element(s) 30045 (FIG. 30) can be implemented simultaneously, as desirable. In other embodiments, accessory element(s) 30045 can be implemented individually.

In general, first member 24002, second member 24003, third member 24004, and/or fourth member 24005 can comprise any suitable material, such as, for example, metal (e.g., aluminum, iron, titanium, etc.), metal alloy (e.g., steel, etc.), wood, polymer, composites (e.g., carbon fiber), etc. In many embodiments, first member 24002, second member 24003, third member 24004, and/or fourth member 24005 can be fabricated by extrusion. Accordingly, in these embodiments, material selection can be dependent on whether the material can be extruded and/or how easily it can be extruded. Further, first member 24002, second member 24003, third member 24004, and/or fourth member 24005 can comprise any suitable dimensions. For example, in some embodiments, first member 24002 can comprise a square cross section having approximately 7.62 centimeter sides. Further, second member 24003, third member 24004, and/or fourth member 24005 can comprise a square cross section having approximately 3.81 centimeter sides.

Turning ahead in the drawings, FIG. 26 illustrates a top, front, ride side view of work table 26048 of system 24000 in work table resting configuration 26051, according to the embodiment of FIG. 24. In many embodiments, system 24000 can comprise work table 26048. Support structure 24001 can comprise part of work table 26048, although in some embodiments, system 24000 can be implemented without work table 26048. In many embodiments, work table 26048 can be advantageously used for wood working, but work table 26048 can also be useful for any other suitable purpose where a table could be implemented.

Work table 26048 can be similar or identical to work table 100 (FIG. 1), work table 700 (FIG. 6), and/or work table 2300 (FIG. 23). Accordingly, in some embodiments, first member 24002 and fourth member 24005 can be similar or identical to side members 130 of work table 100 (FIG. 1), and/or second member 24003 and third member 24004 can be similar or identical to end members 170 of work table 100 (FIG. 1). In other embodiments, first member 24002 can be similar or identical to stationary side member 710 (FIGS. 6 & 23), second member 24003 can be similar or identical to folding end member 730 (FIGS. 6 & 23), third member 24004 can be similar or identical to folding end member 740 (FIGS. 6 & 23), and/or fourth member 24005 can be similar or identical to sliding side member 720 (FIGS. 6 & 23). Further, right end cap 24032 can be similar to extension member 732 (FIGS. 6 & 23), and left end cap 24033 can be similar to extension member 734 (FIGS. 6 & 23).

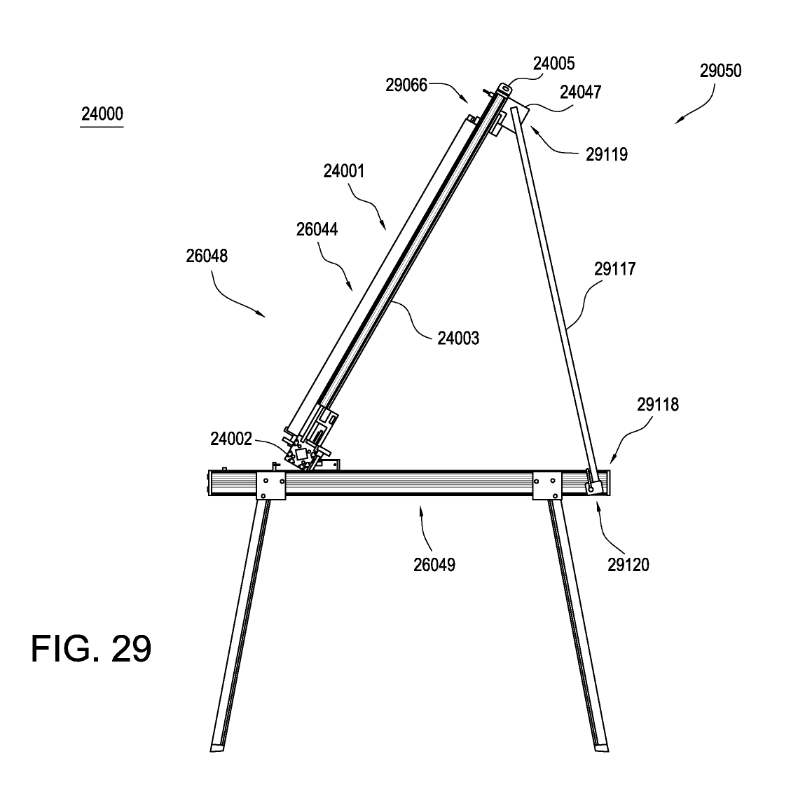

System 24000 and/or work table 26048 can comprise cross member(s) 26044 and/or one or more base supports 26049. Further, work table 26048 can comprise one or more lateral index members and/or one or more longitudinal index members. Further, work table 26048 can comprise work table resting configuration 26051 and one or more work table angled configurations 29050 (FIG. 29). In some embodiments, work table angled configuration(s) 29050 (FIG. 29) can be omitted, as described in greater detail below.

Cross member(s) 26044 can be coupled to support structure 24001 (e.g., at first member 24002 and fourth member 24005) forming a working plane. The working plane can be similar or identical to working plane 150 as illustrated at FIG. 1 and as generally discussed above. In some embodiments, some or all of cross member(s) 26044 can be omitted. However, in these or other embodiments, a unity sheet spanning two or more of members 24002-24005 could be implemented instead of cross member(s) 26044 for similar purpose and/or to achieve similar functionality.

Each of cross member(s) 26044 can be similar or identical to each other. In other embodiments, one or more of cross member(s) 26044 can be different from each other. In some embodiments, each of cross member(s) 26044 can be similar or identical to support members 120 (FIG. 1 and/or FIG. 6), support member 120E (FIGS. 2 & 3), and/or support members 120A-120D (FIGS. 4A-4D). Other exemplary embodiments of cross member(s) 26044 are described below.

Further, base structure(s) 26049 can be configured to support structure 24001 such that support structure 24001 provides a work surface (e.g., a table top) when base support(s) 26049 are supporting support structure 24001. Base structure(s) 26049 can be coupled to support structure 24001 (e.g., at first member 24002 and fourth member 24005). For example, a first one of base structure(s) 26049 can be coupled to first member 24002 via first member left base attachment mechanism (not shown at FIG. 26) and/or fourth member 24005 via fourth member left base attachment mechanism 24046 (FIG. 24); and/or a second one of base structure(s) 26049 can be coupled to first member 24002 via first member right base attachment mechanism (not shown at FIG. 26) and/or fourth member right base attachment mechanism 24047 (FIG. 24).

In some embodiments, the first member left base attachment mechanism and/or the first member right base attachment mechanism can be configured to translate along first member 24002. Further, fourth member left base attachment mechanism 24046 (FIG. 24) and/or fourth member right base attachment mechanism 24047 (FIG. 24) can be configured to translate along fourth member 24005. Accordingly, the coupling positions of base structure(s) 26049 can be controlled. In these or other embodiments, the first member left base attachment mechanism and/or the first member right base attachment mechanism can be locked in place to prevent translation along first member 24002. Further, fourth member left base attachment mechanism 24046 (FIG. 24) and/or fourth member right base attachment mechanism 24047 (FIG. 24) can be locked in place to prevent translation along fourth member 24005. In still other embodiments, one or more of the first member left base attachment mechanism, the first member right base attachment mechanism, fourth member left base attachment mechanism 24046 (FIG. 24), and/or fourth member right base attachment mechanism 24047 (FIG. 24) can be immovable.

In many embodiments, base structure(s) 26049 can be similar or identical to each other. Generally, base structure(s) 26049 can comprise two base structures, but base structure(s) 26049 can comprise any suitable number of base structures (e.g., one, three, four, etc.). In some embodiments, base structure(s) 26049 can be similar or identical to the saw horses described above with respect to work table 100 (FIG. 1) and/or saw horses 764 (FIG. 6). Other exemplary embodiments of base structure(s) 26044 are described below.

The lateral index member(s) can be similar or identical to lateral index members 712 (FIGS. 12, 14, 15, 17A, & 17B). For example, the lateral index member(s) can be coupled to first member 24002 (e.g., at first member distal face 24017 (FIG. 24)). Further, the longitudinal index member(s) can be similar or identical to longitudinal index members 714 (FIGS. 12, 14, 15, 16, 17A, 17B, 22A, & 22B). For example, the longitudinal index member(s) can be coupled to second member 24005 (e.g., at second member left face 24020 (FIG. 24)) and/or third member 24004 (e.g., at third member right face 24025 (FIG. 24)). One or more of the lateral index member(s) and/or one or more of the longitudinal index members can be adjustable. In many examples, one or more of the lateral index member(s) and/or one or more of the longitudinal index member(s) can be vertically adjustable and/or rotatably adjustable. For example, one or more of the lateral index member(s) and/or one or more of the longitudinal index member(s) can be vertically adjustable to move the one or more of the lateral index member(s) and/or the one or more of the longitudinal index member(s) into and out of the working plane. Meanwhile, one or more of the lateral index member(s) and/or one or more of the longitudinal index member(s) can be rotatably adjustable to move the one or more of the lateral index member(s) and/or the one or more of the longitudinal index member(s) between an operation configuration (e.g., permitting vertical adjustment) and a storage configuration (e.g., parallel with the member of support structure 24001 to which the index member is coupled). Further, upon adjustment to a desirable configuration and/or position, the lateral index member(s) and/or the longitudinal index member(s) can be locked into place.

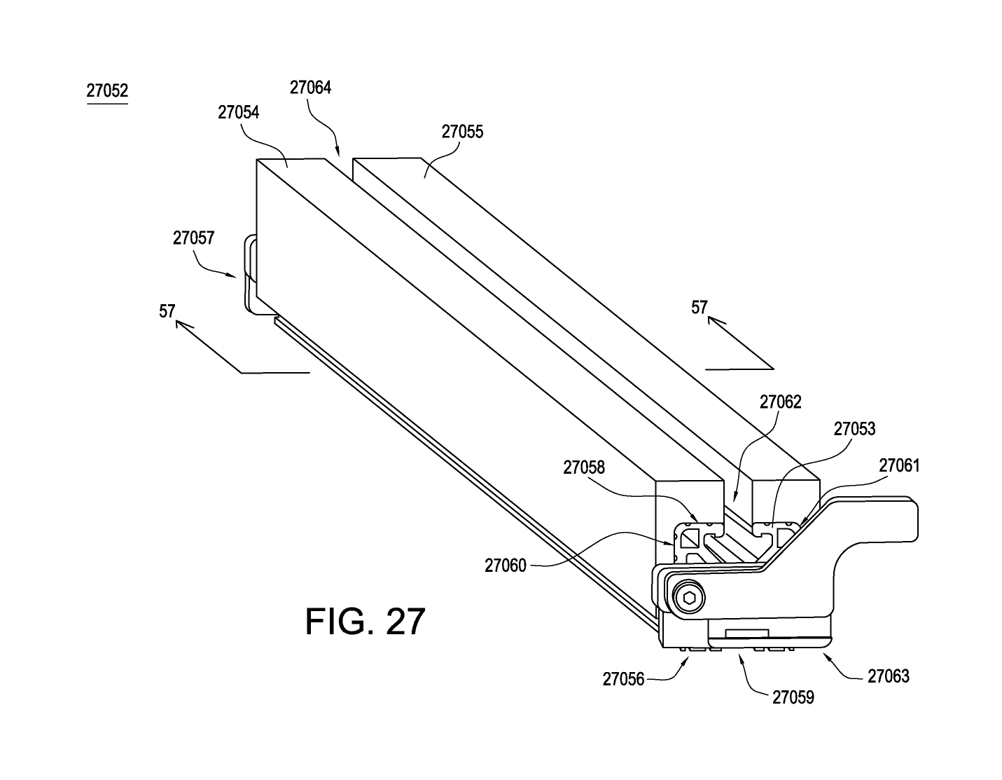

Turning ahead in the drawings, FIG. 27 illustrates cross member 27052, according to an embodiment. Each of cross member(s) 26044 can be similar or identical to cross member 27052.

Cross member 27052 can comprise central member 27053, sacrificial member 27054, and/or sacrificial member 27055. In some embodiments, sacrificial member 27054, and/or sacrificial member 27055 can be omitted. Further, cross member 27052 can comprise cross member proximal coupling mechanism 27056 and/or cross member distal coupling mechanism 27057. Central member 27053 can comprise central member proximal end 27063 and central member distal end 27064.

In some embodiments, when desirable, sacrificial member 27054 and sacrificial member 27055 can be implemented as one element instead of multiple elements. Sacrificial member 27054 and sacrificial member 27055 can be similar or identical to each other. Further, sacrificial member 27054 and/or sacrificial member 27055 each can be configured and/or function similarly or identically to the sacrificial portions as described above with respect to support members 120 (FIG. 1 and/or FIG. 6), support member 120E (FIGS. 2 & 3), and/or support members 120A-120D (FIGS. 4A-4D).

Although central member 27053 can comprise any suitable cross sectional shape (e.g., a circle, an oval, a triangle, a rectangle, etc.), in many examples, central member 27053 can comprise a square cross section. Accordingly, central member 27053 can comprise one or more faces. For example, central member 27053 can comprise central member top face 27058, central member bottom face 27059, central member left face 27060, and/or central member right face 27061. In many embodiments, central member top face 27058 can be opposite central member bottom face 27059, and central member left face 27060 can be opposite central member right face 27061.

Further, central member 27053 can comprise one or more channels 27062. One or more of channel(s) 27062 can be similar to groove 160 (FIGS. 2, 3, 4A, 4C, and/or 4D). For example, one or more of channel(s) 27062 can comprise an L-shaped or T-shaped cross section. Although in many embodiments, each of channel(s) 27062 can be similar or identical to each other, in other embodiments, one or more channels of channel(s) 27062 can differ from one or more other channels of channel(s) 27062. For example, one or more first channels of channel(s) 27062 can comprise an L-shaped cross section while one or more second channels of channel(s) 27062 comprise a T-shaped cross section. In many embodiments, each of the faces of central member 27053 can comprise at least one channel of channel(s) 27062. However, in other embodiments, one or more of the faces may be devoid of channel(s) 27062, or in still other embodiments, channel(s) 27062 can be omitted.

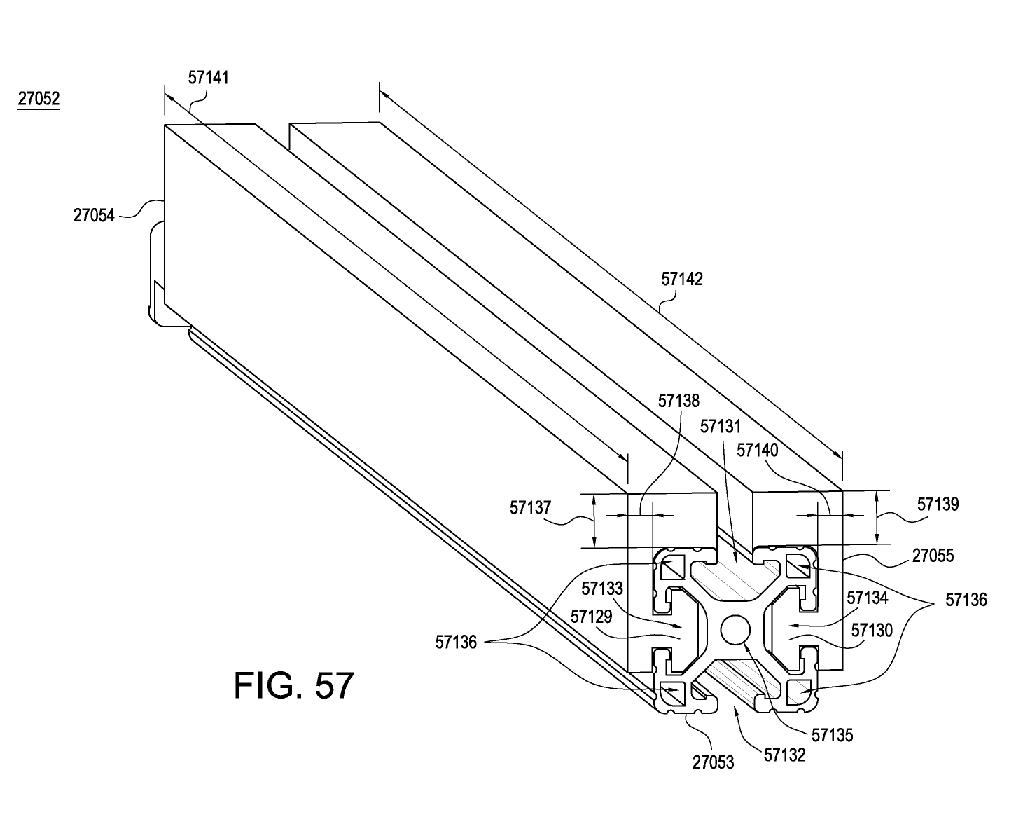

Turning ahead in the drawings, FIG. 57 illustrates a cross sectional view of cross member 27052 taken along line 57-57 of FIG. 27, according to the embodiment of FIG. 27. In many embodiments, sacrificial member 27054 can comprise coupling mechanism 57129, and sacrificial member 27055 can comprise coupling mechanism 57130. Meanwhile, in these or other embodiments, channel(s) 27062 can comprise first channel 57131, second channel 57132, third channel 57133, and fourth channel 57134. Further, central member top face 27058 (FIG. 27) can comprise first channel 57131, central member bottom face 27059 (FIG. 27) can comprise second channel 57132, central member left face 27060 (FIG. 27) can comprise third channel 57133, and central member right face 27061 (FIG. 27) can comprise fourth channel 57134. Further still, central member 27053 can comprise central conduit 57135 and one or more secondary conduits 57136.

Further, sacrificial member 27054 can comprise top thickness 57137 and side thickness 57138. Likewise, sacrificial member 27055 can comprise top thickness 57139 and side thickness 57140. Meanwhile, sacrificial member 27054 can comprise length 57141, and/or sacrificial member 27055 can comprise length 57142.

For ease of reference, top thickness 57137, side thickness 57138, top thickness 57139, side thickness 57140, length 57141, and length 57142 are defined herein relative to central member 27053 when sacrificial member 27054 and sacrificial member 27055 are coupled to central member 27053. However, reference to central member 27053 is not intended to be limiting as top thickness 57137, side thickness 57138, top thickness 57139, side thickness 57140, length 57141, and length 57142 can still exist independently of central member 27053 (i.e., when sacrificial member 27054 and/or sacrificial member 27055 are decoupled from central member 27053).

For example, top thickness 57137 can refer to a dimension of sacrificial member 27054 extending perpendicular to and from central member top face 27058 (FIG. 27) when sacrificial member 27054 is coupled to central member 27053; and/or side thickness 57138 can refer to a dimension of sacrificial member 27054 extending perpendicular to and from central member left face 27060 (FIG. 27) when sacrificial member 27054 is coupled to central member 27053. Meanwhile, top thickness 57139 can refer to a dimension of sacrificial member 27055 extending perpendicular to and from central member top face 27058 (FIG. 27) when sacrificial member 27055 is coupled to central member 27053; and/or side thickness 57140 can refer to a dimension of sacrificial member 27055 extending perpendicular to and from central member right face 27061 (FIG. 27) when sacrificial member 27055 is coupled to central member 27053. Accordingly, in many embodiments, side thickness 57138 and side thickness 57140 can extend in opposing directions and top thickness 57137, and top thickness 57139 can extend approximately parallel to each other in the same direction.

Meanwhile, length 57141 can refer to a dimension of sacrificial member 27054 extending parallel to central member 27053 when sacrificial member 27054 is coupled to central member 27053; and length 57142 can refer to a dimension of sacrificial member 27055 extending parallel to central member 27053 when sacrificial member 27055 is coupled to central member 27053. In particular, in many examples, length 57141 and/or length 57142 can refer to the longest dimensions of sacrificial member 27054 and/or sacrificial member 27055, respectively.

In many embodiments, top thickness 57137 can be similar or identical to top thickness 57139; side thickness 57138 can be similar or identical to side thickness 57140; and/or length 57141 can be similar or identical to length 57142.

In specific examples, length 57141 and/or length 57142 can comprise approximately 101.6 centimeters. Further, top thickness 57137 and/or top thickness 57139 can comprise approximately 1.27 centimeters; and/or side thickness 57138 and/or side thickness 57140 can comprise approximately 0.635 centimeters. Increasing top thickness 57137, side thickness 57138, top thickness 57139, and/or side thickness 57140 can provide room for error to minimize the likelihood of tools coming into contact with central member 27053 when being used to shape a work piece. However, because increasing top thickness 57137, side thickness 57138, top thickness 57139, and/or side thickness 57140 increases the cost of sacrificial member 27054 and/or sacrificial member 27055, top thickness 57137, side thickness 57138, top thickness 57139, and/or side thickness 57140 it can be desirable to constraint the thicknesses of top thickness 57137, side thickness 57138, top thickness 57139, and/or side thickness 57140. Accordingly, for these specific examples, top thickness 57137, side thickness 57138, top thickness 57139, and/or side thickness 57140 can provide suitable margin of error while also minimizing costs.

Referring now back to FIG. 27, in many embodiments, sacrificial member 27054 and/or sacrificial member 27055 can be coupled to central member 27053. For example, sacrificial member 27054 can be coupled to central member 27053 (e.g., at third channel 57133 (FIG. 57) and/or central member left face 27060), and/or sacrificial member 27055 can be coupled to central member 27053 (e.g., at fourth channel 57134 (FIG. 57) and/or central member right face 27061). Meanwhile, in these or other embodiments, sacrificial member 27054 and/or sacrificial member 27055 can be configured to leave exposed one or more channel(s) of channel(s) 27062 located at central member top face 27058 when coupled to central member 27053.

Generally, sacrificial member 27054 and/or sacrificial member 27055 can be coupled to central member 27053 in any suitable manner. Nonetheless, in many embodiments, coupling mechanism 57129 (FIG. 57) and coupling mechanism 57130 (FIG. 57) each can comprise a rail. The rail(s) can extend along part or all of lengths 57141 (FIG. 57) and/or 57142 (FIG. 57) of sacrificial member 27054 and/or sacrificial member 27055, respectively, as applicable. One or more of channel(s) 27062 can be configured to receive coupling mechanism 57129 (FIG. 57) and/or coupling mechanism 57130 (FIG. 57) (e.g., the rail(s)) so that sacrificial member 27054 and/or sacrificial member 27055 can be coupled to central member 27053. For example, in many embodiments, when coupling mechanism 57129 (FIG. 57) and/or coupling mechanism 57130 (FIG. 57) comprise rail(s), the rail(s) can be inserted into third channel 57133 (FIG. 57) and fourth channel 57134 (FIG. 57) at one of central member proximal end 27063 or central member distal end 27064 and moved along the lengths (e.g., longest dimensions) of the third channel 57133 (FIG. 57) and fourth channel 57134 (FIG. 57) toward the opposing ones of central member proximal end 27063 or central member distal end 27064.

Meanwhile, cross member proximal coupling mechanism 27056 can be coupled to central member 27053 (e.g., central member proximal end 27063), and/or cross member distal coupling mechanism 27057 can be coupled to central member 27053 (e.g., central member distal end 27064). In some embodiments, cross member proximal coupling mechanism 27056 and/or cross member distal coupling mechanism 27057 can be coupled to central member 27053 via one or more bolts. The bolts can be received at central conduit 57135 (FIG. 57), which can extend through part or all of the length (e.g., longest dimension) of central member 27053. Additionally, or alternatively, cross member proximal coupling mechanism 27056 and/or cross member distal coupling mechanism 27057 can be coupled to central member 27053 via one or more set screws. The set screws can be received at one or more of secondary conduits 57136 (FIG. 57). Meanwhile, the set screws and/or one or more tabs extending from cross member proximal coupling mechanism 27056 and/or cross member distal coupling mechanism 27057 into one or more channels of channel(s) 27062 and/or one or more conduits of secondary conduit(s) 57136 (FIG. 57) can prevent cross member proximal coupling mechanism 27056 and/or cross member distal coupling mechanism 27057 from rotating about the bolts coupled to central member 27053. Notably, in some embodiments, one or both of cross member proximal coupling mechanism 27056 and/or cross member distal coupling mechanism 27057 can be decoupled from central member 27053 to permit sacrificial member 27054 and/or sacrificial member 27055 can be coupled to and/or decoupled from central member 27053. For example, decoupling one or both of cross member proximal coupling mechanism 27056 and/or cross member distal coupling mechanism 27057 from central member 27053 can provide access to the end(s) of one or more of channel(s) 27062, such as, for example, to the end(s) of third channel 57133 (FIG. 57) and/or fourth channel 57134 (FIG. 57).

Further, cross member proximal coupling mechanism 27056 and/or cross member distal coupling mechanism 27057 can be configured to couple cross member 27052 to support structure 24001 (FIG. 24). For example, cross member proximal coupling mechanism 27056 can be coupled to first member 24002 (FIG. 24) (e.g., at first member top face 24018 (FIG. 24) and/or via one or more of channel(s) 24043 (FIG. 24)), and/or cross member distal coupling mechanism 27057 can be coupled to fourth member 24005 (FIG. 24) (e.g., at fourth member top face 24030 (FIG. 24) and/or via one or more of channel(s) 24043 (FIG. 24)).

Indeed, in some embodiments, cross member proximal coupling mechanism 27056 and/or cross member distal coupling mechanism 27057 can be similar or identical to the locking mechanism described above with respect to FIG. 2. In these or other embodiments, cross member proximal coupling mechanism 27056 and/or cross member distal coupling mechanism 27057 can be similar or identical to the locking mechanism described above with respect to FIG. 3.

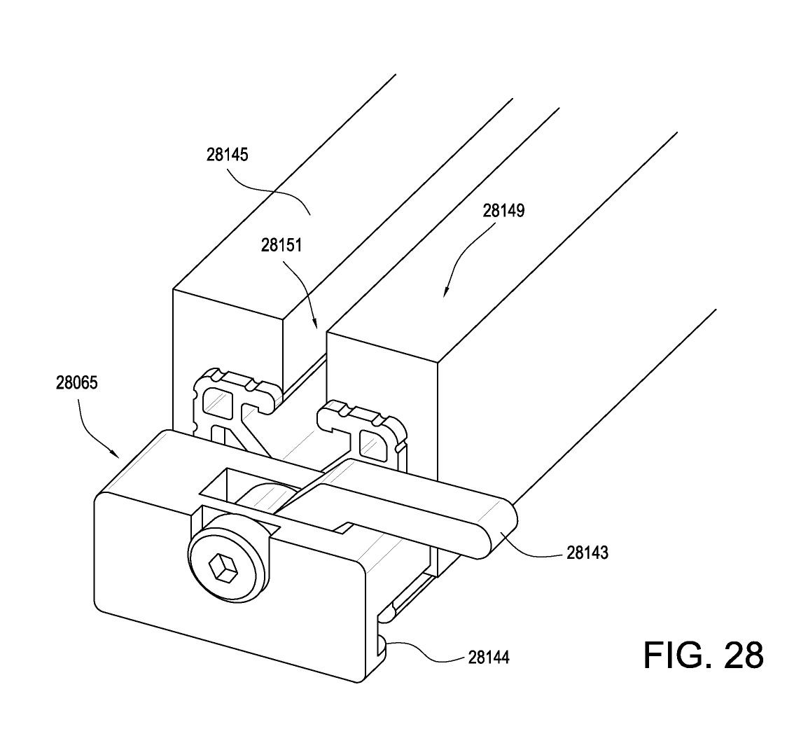

Accordingly, in some embodiments, cross member proximal coupling mechanism 27056 and/or cross member distal coupling mechanism 27057 can be configured to lock cross member 27052 to support structure 24001 (FIG. 24) when cross member proximal coupling mechanism 27056 and/or cross member distal coupling mechanism 27057 are coupled to support structure 24001 (FIG. 24). Implementing cross member proximal coupling mechanism 27056 and/or cross member distal coupling mechanism 27057, such as, for example, using embodiments similar or identical to the locking mechanism described with respect to FIG. 3 and/or cross member proximal coupling mechanism 28065 (FIG. 28), so that cross member 27052 locks to support structure 24001 (FIG. 24) when cross member proximal coupling mechanism 27056 and/or cross member distal coupling mechanism 27057 are coupled to support structure 24001 (FIG. 24) can help prevent cross member 27052 from sliding laterally on first member 24002 (FIG. 24) and/or fourth member 24005 (FIG. 24).

In general, similar to first member 24002 (FIG. 24), second member 24003 (FIG. 24), third member 24004 (FIG. 24), and/or fourth member 24005 (FIG. 24), cross member 27052 can comprise any suitable material, such as, for example, metal (e.g., aluminum, iron, titanium, etc.), metal alloy (e.g., steel, etc.), wood, polymer, composites (e.g., carbon fiber), etc. In many embodiments, part or all of cross member 27052 can be fabricated by extrusion. Accordingly, in these embodiments, material selection can be dependent on whether the material can be extruded and/or how easily it can be extruded. In many examples, central member 27053, cross member proximal coupling mechanism 27056 and/or cross member distal coupling mechanism 27057 can comprise aluminum, and sacrificial member 27054 and/or sacrificial member 27055 can comprise a polymer. In these or other embodiments, cross member proximal coupling mechanism 27056 and/or cross member distal coupling mechanism 27057 also can comprise a polymer, such as, for example, at locking wedge(s) or cam lever(s) of cross member proximal coupling mechanism 27056 and/or cross member distal coupling mechanism 27057. Further, in these or other embodiments, cross member proximal coupling mechanism 27056 and/or cross member distal coupling mechanism 27057 also can comprise rubber. For example, using rubber cushioning at cross member proximal coupling mechanism 27056 and/or cross member distal coupling mechanism 27057 (e.g., between the locking wedge(s) or cam lever(s) of cross member proximal coupling mechanism 27056 and/or cross member distal coupling mechanism 27057 and support structure 24001 (FIG. 24)) can help mitigate wear on support structure 24001 (FIG. 24) when cross member proximal coupling mechanism 27056 and/or cross member distal coupling mechanism 27057 are coupled to support structure 24001 (FIG. 24). Further, implementing rubber can also permit the locking wedge(s) or cam lever(s) of cross member proximal coupling mechanism 27056 and/or cross member distal coupling mechanism 27057 to be implemented with greater coupling strength than may be possible (i.e., without damaging support structure 24001 (FIG. 24) in the absence of the rubber.

Further, cross member 27052 can comprise any suitable dimensions. For example, in some embodiments, central member 27053 can comprise a square cross section having approximately 3.81 centimeter sides. Further, in some embodiments, the lengths of central member 27053 and/or channels 27062, length 57141 (FIG. 57), and/or length 57142 (FIG. 57) each can comprise approximately 101.6 centimeters. Notably, in many embodiments, the lengths of central member 27053, channels 27062, length 57141 (FIG. 57), and/or length 57142 (FIG. 57) can be the same. However, in other embodiments, one or more of the lengths of central member 27053, channels 27062, length 57141 (FIG. 57), and/or length 57142 (FIG. 57) can be different from each other.

Turning ahead again in the drawings, FIG. 28 illustrates cross member proximal coupling mechanism 28065 coupled to cross member 28145 and configured in active configuration 28149, according to an embodiment. In many embodiments, cross member proximal coupling mechanism 27056 and/or cross member distal coupling mechanism 27057 can be similar or identical to cross member proximal coupling mechanism 28065, and vice versa. Further, cross member 28145 can be similar or identical to cross member support members 120 (FIG. 1 and/or FIG. 6), support member 120E (FIGS. 2 & 3), support members 120A-120D (FIGS. 4A-4D), and/or cross member 27052 (FIG. 27). Accordingly, in various embodiments, cross member 28145 can comprise channel 28151, and channel 28151 can be similar or identical to first channel 57131 (FIG. 57).

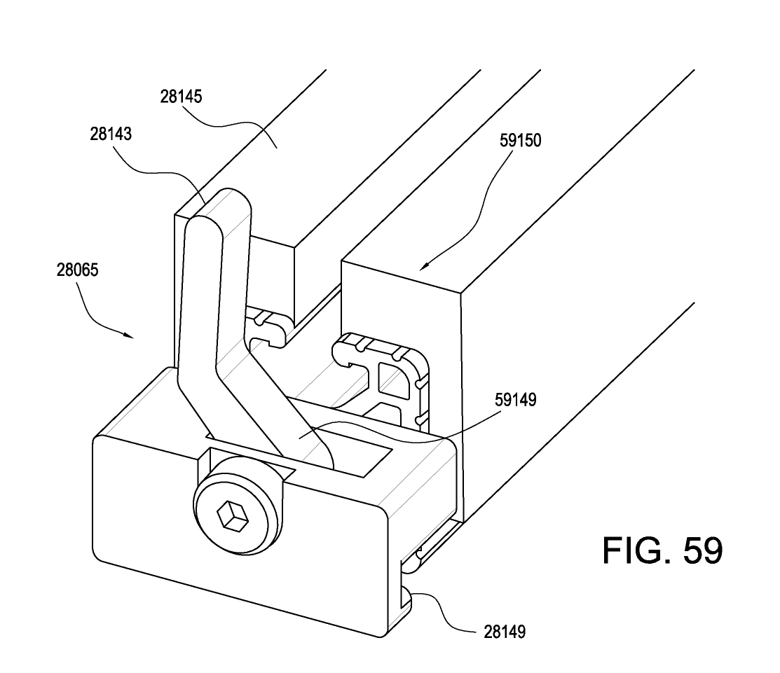

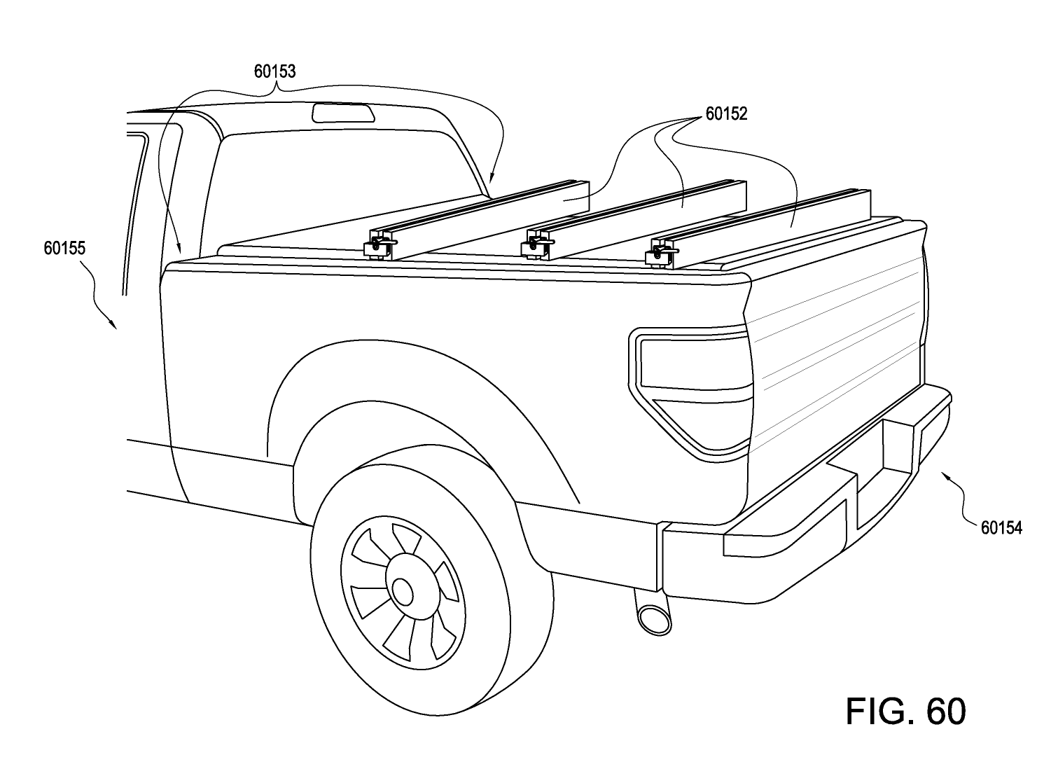

Coupling mechanism 28065 can comprise cam lever 28143 and ledge 28144. Meanwhile, cam lever 28143 can comprise cammed fulcrum 59149 (FIG. 59).

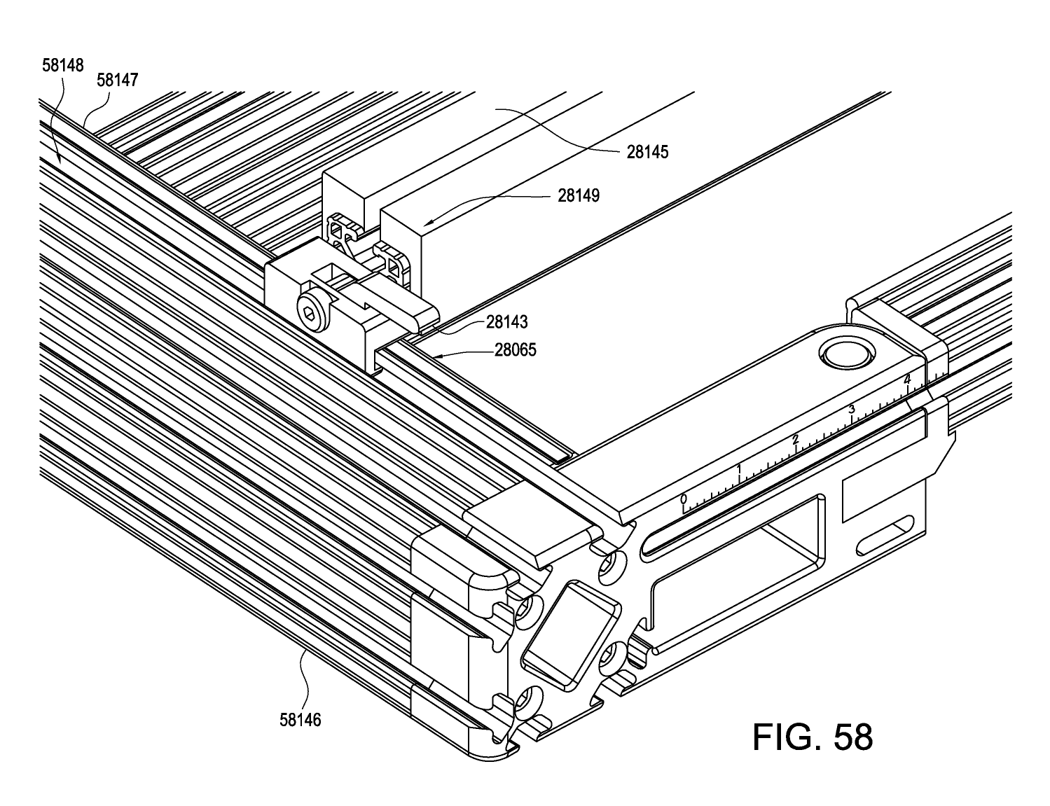

Skipping ahead in the drawings, FIG. 58 illustrates cross member proximal coupling mechanism 28065 in active configuration 28149, coupling cross member 28145 to member 58146, according to the embodiment of FIG. 28. Member 58146 can be similar or identical to side members 130 of work table 100 (FIG. 1), stationary side member 710 (FIGS. 6 & 23), and/or first member 24002 (FIG. 24). Accordingly, member 58146 can comprise top surface 58147 and channel 58148. Top surface 58147 can be similar or identical to first member top face 24018 (FIG. 24), and channel 58148 can be similar or identical to channel(s) 24043 (FIG. 24).

In general, cam lever 28143 can be similar to the locking wedge (e.g., locking wedge 126 (FIG. 3) of the locking mechanism described above with respect to FIGS. 2 & 3. However, unlike the locking wedge (e.g., locking wedge 126 (FIG. 3)), which can operate at support member attachment channel 140 (FIGS. 1-3) by applying pressure (e.g., opposing pressure) at the sidewalls of support member attachment channel 140, cam lever 28143 can operate such that cammed fulcrum 59149 (FIG. 59) interferes with top surface 58147 while ledge 28144 (FIG. 28) is received at channel 58148, and when cross member proximal coupling mechanism 28065 is configured in active configuration 28149. Specifically, in these embodiments, when cross member proximal coupling mechanism 28065 is configured in active configuration 28149, an eccentric portion of cammed fulcrum 59149 (FIG. 59) can apply pressure (e.g., attractive pressure) with ledge 28144 (FIG. 28) at opposing sides of a lip projecting into channel 58148, operatively clamping the projecting lip between cammed fulcrum 59149 (FIG. 59) and ledge 28144 (FIG. 28). As a result, cross member proximal coupling mechanism 28065 can operatively lock cross member 28145 in position. In these or other embodiments, the opposing sides of the projecting lip can comprise top surface 58147 and an opposing shoulder surface of the projecting lip, respectively. Further, in many examples, the projecting lip can be present when channel 58148 comprises a T-shaped cross section or an L-shaped cross section.

Turning to the next drawing, FIG. 59 illustrates cross member proximal coupling mechanism 28065 coupled to cross member 28145 and configured in inactive configuration 59150 such that an eccentric portion of cammed fulcrum 59149 is rotated away from ledge 28144 (FIG. 28), according to the embodiment of FIG. 28. Although the eccentric portion of cammed fulcrum 59149 can be biased according to any suitable extent, in many embodiments, the eccentric portion of cammed fulcrum 59149 can be biased by 0.0635 centimeters more than a non-eccentric portion of cammed fulcrum 59149. Notably, as shown at FIGS. 28 and 59, cam lever 28143 can be configured so as not to interfere with channel 28151 whether configured in active configuration 28149 (FIG. 29) or inactive configuration 59150.

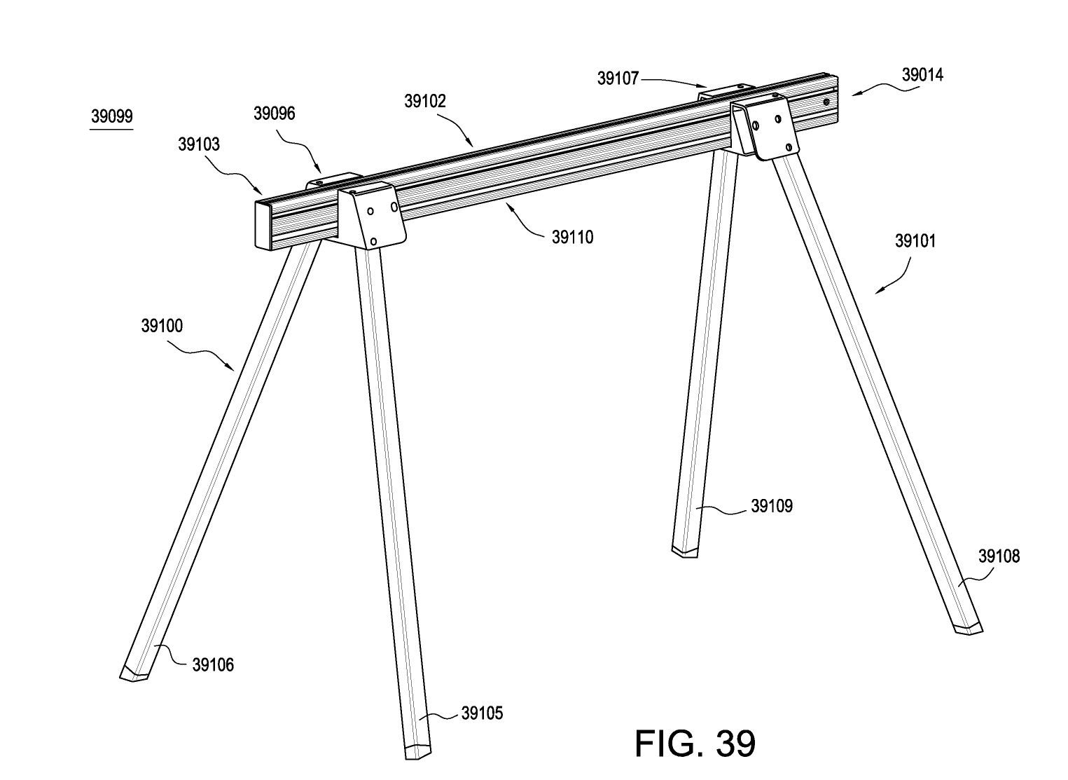

Returning briefly to FIG. 27, although cross member 27052 is generally discussed herein as being implemented with support structure 24001 (FIG. 24), work table 26048, and/or one or more other cross members similar or identical to cross member 27052, in some embodiments, cross member 27052 can be implemented in any other suitable manner. For example, in various embodiments, cross member 27052, cross member proximal coupling mechanism 27056, and/or cross member distal coupling mechanism 27057 can be coupled to any structure and/or structures having one or more channels similar or identical to channel(s) 24043 (FIG. 24). More specifically, in some embodiments, cross member 27052, cross member proximal coupling mechanism 27056, and/or cross member distal coupling mechanism 27057 can be coupled to any extruded beam having one or more channels similar or identical to channel(s) 24043 (FIG. 24). In these embodiments, for example, the extruded beam can be similar or identical to base structure cross member 39102 (FIG. 39). Meanwhile, FIG. 60 illustrates cross members 60152 coupled between sidewalls 60153 of truck bed 60154 of vehicle 60155, according to an embodiment. Notably, cross members 60152 each can be similar or identical to cross member 27052 (FIG. 27).

Now, turning back in the drawings, FIG. 29 illustrates a ride side view of work table 26048 of system 24000 in work table angled configuration 29066 of work table angled configuration(s) 29050, according to the embodiment of FIG. 24. In many embodiments, work table 26048 can be configured so that support structure 24001 can rotate about first member 24002 from work table resting configuration 26051 (FIG. 26) to work table angled configuration(s) 29050 (e.g., work table angled configuration 29066). In these embodiments, work table 26048 can be moved from work table resting configuration 26051 (FIG. 26) to work table angled configuration(s) 29050, as desirable, to reorient the working plane. Accordingly, a distal portion of a work piece located at the working plane can be moved closer to a user of work table 26048.

In many examples, work table 26048 can be moved from work table resting configuration 26051 (FIG. 26) to work table angled configuration(s) 29050 over an arc of approximately 0 degrees at a minimum to approximately 65 degrees at a maximum. In other embodiments, the maximum can be greater than 65 degrees (e.g., approximately 90 degrees) or less than 65 degrees.

In these embodiments, system 24000 and/or work table 26048 can comprise kickstand 29117 and kickstand receiver 29120. Kickstand 29117 can comprise kickstand lower end 29118 and kickstand upper end 29119.

Kickstand receiver 29120 can be coupled to one of structures 26049 and can be configured to receive kickstand 29117, such as, for example, via kickstand lower end 29118. Meanwhile, kickstand 29117 can also be coupled to support structure 24001 (e.g., via kickstand upper end 29119), such as, for example, at one of fourth member left base attachment mechanism 24046 (FIG. 24) or right base attachment mechanism 24047 (FIG. 24).

Kickstand 29117 can slide up or down within kickstand receiver 29120 to move work table between work table resting configuration 26051 (FIG. 26) and work table angled configuration(s) 29050. Kickstand receiver 29120 can be configured to lock kickstand 29117 at one or more of work table resting configuration 26051 (FIG. 26) and work table angled configuration(s) 29050. In some embodiments, kickstand 29117 can be decoupled from the one of base structure(s) 26049 (e.g., by lifting kickstand 29117 up out of kickstand receiver 29120) and/or support structure 24001 and stowed in a hollow middle of a base structure cross member of one of base structure(s) 26049.

Although rotation of work table 26048 is shown at FIG. 29 using manual operation, in other embodiments, rotation can be pneumatically and/or electrically powered. Further, the rotation could be automated.

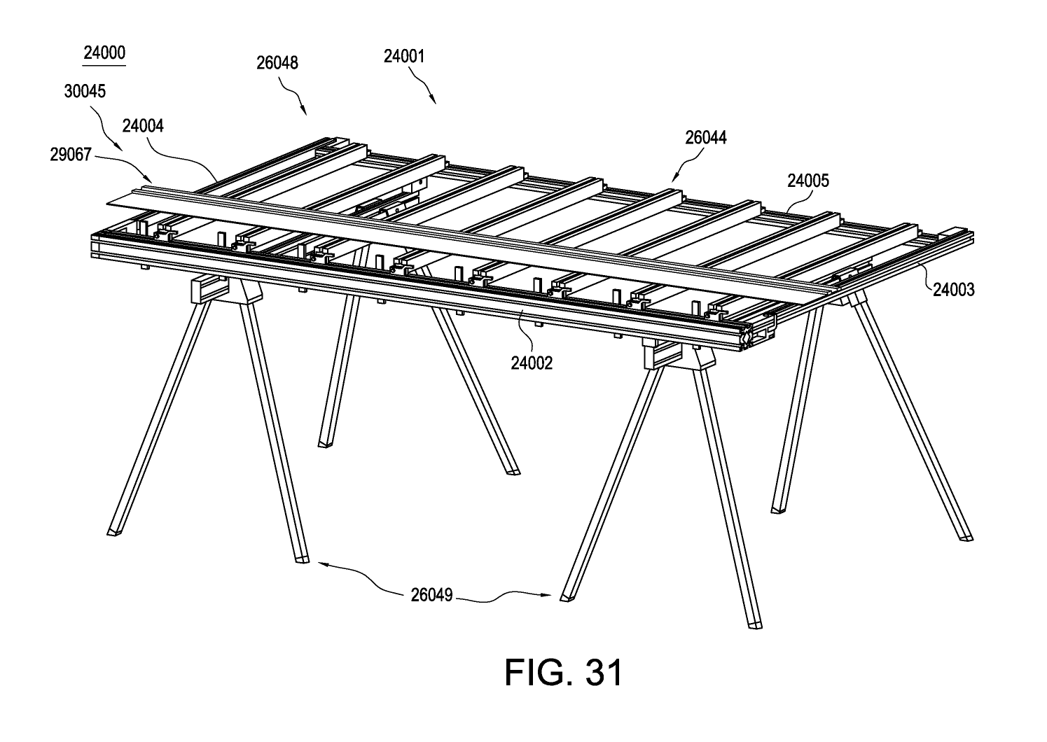

Turning ahead in the drawings, FIG. 30 illustrates a partial right side view of work table 26048 of system 24000 implementing tool guide 30067, according to the embodiment of FIG. 24. In many embodiments, tool guide 30067 can be similar or identical to tool guide 202 (FIGS. 14 & 15). Meanwhile, FIG. 31 illustrates a top, front, ride side view of work table 26048 of system 24000 implementing tool guide 30067, according to the embodiment of FIG. 24. In many examples, accessory element(s) 30045 can comprise tool guide 30067.

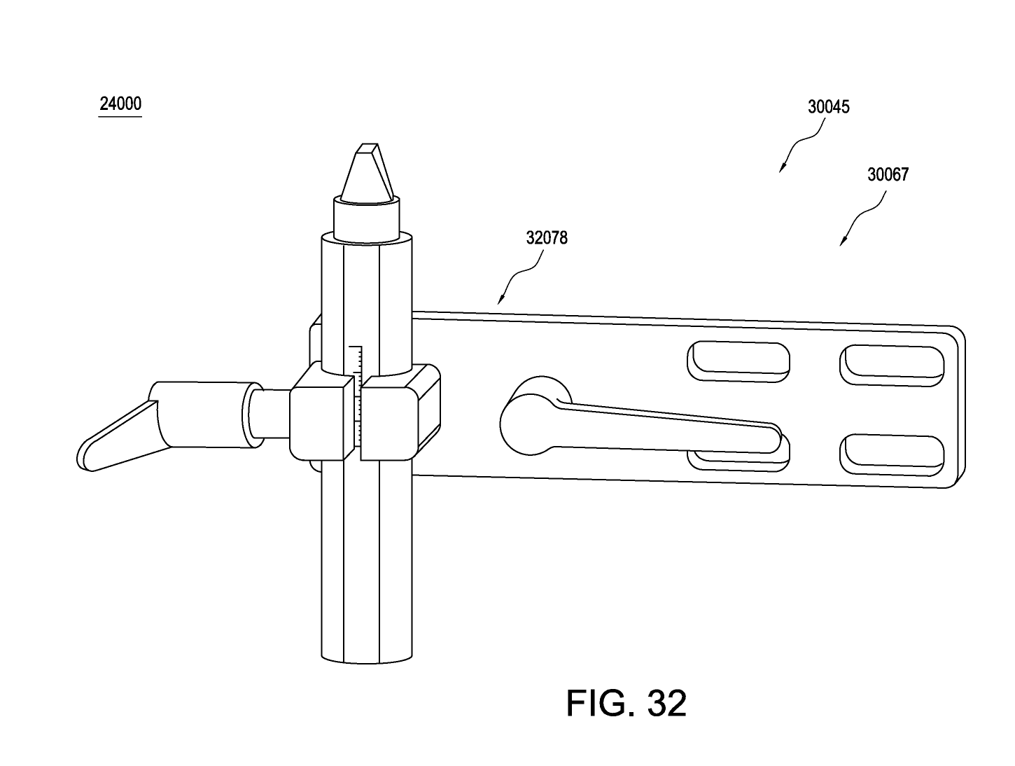

Referring to FIG. 30, tool guide 30067 can comprise right tool guide receiver 30073, left tool guide receiver 32078 (FIG. 32), and tool guide track 30072. Right tool guide receiver 30073 can comprise right receiver attachment member 30068 and right receiver post 30069. Right receiver post 30069 can comprise right receiver 30070 and can be coupled to right receiver attachment member 30068. Right receiver attachment member 30068 can be configured to couple to and/or translate along second member 24003 (e.g., along second member right face 24021). Right receiver post 30069 and/or right receiver 30070 can be configured to receive tool guide track 30072. Accordingly, when right receiver post 30069 and/or right receiver 30070 receive tool guide track 30072, translating right receiver attachment member 30068 along second member 24003 also can translate tool guide track 30072 longitudinally between first member 24002 and fourth member 24005 (FIG. 24).

Tool guide track 30072 can be similar or identical to tool guide track 220 (FIGS. 14 & 15); right receiver attachment member 30068 can be similar or identical to one of attachment members 210 (FIGS. 14 & 15); and/or right receiver post 30069 can be similar or identical to one of posts 212 (FIG. 15). Left tool guide receiver 32078 (FIG. 32) can be similar or identical to right tool guide receiver 30073, but can be coupled to third member 24004 (FIG. 24) as opposed to second member 24003. FIG. 32 illustrates a perspective view of left tool guide receiver 32078 of tool guide 30067 when left tool guide receiver 32078 is decoupled from work table 26048, according to the embodiment of FIG. 24.

Meanwhile, right receiver 30070 can be similar to narrowed end 214 (FIG. 15). However, right receiver 30070 can be spring loaded so that when receiver 30070 receives tool guide track 30072, right receiver 30070 lowers tool guide track 30072 to lie substantially within and/or proximate to the working plane. Implementing right receiver 30070 with spring loading can be advantageous when a work piece is warped so that the work piece is not substantially parallel to tool guide track 30072.

In many embodiments, right end cap 24032 (FIG. 24), second member 24003, and/or right receiver attachment member 30068 can comprise right measurement mechanism 30074. Right measurement mechanism 30074 can comprise an analog or digital measurement device configured permitting the user of system 24000 to determine a distance right receiver attachment member 30068 translate along second member 24003. Accordingly, although right measurement mechanism 30074 is illustrated at FIG. 30 as an analog measurement device (e.g., laser etched at right end cap 24032 (FIG. 24) and/or second member 24003), in other embodiments, when right measurement mechanism 30074 comprises a digital measurement device, right measurement mechanism can comprise an electronic display to indicate the appropriate distances measured. Meanwhile, although right measurement mechanism 30074 is shown extending only part of the way along right end cap 24032 (FIG. 24), in many examples, right measurement mechanism 30074 can provide measurements along part or all of right end cap 24032 (FIG. 24) and/or second member 24003. Right receiver attachment member 30068 can comprise windows to show position for an analog measurement device.

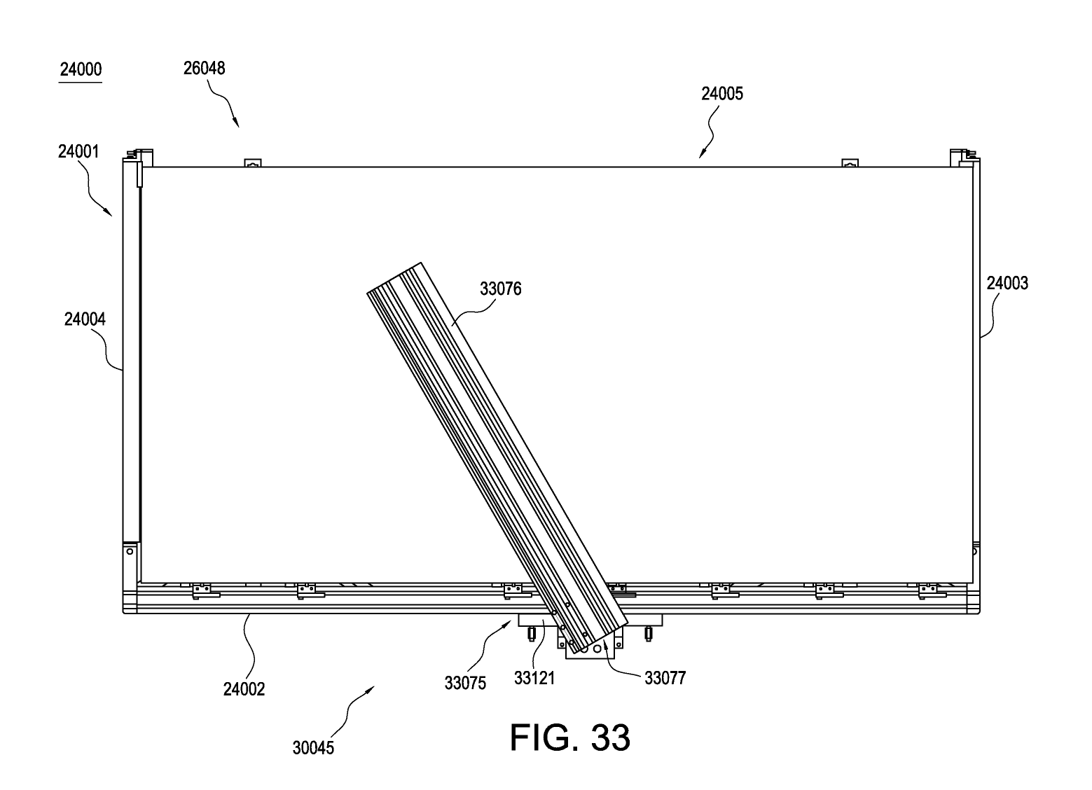

Turning ahead in the drawings, FIG. 33 illustrates a top view of work table 26048 of system 24000 implementing tool guide 33075 when a work piece is disposed over work table 26048, according to the embodiment of FIG. 24. In many examples, accessory element(s) 30045 can comprise tool guide 33075.

Tool guide 33075 can comprise cantilevered tool guide track 33076, base member 33121, and multidirectional arm 33077. In many embodiments, tool guide 33075 can be similar or identical to tool guide 300 (FIGS. 16-17B). Further, cantilevered tool guide track 33076 can be similar or identical to cantilevered tool guide track 302 (FIGS. 16-17B); base member 33121 can be similar or identical to attachment member 310 (FIGS. 16-17B); and/or multidirectional arm 33077 can be similar to pivot arm 320 (FIGS. 16-17B).

As tool guide 33075 can be similar or identical to tool guide 300 (FIGS. 16-17B), multidirectional arm 33077 can be configured to permit cantilevered tool guide track 33076 to rotate about base member 33121 as described above with respect to tool guide 300. Further, multidirectional arm 33077 can be configured to permit cantilevered tool guide track 33076 to rotate laterally about base member 33121 (e.g., toward second member 24003 and/or third member 24004). In some examples, multidirectional arm 33077 can be configured so that cantilevered tool guide track 33076 can rotate laterally a full 180 degrees about base member 33121 (e.g., from approximately perpendicular with second member 24003 to approximately perpendicular with third member 24004). In other embodiments, multidirectional arm 33077 can be configured so that cantilevered tool guide track 33076 can rotate laterally any other suitable amount about base member 33121.

In some embodiments, rotation of multidirectional arm 33077 can be automated. In some embodiments, multidirectional arm 33077 can provide a current angular position of cantilevered tool guide track 33076 about base member 33121.

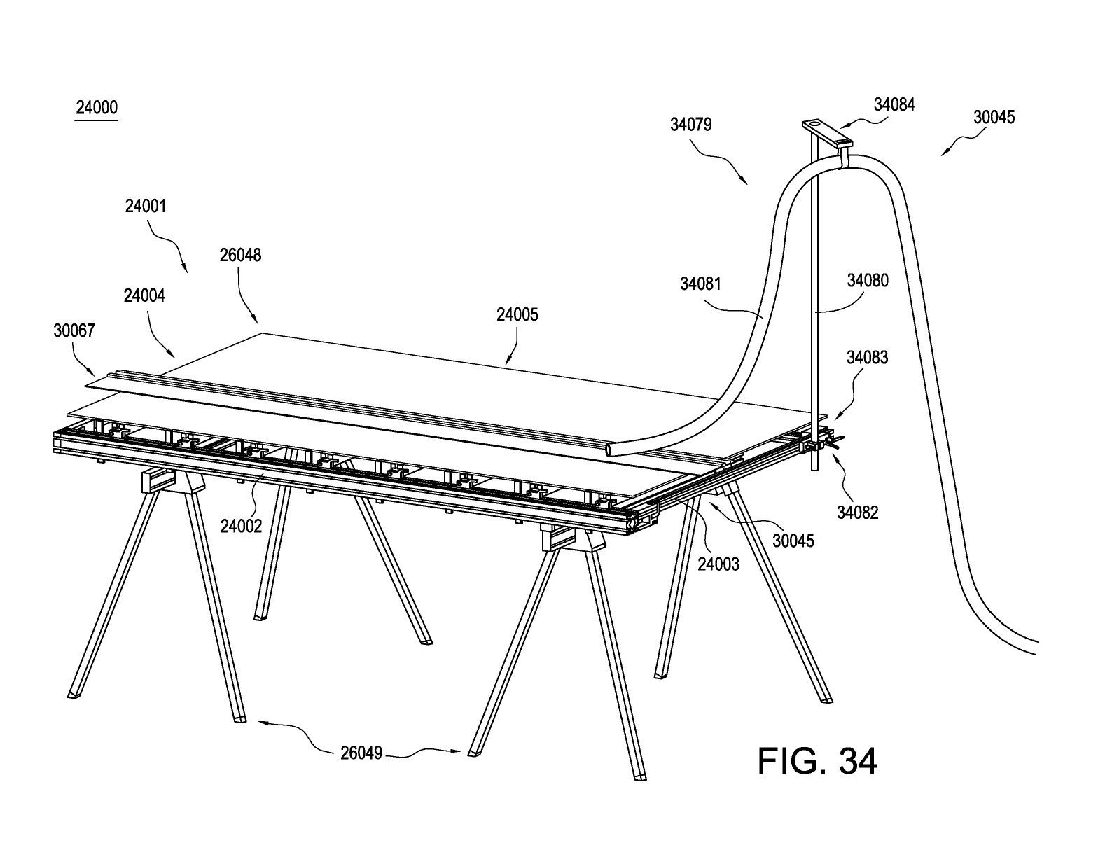

Turning ahead in the drawings, FIG. 34 illustrates a front, top, right side view of work table 26048 of system 24000 implementing vacuum accessory element 34079 and tool guide 30067 when a work piece is disposed over work table 26048, according to the embodiment of FIG. 24. In many examples, accessory element(s) 30045 can comprise vacuum accessory element 34079. In many embodiments, vacuum accessory element 34079 can be implemented without tool guide 30067 and/or with one or more other of accessory element(s) 30045.

Vacuum accessory element 34079 can comprise boom arm 34080, vacuum hose 34081, and/or boom mount 34082. Boom arm 34080 can comprise boom arm mount end 34083 and boom arm vacuum end 34084. Further, in some embodiments, boom arm 34080 can comprise a boom arm riser and a boom arm extension. In these embodiments, boom arm riser can comprise boom arm end 34083 and boom arm extension can comprise boom arm vacuum end 34084.

Vacuum hose 34081 can be coupled to one end to a vacuum (not shown) to provide suction through vacuum hose 34081. Accordingly, vacuum accessory element 34079 can be configured to function as a vacuum at the other end for use with work table 26048, such as, for example, to vacuum saw dust and/or other debris.

Boom mount 34082 can be configured to be coupled to one of members 24002-24005. Further, boom mount 34082 can be configured so that boom mount 34082 can be translated along the one of members 24002-24005 to which boom mount 34082 is mounted. Boom arm 34080 can be coupled to boom mount 34082 (e.g., at boom arm mount end 34083). In some embodiments, boom mount 34082 can be configured so that boom arm 34080 can be lowered or raised at boom mount 34082, as desirable. Boom mount 34082 can be configured so that boom mount 34082 and/or boom arm 34080 can be locked in place to prevent boom mount 34082 from translating at the corresponding one of members 24002-24005 to which boom mount 34082 is mounted and/or to prevent boom arm 34080 from rising or lowering.

Boom arm 34080 can be configured so that vacuum hose 34081 can be coupled to boom arm vacuum end 34084 to hold vacuum hose 34081 in place and out of the way of the work piece. Although boom arm 34080 is illustrated at FIG. 34 as being rigid, in other embodiments, boom arm 34080 can comprise an articulating boom arm, such as, for example, to increase the maneuverability of boom arm 34080 and/or vacuum hose 34081. For example, the articulating boom arm can comprise a flexible, semi-rigid gooseneck tube.

Part or all of boom arm 34080 can comprise aluminum. Part or all of boom arm 34080 (e.g., the boom arm riser) can comprise a hollow tube. The hollow tube can comprise a 2.54 centimeter diameter. Further, the hollow tube can comprise a wall thickness of 0.635 centimeters.

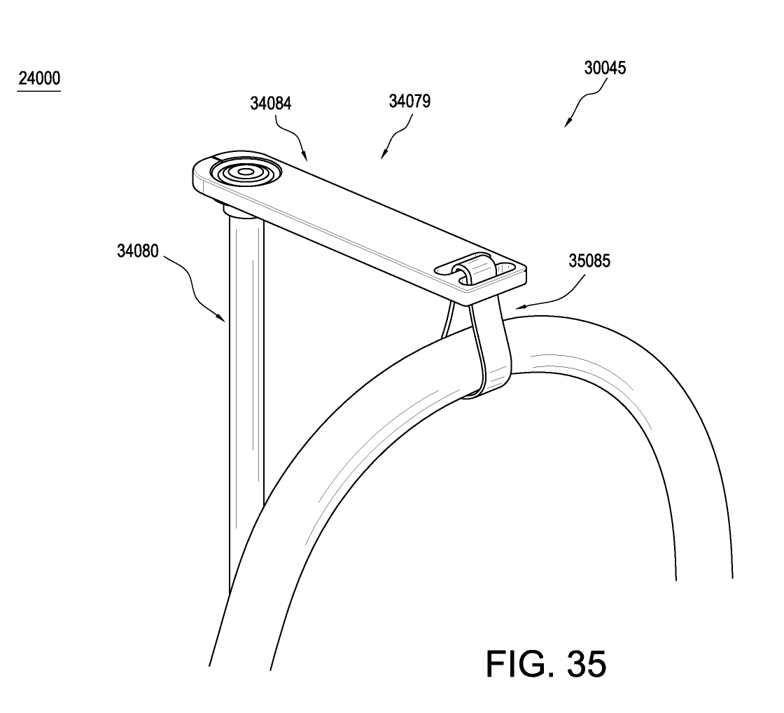

Turning to the next drawing, FIG. 35 illustrates a perspective view of vacuum hose 34081 coupled to boom arm 34080, according to the embodiment of FIG. 24. For example, boom arm 34080 can comprise boom arm coupling mechanism 35085 configured to couple vacuum hose 34081 to boom arm 34080. Boom arm coupling mechanism 35085 can cradle vacuum hose 34081 so that vacuum hose 34081 can be extended and/or shortened, as desirable.

Boom arm coupling mechanism 35085 can comprise a hoop, a strap (e.g., Velcro), etc. Vacuum hose 34081 can be threaded through the hoop and/or the strap can be engaged around vacuum hose 34081, as applicable.

When applicable, the boom arm riser and the boom arm extension can be coupled together, such as, for example, via a shaft bearing. The shaft bearing can permit smooth and/or rugged rotation of the boom arm extension about the boom arm riser. Accordingly, a position of the boom arm extension can be adjustable.

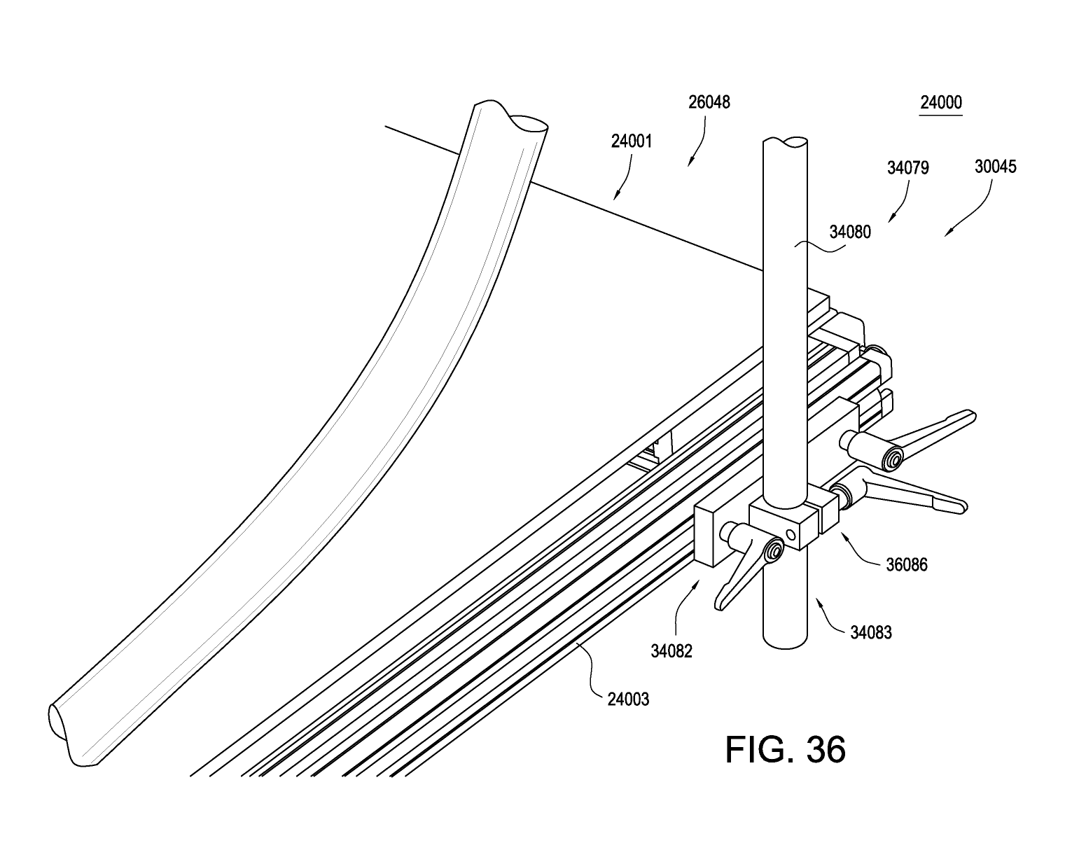

Turning again to the next drawing, FIG. 36 illustrates a perspective view of boom mount 34082 coupled to second member 24003, according to the embodiment of FIG. 24. Boom arm 34080 can be coupled to boom mount 34082 via boom mount receiver 36086 of boom mount 34082.

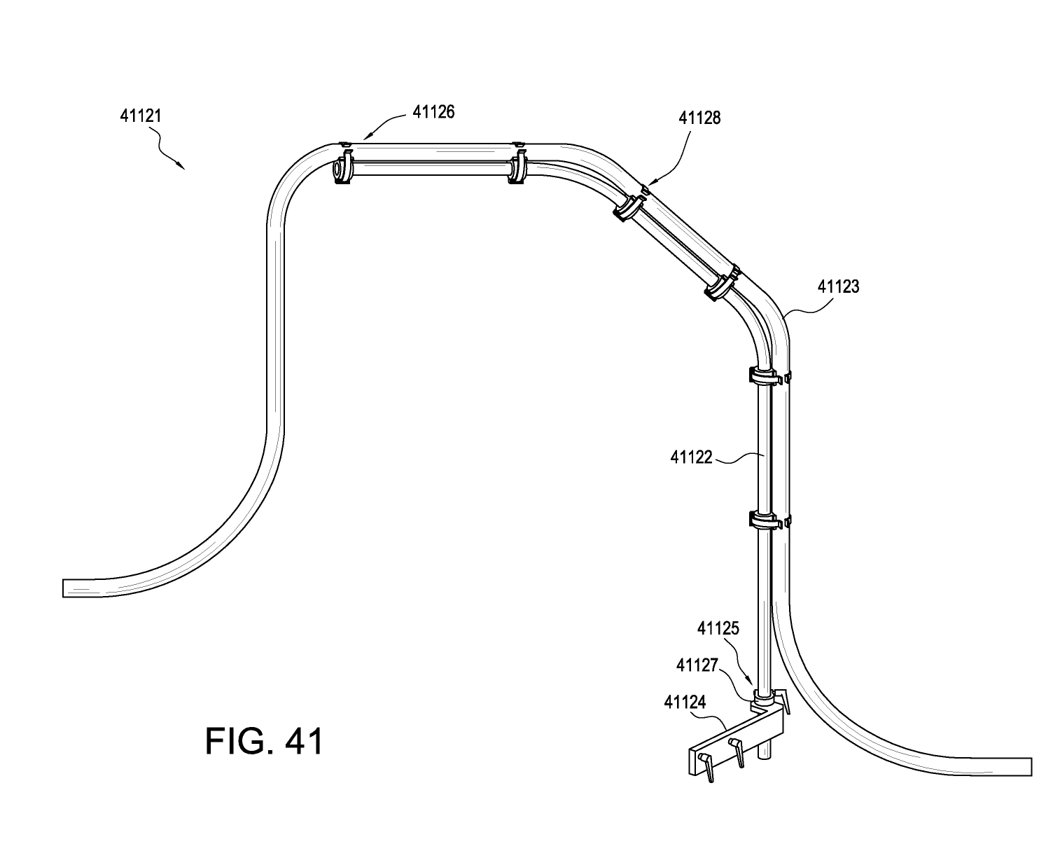

Skipping ahead in the drawings, FIG. 41 illustrates a perspective view of vacuum accessory element 41121, according to an embodiment. Vacuum accessory element 41121 can be similar or identical to vacuum accessory element 34079 (FIG. 34). In many examples, accessory element(s) 30045 can comprise vacuum accessory element 41121.

For example, vacuum accessory element 41121 can comprise boom arm 41122, vacuum hose 41123, and/or boom mount 41124. Boom arm 41122 can comprise boom arm mount end 41125 and boom arm vacuum end 41126. Further, boom mount 41124 can comprise boom mount receiver 41127 and boom arm 41122 can comprise one or more boom arm coupling mechanisms 41128.

Boom arm 41122 can be similar or identical to boom arm 34080 (FIG. 34); vacuum hose 41123 can be similar or identical to vacuum hose 34081 (FIG. 34); boom mount 41124 can be similar or identical to boom mount 34082 (FIG. 34); boom arm mount end 41125 can be similar or identical to boom arm mount end 34083 (FIG. 34); and/or boom arm vacuum end 41126 can be similar or identical to boom arm vacuum end 34084 (FIG. 34). Further, boom mount receiver 41127 can be similar or identical to boom mount receiver 36086 (FIG. 36), and/or each of boom arm coupling mechanism(s) 41128 can be similar or identical to boom arm coupling mechanism 35085 (FIG. 35).

Further vacuum hose 41123 can be coupled to one end to a vacuum (not shown) to provide suction through vacuum hose 41123. Accordingly, vacuum accessory element 41121 can be configured to function as a vacuum at the other end for use with a work table (e.g., work table 26048 (FIG. 26)), such as, for example, to vacuum saw dust and/or other debris.

Boom mount 41124 can be coupled to a base structure and/or a support structure of the work table, thereby mounting vacuum accessory element 41121 to the work table. Further, boom arm 41122 can be coupled to boom mount, such as, for example, at boom arm mount end 41125. In these embodiments, boom arm 41122 can be configured to rotate axially (e.g., 90 degrees, 180 degrees, 360 degrees, etc.) within boom mount receiver 41127 at boom mount 41124. Further, boom arm 41124 can be vertically adjustable at boom mount receiver 41127. In some embodiments, boom arm receiver 41127 can be configured to lock boom arm 41122 in a desired position.

Boom arm 41122 can comprise multiple boom arm components configured to be coupled together to provide boom arm 41122. The boom arm component(s) can be disassembled to store boom arm 41122.

Boom arm coupling mechanism(s) 41128 can be coupled to boom arm 41122 at one or more locations along a length of boom arm 41122. Boom arm coupling mechanism(s) 41128 can couple vacuum hose 41123 to boom arm 41122. In many embodiments, one or more of boom arm coupling mechanism(s) can comprise a cradle mechanism and a strap. The cradle mechanism can be coupled to boom arm 41128 and can provide a cradle which can receive vacuum hose 41123. Further, the strap can be coupled around the cradle mechanism body and the vacuum tube to hold vacuum hose 41123 at the cradle. The strap can comprise rubber or Velcro.

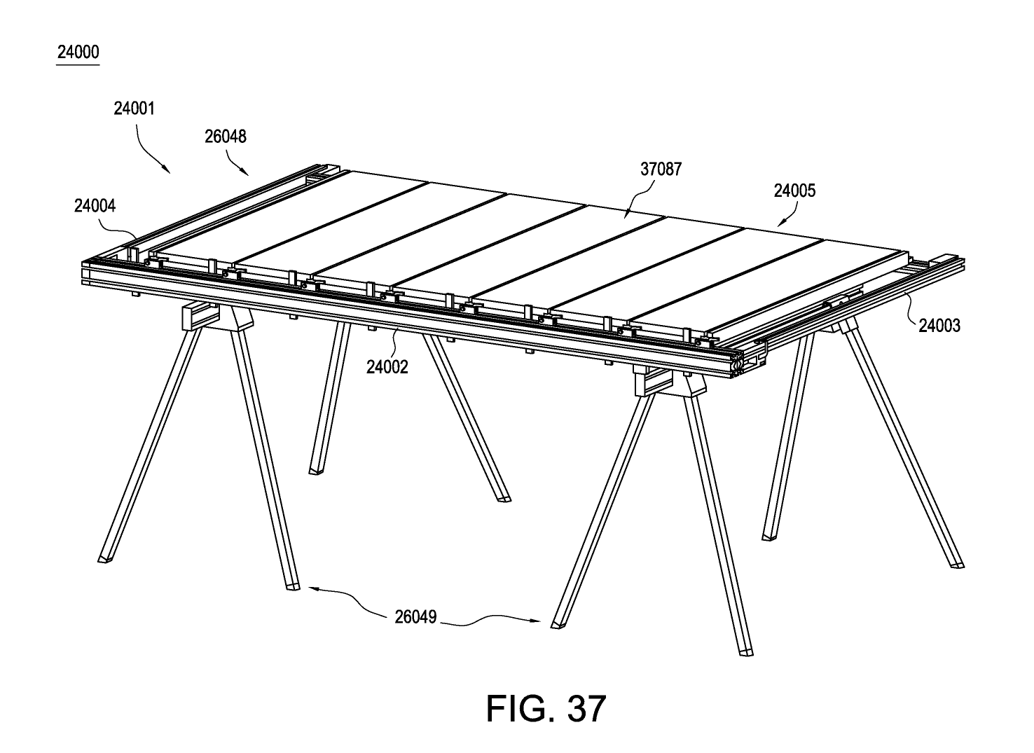

Turning back in the drawings, FIG. 37 illustrates a top, front, ride side view of work table 26048 of system 24000 implementing multiple surface inserts of surface insert(s) 37087, according to the embodiment of FIG. 24.

In many embodiments, system 24000 can comprise one or more surface inserts 37087. Each of surface insert(s) 37087 can span between and/or couple to each of two of cross member(s) 26044. Accordingly, cross member(s) 26044 can provide a working surface between one or more pairs of cross member(s) 26044. Each of surface insert(s) 37087 can be similar or identical to sheet material 1050 (FIG. 20). Further, each of surface insert(s) 37087 can be similar or identical to each other. However, in some embodiments, one or more of surface insert(s) 37087 can comprise differing spans, as desirable. Accordingly, for a larger span, the pair of cross member(s) 26044 can be spaced farther apart.

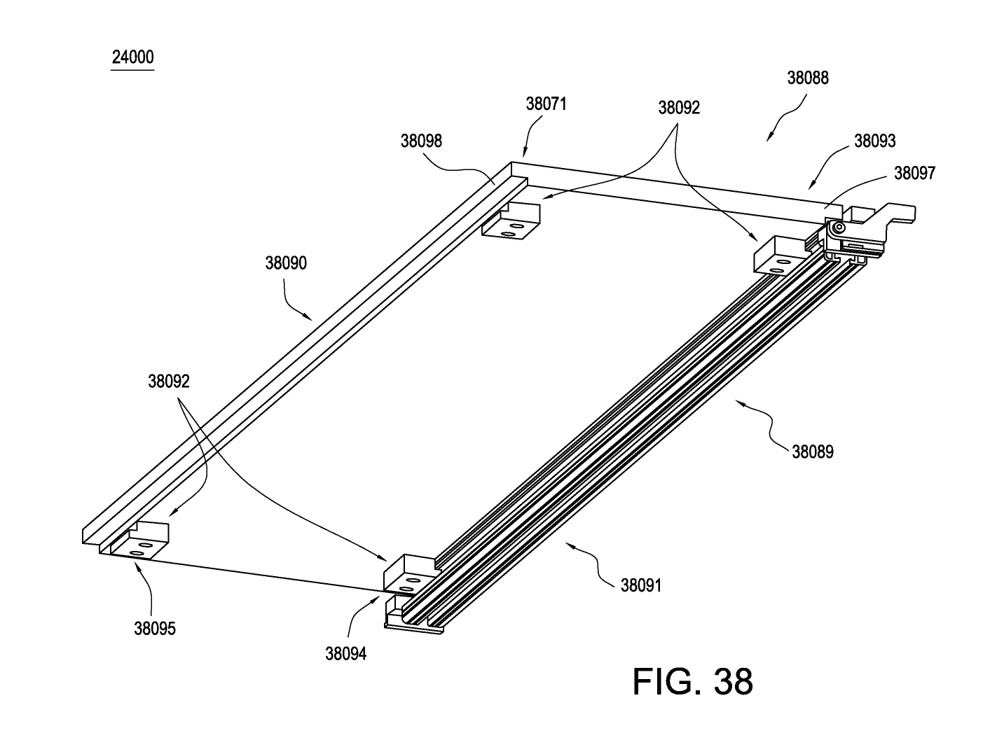

FIG. 38 illustrates sheet insert 38088 coupled to cross member 38089, according to the embodiment of FIG. 24. Accordingly, one or more of sheet insert(s) 37087 (FIG. 37) can be similar or identical to sheet insert 38088.

Sheet insert 38088 can comprise left sheet insert end 38090 and right sheet insert end 38091. In many embodiments, sheet insert 38088 can comprise one or more sheet insert tabs 38092. For example, sheet insert 38088 can comprise proximal right sheet insert tab 38093 and distal right sheet insert tab 38071 at right sheet insert end 38091, and/or sheet insert 38088 can comprise proximal left sheet insert tab 38071 and distal left sheet insert tab 38095 at left sheet insert end 38090. Likewise, sheet insert 38088 can comprise right wing 38097 and left wing 38098.

Sheet insert tab(s) 38092 can facilitate coupling sheet insert 38088 to cross member(s) 26044 (FIG. 26). For example, sheet insert tab(s) 38092 can be configured to be received at channel(s) 27062 (FIG. 27) of cross member(s) 26044 (FIG. 26). Accordingly, FIG. 38 shows proximal right sheet insert tab 38093 and distal right sheet insert tab 38071 received at a channel of cross member 38089.

Right wing 38097 and/or left wing 38098 can be configured to rest over cross member(s) 26044 (FIG. 26), such as, for example, when sheet insert tab(s) 38092 are received at channel(s) 27062 of cross member(s) 26044 (FIG. 26). In many embodiments, sheet insert 38088 can be used instead of one or more sacrificial members of cross member(s) 26044 (FIG. 26).

FIG. 39 illustrates a front, top, right side view of base structure 39099, according to an embodiment. In many embodiments, one or more of base structure(s) 26049 (FIG. 26) can be similar or identical to base structure 39099. Further, base structure 39099 can be similar or identical to one of the saw horses described above with respect to work table 100 (FIG. 1) and/or saw horses 764 (FIG. 6).

Base structure 39099 can comprise base structure proximal stand 39100, base structure distal stand 39101, and base structure cross member 39102. Base structure cross member 39102 can comprise base structure cross member proximal end 39103 and base structure cross member distal end 39104 opposite of base structure cross member proximal end 39103. Further, base structure proximal stand 39100 can comprise base structure proximal stand receiver 39096, base structure proximal stand right leg 39105, and base structure proximal stand left leg 39106. Further still, base structure distal stand 39101 can comprise base structure distal stand receiver 39107, base structure distal stand right leg 39108, and base structure distal stand left leg 39109. In some embodiments, base structure cross member 39102 can be similar to one or more of members 24002-24005 (FIG. 24), as described above.

In many embodiments, base structure cross member 39102 can be coupled to base structure proximal stand receiver 39096 (e.g., proximate to base structure cross member proximal end 39103) and base structure distal stand receiver 39107 (e.g., proximate to base structure cross member distal end 39104). In these embodiments, base structure cross member 39102 can be coupled to base structure proximal stand receiver 39096 and base structure distal stand receiver 39107 in such a manner that base structure cross member proximal end 39103 and/or base structure cross member distal end 39104 remain exposed. Accordingly, in some embodiments, base structure cross member 39102 can be coupled to a first member (e.g., first member 24002 (FIG. 24)) at base structure cross member proximal end 39103 and a fourth member (e.g., fourth member 24005 (FIG. 24)) at base structure cross member distal end 39104, and vice versa.

In many embodiments, base structure proximal stand right leg 39105 and base structure proximal stand left leg 39106 can be configured to moveably flare away from each other to operate as support legs for base structure proximal stand receiver 39096, such as, for example, when couple to a work table (e.g., work table 26048 (FIG. 26)). Further, in these or other embodiments, base structure distal stand right leg 39108 and base structure distal stand left leg 39109 can be configured to moveably flare away from each other to operate as support legs for base structure distal stand receiver 39107, such as, for example, when couple to a work table (e.g., work table 26048 (FIG. 26)). In further embodiments, base structure proximal stand right leg 39105 and base structure proximal stand left leg 39106 can be drawn together, base structure distal stand right leg 39108 and base structure distal stand left leg 39109 can be drawn together, and/or one or both of base structure proximal stand receiver 39096 and/or base structure distal stand receiver 39107 can be decoupled from base structure cross member 39102 for storage and/or transport of base structure 39099.

Although base structure cross member 39102 can comprise any suitable cross sectional shape (e.g., a circle, an oval, a triangle, a square, etc.), in many examples, base structure cross member 39102 can comprise a square cross section. Accordingly, base structure cross member 39102 can comprise one or more faces.

One or more of the face(s) of base structure cross member 39102 can comprise one or more channels 39110. Channel(s) 39110 can be similar or identical to channel(s) 24043 (FIG. 24). Accordingly, channel(s) 39110 can be configured to be coupled with one or more of accessory elements (e.g., accessory element(s) 30045 (FIG. 30)) and/or one or more cross members (e.g., cross member(s) 26044 (FIG. 26)). In some embodiments, channel(s) 39110 can comprise one or more keyhole slots configured to permit channel(s) 39110 to receive accessory element(s), etc. at one or more intermediate positions along channel(s) 39110. Keyhole slot(s) can be advantageous where base structure proximal stand receiver 39096 and base structure distal stand receiver 39107 could prevent translation of the accessory element(s), etc. along base structure cross member 39102.

Although base structure 39099 is contemplated for use with a work table (e.g., work table 26048), in other embodiments, base structure 39099 can be implemented for any other suitable use, such as, for example, as a saw horse generally. Further, in some embodiments, base structure 39099 can be coupled with one or more cross members (e.g., cross member(s) 26044 (FIG. 26)) to one or more other base structures. The other base structure(s) can be similar or identical to base structure 39099.

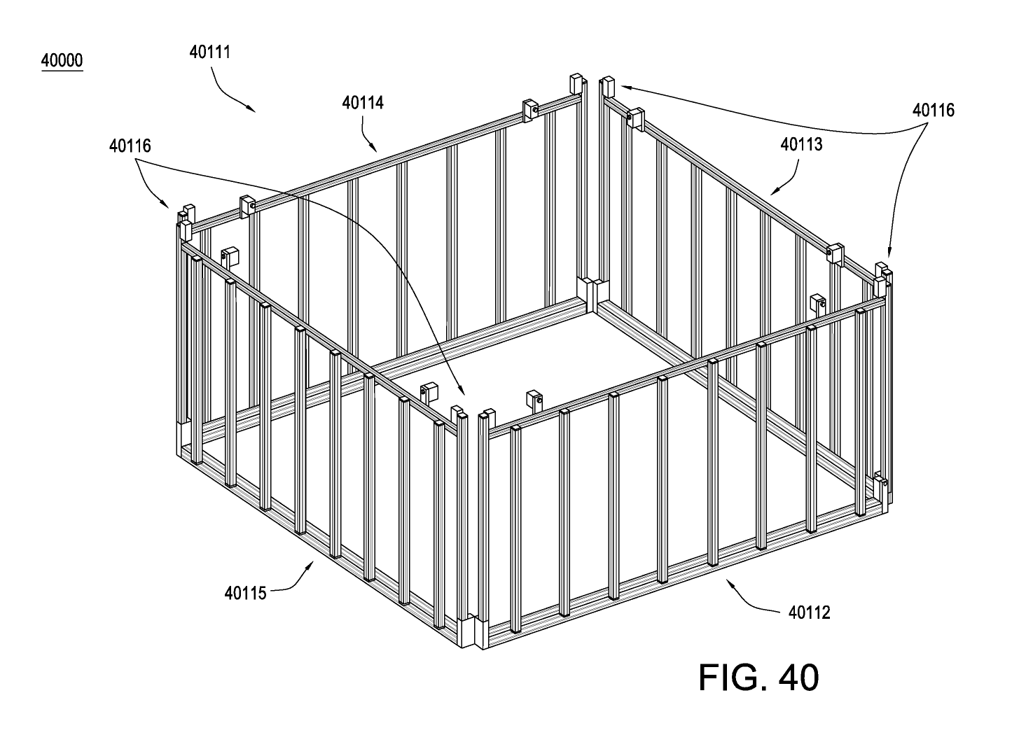

Turning to the next drawing, FIG. 40 illustrates a top, front, right side view of system 40000, according to an embodiment. System 40000 is merely exemplary and is not limited to the embodiments presented herein. System 40000 can be employed in many different embodiments or examples not specifically depicted or described herein.

System 40000 can comprise one or more support structures 40111. Each of support structure(s) 40111 can be similar or identical to support structure 24001 (FIG. 24). Support structure(s) 40111 can be implemented to provide one or more walls of a structure (e.g., side walls, floor, ceiling, etc.) and/or one or more walls of a container (e.g., sidewalls, top wall, bottom wall, etc.), such as, for example, for a domicile, for storage, etc. Depending on the application, support structure(s) 40111 can be sized appropriately. Further to this point, support structure(s) 40111 can comprise any suitable size. Because support structure 40111 can be collapsible, the structure and/or the container can be rapidly fabricated and easily transported. Further, support structure(s) 40111 can be easily stored when not in use.

In some embodiments, and as illustrated at FIG. 40, support structure(s) 40111 can comprise four support structures (e.g., first support structure 40112, second support structure 40113, third support structure 40114, and/or fourth support structure 40115). Although each of support structure(s) 40111 are shown implementing cross members, one or more of the cross member(s) can be omitted. In many embodiments, the cross member(s) can be similar or identical to cross member(s) 26044 (FIG. 26). The cross member(s) can be implemented to provide additional support to support structure(s) 40111. However, certain of the cross member(s) could be omitted to make room for point(s) of entry, window(s), etc., as applicable.

Further, although not shown at FIG. 40, as indicated previously, additional ones of support structure(s) 40111 could be implemented to provide a top wall/ceiling and/or a bottom wall/floor of system 40000. Further, one or more sheet insert(s) can be implemented to span between one or more pairs of cross member(s) implemented with support structure(s) 40111, such as, for example, to complete walls provided by support structure(s) 40111.

Further, door and/or window accessory element(s) could be implemented as doors and/or windows of system 40000, as desirable. Similar to accessory elements 30045 (FIG. 26) as described above, door and/or window accessory element(s) can be configured to couple to support structure(s) 40111. Further, one or more corner accessory element(s) could be implemented to couple together one or more of support structure(s) 40111 together at proximal interface(s) 40116 of system 40000. Proximal interface(s) 40112 can refer to proximal members of support structure(s) 40111.

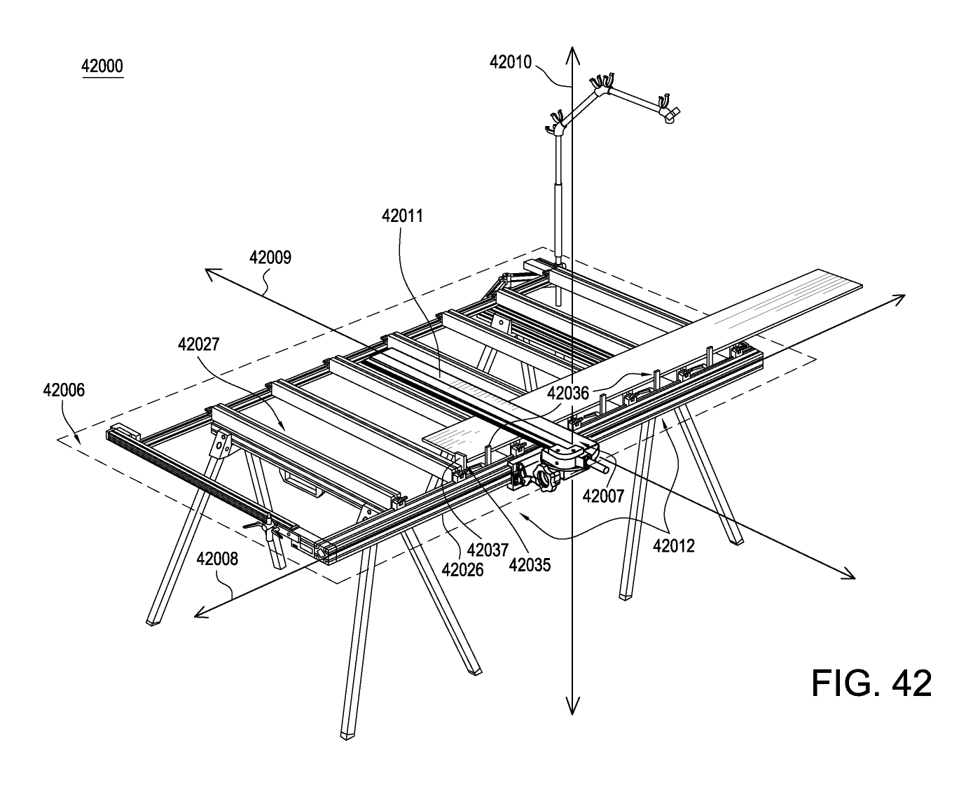

Turning ahead in the drawings, FIG. 42 illustrates a perspective view of system 42000, according to an embodiment. System 42000 is merely exemplary and is not limited to the embodiments presented herein. System 42000 can be employed in many different embodiments or examples not specifically depicted or described herein. In many examples, accessory element(s) 30045 can comprise system 42000, tool guide 42011, and/or index member(s) 42012.

System 42000 comprises tool guide 42011, working plane 42006, and reference frame 42007. Also, in many embodiments, system 42000 can comprise one or more index members 42012 (e.g., longitudinal index member 42037), though in other embodiments, index member(s) 42012 can be omitted.

As discussed in greater detail below, tool guide 42011 and/or index member(s) 42012 can be operatively coupled (e.g., selectively) to support structure 42026, such as, for example, to be used to shape a work piece. Although support structure 42026 can comprise any suitable structure to which tool guide 42011 and/or index member(s) 42012 can be coupled, in many embodiments, support structure 42026 can be similar or identical to part or all of frame 110 (FIG. 1) and/or support structure 24000 (FIG. 24). Accordingly, support structure 42026 can be part of work table 42027. Meanwhile, work table 42027 can be similar or identical to work table 100 (FIG. 1), work table 700 (FIG. 7), work table 2300 (FIG. 23) and/or work table 26048 (FIG. 26). In some embodiments, system 42000 can comprise support structure 42026 and/or work table 42027. In other embodiments, work table 42027 can be omitted.

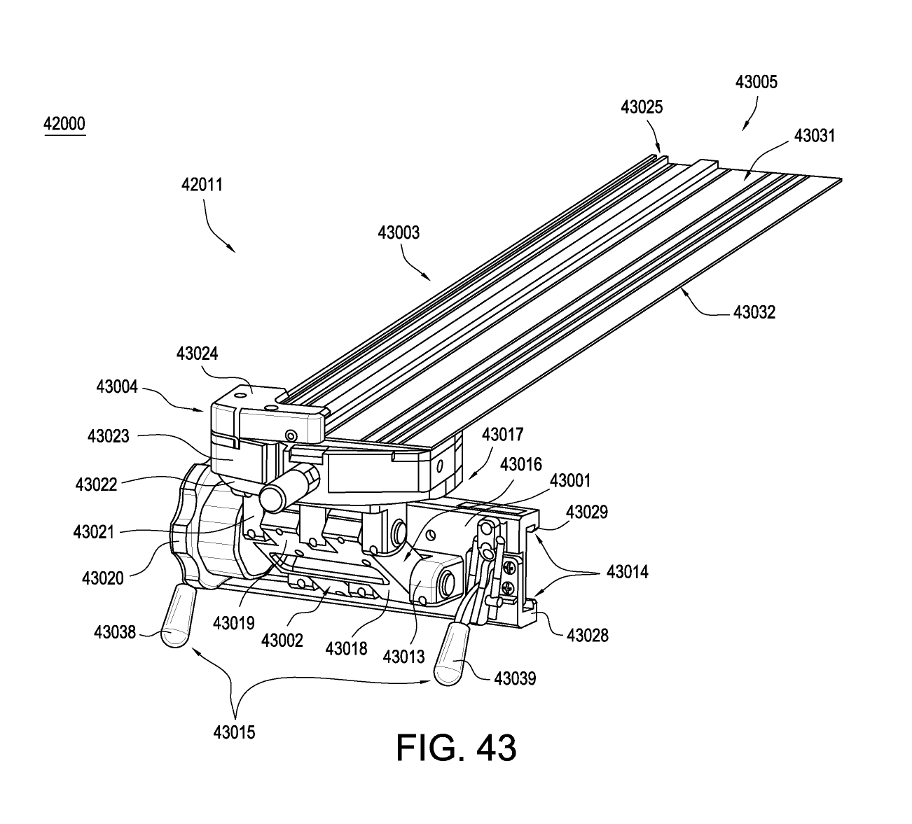

Moreover, in many examples, support structure 42026 can comprise one or more coupling receivers. The coupling receiver(s) can comprise one or more channels at support structure 42026. Further, each of the coupling receiver(s) can be similar or identical to channel 140 (FIG. 1), tool guide retention member 145 (FIG. 1), groove 160 (FIG. 1), one of channel(s) 24043, and/or one of channel(s) 27062 (FIG. 27). Accordingly, the coupling receiver(s) can be configured to receive coupling member(s) 43014 (FIG. 43), as described below.

Meanwhile, working plane 42006 and reference frame 42007 can provide reference geometry helping to illustrate the operability and/or relative motion of tool guide 42011 and/or index member(s) 42012 within system 42000, such as, for example, when tool guide 42011 and/or index members 42012 are coupled to support structure 42026. Working plane 42006 can be defined relative to one or more surfaces (e.g., one or more surfaces of work table 42027) configured to support a work piece to be shaped by tool guide 42011. Specifically, working plane 42006 can refer to a reference plane that is approximately coplanar with the surface(s). Accordingly, working plane 42006 can be similar or identical to the working plane discussed above with respect to work table 100 (FIG. 1), work table 700 (FIG. 7), work table 2300 (FIG. 23) and/or work table 26048 (FIG. 26).

Reference frame 42007 can comprise x-axis 42008, y-axis 42009, and z-axis 42010, which can be arranged as reference axes in a Cartesian coordinate system. Specifically, x-axis 42008, y-axis 42009, and z-axis 42010 can be approximately perpendicular to each other. Further, reference frame 42007 can be oriented relative to working plane 42006. Accordingly, x-axis 42008 and y-axis 42009 can be approximately parallel to working plane 42006, and the z-axis can be approximately perpendicular to working plane 42006.

In implementation, tool guide 42011 can be similar to tool guide 300 (FIGS. 16-17B) and/or similar or identical to tool guide 33075 (FIG. 33). FIG. 43 illustrates a front, top, right side view of tool guide 42011 when tool guide 42011 is decoupled from support structure 42026, according to the embodiment of FIG. 42.

Referring to FIG. 43, tool guide 42011, and more generally system 42000 (FIG. 42), can comprise base member 43001, multidirectional arm 43002, and track 43003. In many embodiments, base member 43001 can be similar to attachment member 310 (FIGS. 16-17B) and/or similar or identical to base member 33121 (FIG. 33); multidirectional arm 43002 can be similar to pivot arm 320 (FIGS. 16-17B) and/or similar or identical to multidirectional arm 33077 (FIG. 33); and/or track 43003 can be similar to cantilevered tool guide track 302 (FIGS. 16-17B) and/or similar or identical to cantilevered tool guide track 33076 (FIG. 33).

Specifically, base member 43001 can comprise hinge element 43013, one or more coupling members 43014 (e.g., coupling member 43028 and coupling member 43029), and one or more base member locking mechanisms 43015 (e.g., base member locking mechanism 43038 and base member locking mechanism 43039). However, in other embodiments, one or more of hinge element 43013, coupling member(s) 43014 (e.g., coupling member 43028 and/or coupling member 43029), and/or base member locking mechanism(s) 43015 (e.g., base member locking mechanism 43038 and/or base member locking mechanism 43039) can be omitted. In some embodiments, hinge element 43013 can be coupled to base member 43001 while in other embodiments, hinge element 43013 can be integral therewith.

Further, in these or other embodiments, multidirectional arm 43002 can comprise arm member 43016 and arm member 43017. Arm member 43016 can comprise hinge element 43018, hinge element 43019, and/or height adjustment mechanism 43020. Hinge 43018 can be located at a proximal end of arm member 43016 and hinge element 43019 can be located at a distal end of arm member 43016 opposite to the proximal end of arm member 43016.

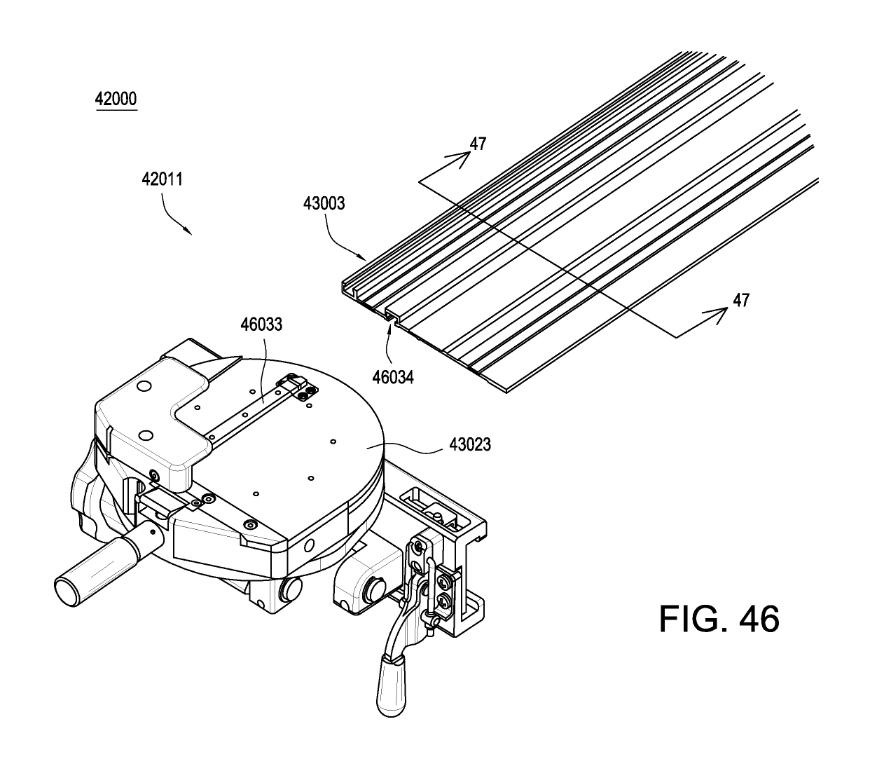

Meanwhile, arm member 43017 can comprise hinge element 43021, track stand interface 43022, and track stand 43023. Further, track stand 43023 can comprise track locking mechanism 46033 (FIG. 46) and/or retention mechanism 43024. However, in other embodiments, retention mechanism 43024 can be part of track 43003.

Hinge element 43021 can be located at a proximal end of arm member 43017 and track stand interface 43022 and track stand 43023 can be located at a distal end of arm member 43016 opposite to the proximal end of arm member 43017. Retention mechanism 43024 can be coupled to and/or integral with track stand 43023 and/or track 43003, as applicable.

Still, in other embodiments, arm member 43016 and/or arm member 43017 can be omitted. Accordingly, one or more of hinge element 43018, hinge element 43019, height mechanism 43020, hinge element 43021, track stand interface 43022, track stand 43023, track locking mechanism 46033 (FIG. 46), and/or retention mechanism 43024 can be omitted. For example, in some embodiments, part or all of multidirectional arm 43002 can be implemented as a gooseneck tube instead of being implemented with arm member 43016 and/or arm member 43017. The gooseneck tube can be semi-rigid (i.e., able to hold its shape in the absence of an externally applied force).

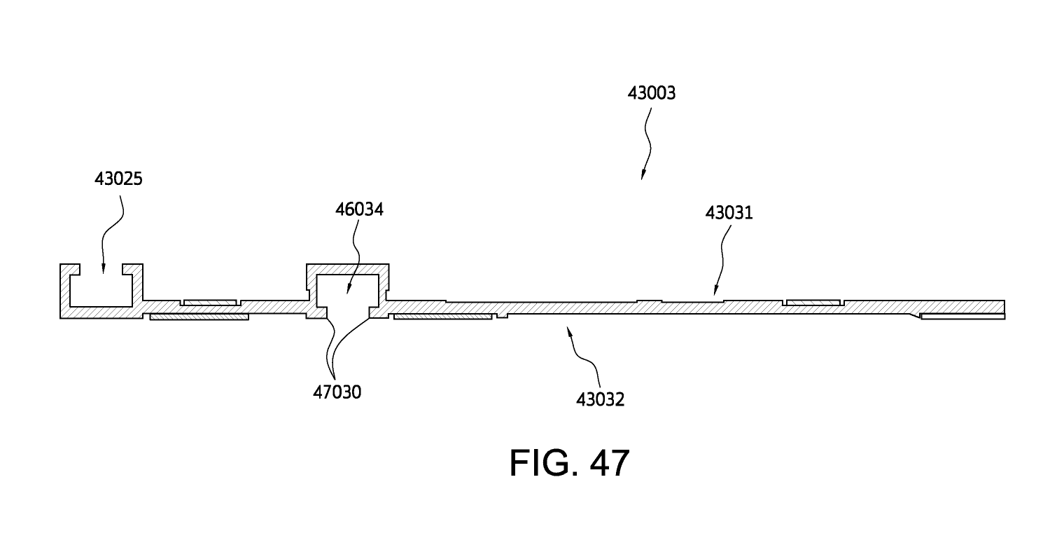

Further still, in these or other embodiments, track 43003 can comprise proximal end 43004, distal end 43005, track top face 43031, track bottom face 43032, and tool channel 43025. Also, track 43003 can comprise coupling channel 46034 (FIG. 46), and coupling channel 46034 can comprise one or more extensions 47030 (FIG. 47).

Proximal end 43004 can be opposite distal end 43005 relative to a length of track 43003. The length of track 43003 can refer to a longest dimension of track 43003. Meanwhile, tool channel 43025 can extend between distal end 43005 and proximal end 43004. In these embodiments, tool channel 43025 can extend partially or entirely between distal end 43005 and proximal end 43004. In many embodiments, tool channel 43025 extends substantially from distal end 43005 to proximal end 43004 (e.g., extending for at least 50 percent, 70 percent, or 80 percent of the length of track 43003). Further, tool channel 43025 can be approximately parallel with the length of track 43003. Nonetheless, in other embodiments, tool channel 43025 can be implemented according to any suitable length, shape (e.g., linear, curved, etc.), and/or orientation.

Further, track top face 43031 can be opposite track bottom face 43032. Track top face 43031 and track bottom face 43032 can be separated by a thickness of track 43003. The thickness of track 43003 can refer to a shortest dimension of track 43003. In many embodiments, the thickness of track 43003 can be substantially smaller than the length and/or a width of track 43003. As a result, track 43003 can be approximately laminar. In many embodiments, tool channel 43025 can be located at track top face 43031 and coupling channel 46034 (FIG. 46) can be located at track bottom face 43032.

Coupling channel 46034 (FIG. 46) can comprise opposing sidewalls defining coupling channel 46034. Meanwhile, extension(s) 47030 (FIG. 47) can protrude (e.g., as cantilever(s)) from the sidewalls of coupling channel 46034 (FIG. 46) at or near track bottom face 43032.

As discussed in greater detail below, base member 43001, multidirectional arm 43002, and track 43003 can be coupled together. Further, as discussed briefly above, tool guide 42011 can be operatively coupled (e.g., selectively) to support structure 42026 (FIG. 42).

More specifically, base member 43001 can be operatively coupled (e.g., selectively) to support structure 42026 (FIG. 42). Tool guide 42011 and/or base member 43001 can be coupled to support structure 42026 (FIG. 42) in any suitable manner, provided the manner of coupling does not prevent tool guide 42011 from functioning in the manner described herein. In specific embodiments, coupling member(s) 43014 (e.g., coupling member 43028 and coupling member 43029) can be receivable at the coupling receiver(s) of support structure 42026 (FIG. 42) in order to couple tool guide 42011 and/or base member 43001 to support structure 42026 (FIG. 42).

For example, coupling member 43028 and coupling member 43029 can be positioned opposite of each other at base member 43001 to permit coupling member 43028 and coupling member 43029 to be received at opposing coupling receivers of support structure 42026 (FIG. 42). Further, coupling member 43028 and coupling member 43029 can be engaged (e.g., moved closer together relative to each other in a direction parallel to z-axis 42010 (FIG. 42)) and disengaged (e.g., moved farther apart relative to each other in a direction parallel to z-axis 42010 (FIG. 42)). In this manner, coupling member 43028 and coupling member 43029 can operate similarly to a conventional c-clamp, coupling (e.g., clamping) tool guide 42011 and/or base member 43001 to support structure 42026 (FIG. 42) when coupling member 43028 and coupling member 43029 are engaged at support structure 42026 (FIG. 42) (e.g., at the coupling receivers of support structure 42026 (FIG. 26)).

To the extent support structure 42026 (FIG. 42) comprises the coupling receiver(s), engaging coupling member 43028 and/or coupling member 43029 at the coupling receiver(s) of support structure 42026 (FIG. 42) can provide mechanical resistance (in addition to or alternatively to frictional resistance) preventing tool guide 42011 and/or base member 43001 from being decoupled (e.g., undesirably) from support structure 42026 (FIG. 42) in a direction parallel to y-axis 42009 (FIG. 42). Meanwhile, although it is also possible to couple tool guide 42011 and/or base member 43001 at support structure 42026 (FIG. 42) when the coupling receiver(s) are absent or unused, this manner of implementation may be less secure, requiring less force (e.g., force sufficient to overcome only friction) to decouple (e.g., undesirably) tool guide 42011 and/or base member 43001 from support structure 42026 (FIG. 42) in a direction parallel to y-axis 42009 (FIG. 42).

In these or other embodiments, base member locking mechanism(s) 43015 (e.g., base member locking mechanism 43030 and/or base member locking mechanism 43031) can be operable to secure tool guide 42011 and/or base member 43001 to support structure 42026 (FIG. 42) when tool guide 42011 and/or base member 43001 are coupled to support structure 42026 (FIG. 42). Tool guide 42011 and/or base member 43001 can be secured to support structure 42026 (FIG. 26) in any suitable manner, provided the manner of securing does not prevent tool guide 42011 from functioning in the manner described herein. Moreover, base member locking mechanism(s) 43015 (e.g., base member locking mechanism 43030 and/or base member locking mechanism 43031) can permit coupling member 43028 and coupling member 43029 to be selectively engaged and disengaged.

For example, base member locking mechanism(s) 43015 (e.g., base member locking mechanism 43030 and/or base member locking mechanism 43031) can comprise one or more toggle clamp(s) configured to selectively engage and disengage coupling member 43028 and coupling member 43029. Further, operating toggle clamp(s) to engage coupling member 43028 and coupling member 43029 at support structure 42026 (FIG. 42) can secure tool guide 42011 and/or base member 43001 to support structure 42026 (FIG. 42), such as, for example, by friction and/or mechanically (e.g., by retention of coupling member 43028 and/or coupling member 43029 at the coupling receiver(s) of support structure 42026 (FIG. 42)). Although FIG. 43 illustrates base member 43001 as comprising two base member locking mechanisms of base member locking mechanism(s) 43015, more or less base member locking mechanisms can be implemented.

Tool guide 42011 can be portable as a result of tool guide 42011 and/or base member 43001 being able to be selectively coupled and decoupled from support structure 42026 (FIG. 42). In this manner, tool guide 42011 and/or base member 43001 can be coupled to any suitable support structure, as desirable.

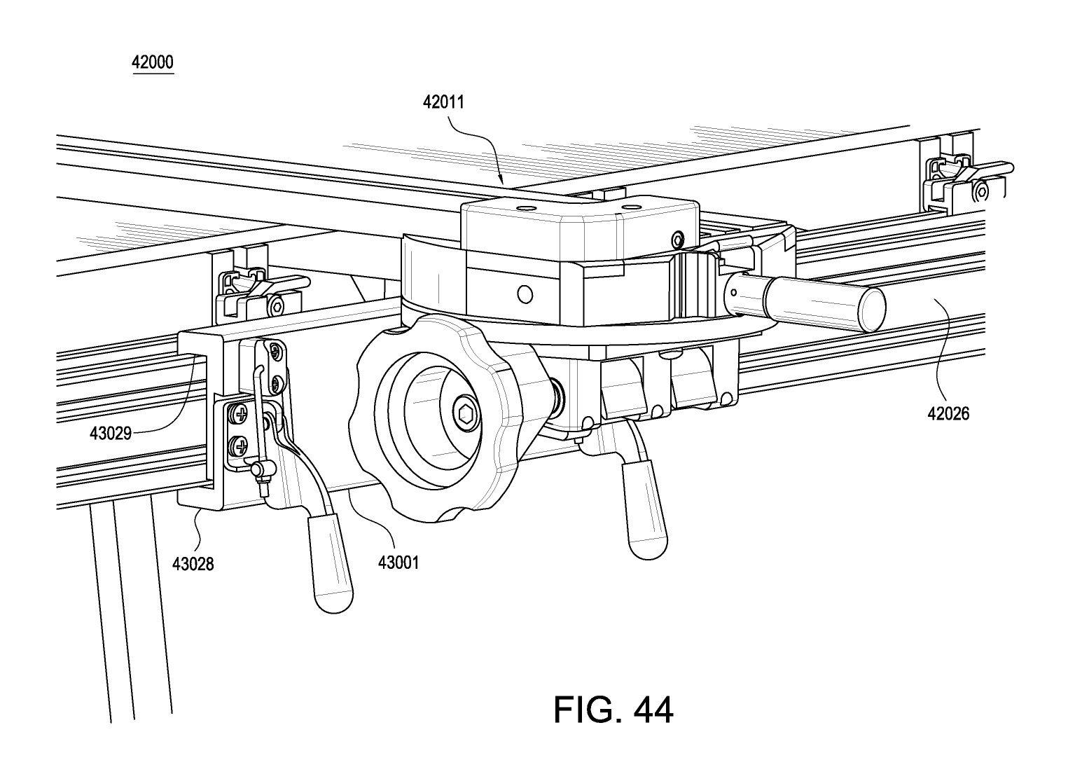

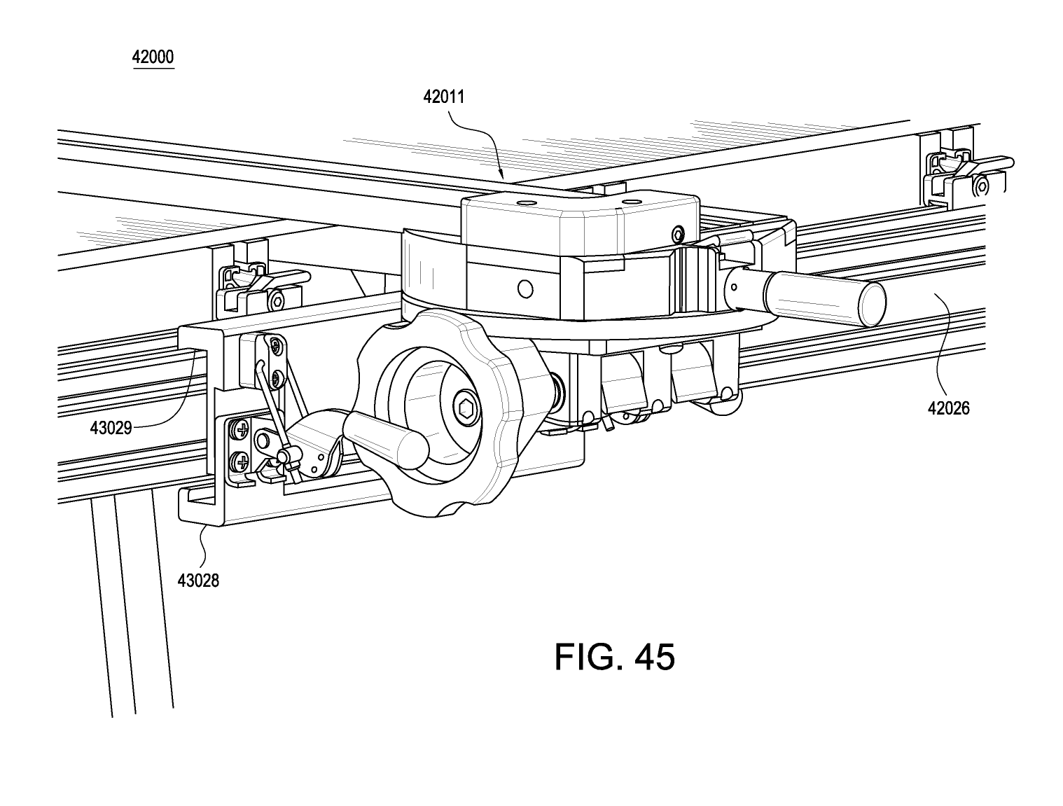

Turning ahead briefly in the drawings, FIG. 44 illustrates base member 43001 of tool guide 42011 of system 42000 securely coupled to support structure 42026 when coupling member 43028 and coupling member 43029 of coupling member(s) 43014 (FIG. 43) are engaged, according to the embodiment of FIG. 42. Meanwhile, FIG. 45 illustrates base member 43001 of tool guide 42011 of system 42000 coupled to support structure 42026 in an unsecured manner when coupling member 43028 and coupling member 43029 of coupling member(s) 43014 are disengaged, according to the embodiment of FIG. 42.

Returning now to FIG. 43, track 43003 can be coupled (e.g., selectively) to multidirectional arm 43002. In specific embodiments, track 43003 can be coupled (e.g., selectively) to track stand 43023. However, in some embodiments, track stand 43023 can be omitted. In these embodiments, track 43003 can be coupled directly to track stand interface 43022. Track 43003 can be coupled to track stand 43023 at or near proximal end 43004. As a result, track 43003 can project outwardly from multidirectional arm 43002 and/or track stand 43023 as a cantilever.

Track 43003 can be coupled to multidirectional arm 43002 and/or track stand 43023 in any suitable manner. However, in many embodiments, track locking mechanism 46033 (FIG. 46) can receive coupling channel 46034 (FIG. 46) so that track 43003 can be securely and/or selectively coupled to multidirectional arm 43002 and/or track stand 43023. FIG. 46 illustrates coupling channel 46034 of track 43003 decoupled from track locking mechanism 46033 of track stand 43023, according to the embodiment of FIG. 42.

Track locking mechanism 46033 can comprise a wedge configured to apply downward force (e.g., selectively) on extension(s) 47030 (FIG. 47) of coupling channel 46034 when coupling channel 46034 is received at track locking mechanism 46028. Application of this downward force on extension(s) 47030 (FIG. 47) can securely couple track 43003 to track stand 43023. The downward force can be effected, for example, by spring loading track locking mechanism 46033. As a result, track locking mechanism 46033 can securely and/or selectively couple track 43003 to multidirectional arm 43002 (FIG. 43) and/or track stand 43023. FIG. 47 illustrates a cross sectional view of track 43003 taken along line 47-47 of FIG. 46 and showing extension(s) 47030 of coupling channel 46034 and tool channel 43025 (FIG. 43), according to the embodiment of FIG. 42.

Track 43003 can receive a tool. The tool can be any suitable tool, such as, for example, an electrical saw, an electrical drill, an electrical sander, an electrical router, etc. The tool can be received at tool channel 43025 and moved (e.g., translated) along tool channel 43025. As discussed in greater detail below, track 43003 (e.g., track bottom face 43032) and the tool can be brought in contact with a work piece in order to permit the work piece to be shaped by the tool. When track 43003 is coupled to multidirectional arm 43002, multidirectional arm 43002 permits track 43003 and the tool to be adjusted (e.g., selectively) with respect to the work piece, as is discussed in greater detail below.

In implementation, multidirectional arm 43002 can be coupled to base member 43001 in any suitable manner, and arm member 43016 can be coupled to arm member 43017 in any suitable manner. For example, in many embodiments, hinge element 43013 can be coupled to hinge element 43018 in order to couple base member 43001 to multidirectional arm 43002. Further, in many embodiments, hinge element 43019 can be coupled to hinge element 43021 in order to couple arm member 43016 to arm member 43017.

Further still, track stand interface 43022 can be coupled to track stand 43023 in any suitable manner. For example, in many embodiments, track stand 43023 can be coupled to track stand interface 43022 such that track stand 43023 can rotate axially with respect to track stand interface 43022. In these embodiments, track stand 43023 can rotate about an axis of rotation of track stand interface 43022. In some embodiments, for simplicity, the axis of rotation can intersect a center of track stand interface 43022 and/or a center of track stand 43023. However, in other embodiments, the axis of rotation can be offset from the center of track stand interface 43022 and/or the center of track stand 43023. Accordingly, when applicable, track stand 43023 can function as a carousel with respect to track stand interface 43022 and/or as a hub with respect to track 43023. However, in other embodiments, track stand 43023 can be omitted, and track 43003 can be directly axially coupled to track stand interface 43022. Regardless of the particular manner of implementation, track 43003 can rotate about the axis of rotation of track stand interface 43022 in a manner similar to the rotation of a single-bladed propeller.

Regardless of the manner of coupling, multidirectional arm 43002 can be coupled to base member 43001 such that multidirectional arm 43002 can be selectively moved with respect to base member 43001. Further, when applicable, arm member 43016 and arm member 43017 can be coupled to each other such that arm member 43016 and arm member 43017 can be selectively moved with respect to each other. Further still, in many embodiments, track stand 43023 and/or track 43003 can be configured to selectively axially rotate with respect to track stand interface 43022. In particular, an operator of system 42000 and/or tool guide 42011 can selectively immobilize in any suitable manner (i) multidirectional arm 43002 with respect to base member 43001, (ii) arm member 43016 with respect to arm member 43017, and/or (iii) track stand 43023 and/or track 43003 with respect to track stand interface 43022 so that a particular orientation of track 43003 can be selectively maintained.

Referring now back to FIG. 42, in many embodiments, tool guide 42011 can be configured such that when base member 43001 (FIG. 43) is coupled to support structure 42026, track 43003 (FIG. 43) (e.g., track top face 43031 (FIG. 43)) can be extended over and/or approximately parallel to working plane 42006. When base member 43001 (FIG. 43) is coupled to support structure 42026 and track 43003 (FIG. 43) (e.g., track top face 43031 (FIG. 43)) is extended over and/or approximately parallel to working plane 42006, z-axis 42010 can be approximately collinear with the axis of rotation of track stand interface 43022 (FIG. 43). Further, when base member 43001 (FIG. 43) is coupled to support structure 42026 and track 43003 (FIG. 43) (e.g., track top face 43031 (FIG. 43)) is extended over and/or approximately parallel to working plane 42006, x-axis 42008 and y-axis 42009 can be approximately coplanar with track 43003 (FIG. 43) (e.g., track top face 43031 (FIG. 43)). Meanwhile, as discussed below, base member 43001 (FIG. 43) and multidirectional arm 43002 (FIG. 43) can permit track 43003 (FIG. 43) to be selectively adjusted in multiple degrees of freedom when base member 43001 (FIG. 43) is coupled to support structure 42026.

Specifically, when base member 43001 (FIG. 43) is coupled to support structure 42026, track 43003 (FIG. 43) can be selectively rotated about the axis of rotation of track stand interface 43022 (FIG. 43). This rotation of track 43003 (FIG. 43) can be effected by the axial coupling of track stand interface 43022 (FIG. 43) with track stand 43023 (FIG. 43) and/or track 43003 (FIG. 43). As a non-limiting but illustrative example, when base member 43001 (FIG. 43) is coupled to support structure 42026 and track 43003 (FIG. 43) (e.g., track top face 43031 (FIG. 43)) is approximately parallel to working plane 42006, track 43003 (FIG. 43) can be selectively rotated about z-axis 42010. Further, in many embodiments, track 43003 (FIG. 43) also can be selectively rotated about the axis of rotation of track stand interface 43022 (FIG. 43) when track 43003 (FIG. 43) (e.g., track top face 43031 (FIG. 43)) is non-parallel to working plane 42006.

Further, when base member 43001 (FIG. 43) is coupled to support structure 42026, track 43003 (FIG. 43) can be selectively rotated such that distal end 43005 (FIG. 43) of track 43003 (FIG. 43) moves toward z-axis 42010 (e.g., such that track 43003 moves between being approximately parallel with working plane 42006 to non-parallel with working plane 42006). Accordingly, track 43003 (FIG. 43) can be inclined with respect to working plane 42006. This rotation of track 43003 (FIG. 43) can be effected by the hinged coupling of hinge element 43019 (FIG. 43) of arm member 43016 (FIG. 43) with hinge element 43021 (FIG. 43) of arm member 43017 (FIG. 43).

Further still, multidirectional arm 43002 (FIG. 43) can permit a track height of track 43003 (FIG. 43) to be selectively adjusted. The track height can refer to an approximate distance of track 43003 (FIG. 43) over working plane 42006 when track 43003 (FIG. 43) is approximately parallel to working plane 42006. For example, when base member 43001 (FIG. 43) is coupled to support structure 42026 and track 43003 (FIG. 43) (e.g., track top face 43031 (FIG. 43)) is over and approximately parallel to working plane 42006, track 43003 (FIG. 43) can be raised away from working plane 42006 and lowered toward working plane 42006 to selectively adjust the track height of track 43003 (FIG. 43). Notably however, at least in some embodiments, track 43003 (FIG. 43) does not necessarily need to be in an approximately parallel orientation for the track height to be adjusted. Rather, this description is merely intended to be illustrative of the change in the track height, which is defined relative to working plane 42006 above.

The selective adjustment of the track height can be effected through the combination of the hinged coupling of hinge element 43019 (FIG. 43) of arm member 43016 (FIG. 43) and hinge element 43021 (FIG. 43) of arm member 43017 (FIG. 43) with the hinged coupling of hinge element 43018 (FIG. 43) of arm member 43016 (FIG. 43) and hinge element 43013 (FIG. 43) of base member 43001 (FIG. 43). Specifically, moving the distal end of arm member 43017 (FIG. 43) away from support structure 42026 can decrease the track height and moving the distal end of arm member 43017 (FIG. 43) closer to support structure 42026 can increase the track height.

Even further still, in many embodiments, when base member 43001 (FIG. 43) is coupled to support structure 42026, base member 43001 (FIG. 43) can be selectively moved (e.g., translated) along support structure 42026 (e.g., parallel to x-axis 42008). For example, coupling member(s) 43014 (FIG. 43) (e.g., coupling member 43028 (FIG. 43) and/or coupling member 43029 (FIG. 43)) can slide within the coupling receiver(s) of support structure 42026 in order to permit base member 43001 (FIG. 43) to move along support structure 42026. In some embodiments, when base member locking mechanism(s) 43015 (FIG. 43) are securing base member 43001 (FIG. 43) to support structure 42026, it may not be possible to move base member 43001 (FIG. 43) along support structure 42026. In these embodiments, base member locking mechanism(s) 43015 (FIG. 43) may need to be disengaged to permit base member 43001 (FIG. 43) to be moved along support structure 42026. Nonetheless, in other embodiments, it may be possible to move base member 43001 (FIG. 43) along support structure 42026 even when base member locking mechanism(s) 43015 (FIG. 43) are securing base member 43001 (FIG. 43) to support structure 42026, such as, for example, when base member 43001 (FIG. 43) is secured mechanically but not by friction.

Advantageously, when track 43003 (FIG. 43) receives an electrical saw, the ability to selectively rotate track 43003 (FIG. 43) about the axis of rotation of track stand interface 43022 (FIG. 43) permits tool guide 42011 to operate similarly to a miter saw or chop saw with respect to a work piece. As a result, angular cuts can be performed on the work piece. Meanwhile, the ability to selectively rotate track 43003 (FIG. 43) such that distal end 43005 (FIG. 43) of track 43003 (FIG. 43) moves toward z-axis 42010 permits track 43003 (FIG. 43) to be tilted away from working plane 42006, facilitating placement of a work piece at working plane 42006 as well as removal of the work piece from work plane 42006. This functionality can be particularly useful for chop saw applications. Likewise, the ability to adjust the track height of track 43003 (FIG. 43) permits tool guide 42011 to be used with work pieces of varying thicknesses, and the ability to move base member 43001 (FIG. 43) along support structure 42026 permits tool guide 42011 to be selectively oriented at different locations with respect to a work piece at working plane 42006.

In many embodiments, system 42000 and/or tool guide 42011 can comprise one or more position indicators. The position indicators can be configured to indicate one or more positions and/or orientations of tool guide 42011.

For example, the position indicator(s) can comprise a first position indicator configured to indicate an angular orientation of track 43003 (FIG. 43) about z-axis 42010 and/or the axis of rotation of track stand interface 43022 (FIG. 43). Further, in many embodiments, the first position indicator can indicate the angular orientation of track 43003 (FIG. 43) about z-axis 42010 and/or the axis of rotation of track stand interface 43022 (FIG. 43) relative to a neutral position of track 43003 (FIG. 43) in which track 43003 (e.g., track top face 43031 (FIG. 43)) is approximately parallel to working plane 42006, and the length of track 43003 (FIG. 43) is approximately parallel with y-axis 42009, approximately perpendicular with x-axis 42008, and/or approximately perpendicular with z-axis 42010.

Meanwhile, the position indicator(s) can comprise a second position indicator configured to indicate an angular orientation of track 43003 (FIG. 43) about x-axis 42008 and/or with respect to working plane 42006. Like the first position indicator, in many embodiments, the second position indicator can indicate the angular orientation of track 43003 (FIG. 43) about x-axis 42008 and/or with respect to working plane 42006 relative to the neutral position of track 43003 (FIG. 43).

Further, the position indicator(s) can comprise a third position indicator configured to indicate the track height, and/or a fourth position indicator configured to indicate a translational position of base member 43001 (FIG. 43) with respect to support structure 42026 and/or longitudinal index member(s) 42035 (e.g., longitudinal index member 42037).

Referring again to FIG. 43, in many embodiments, retention mechanism 43024 can be operable to maintain (e.g., substantially) a tool at track 43003, such as, for example, when track 43003 is tilted with respect to working plane 42006 (FIG. 42) (e.g., distal end 43005 of track 43003 is moved toward z-axis 42010 (FIG. 42)). That is, when track 43003 is tilted with respect to working plane 42006 (FIG. 42), track top face 43031 and/or tool channel 43025 may insufficiently support the tool received at track 43003 such that the tool may fall from track 43003. Accordingly, retention mechanism 43024 can be configured to impede or prevent the tool from falling from track 43003.

For example, in many embodiments, retention mechanism 43024 can comprise a ledge extending over part or all of track 43003, track top face 43031 and/or tool channel 43025. The ledge can be configured to extend over part or all of the tool received at track 43003, track top face 43031 and/or tool channel 43025 so that the ledge is able to catch the tool to impede or prevent the tool from falling from track 43003. In many embodiments, retention mechanism 43024 can be located (e.g., coupled to and/or integral with track 43003 and/or track stand interface 43022) at or near at least proximal end 43004 of track 43003.

Notably, retention mechanism 43024 can be configured so that the tool remains in constant contact with track 43003, track top face 43031 and/or tool channel 43025 when the tool is received at track 43003. However, in other embodiments, retention mechanism 43024 can be configured so that the tool may at least partially break contact with track 43003, track top face 43031 and/or tool channel 43025 but nevertheless impede or prevent the tool from falling from track 43003 (i.e., substantially maintaining the tool at track 43003).

Meanwhile, height adjustment mechanism 43020 can comprise any suitable device configured to selectively adjust multidirectional arm 43002 in order to adjust the track height of track 43003. In some embodiments, height adjustment mechanism 43020 can be configured to adjust the track height (e.g., rapidly) approximately to two or more predetermined track heights (e.g., 0.098 centimeters, 0.197 centimeters, 0.295 centimeters, etc.), such as, for example, based on a thickness of a work piece. In implementation, height adjustment mechanism 43020 can comprise a dial with a polygonal hub having face surfaces of varying distances from a center of the hub. These face surfaces can correspond to the predetermined track heights. Meanwhile, track stand interface 43022 can be configured to contact the hub of the dial such that turning the dial so that track stand interface 43022 contacts the hub at the face surface corresponding to the desired track height adjusts the track height to that predetermined track height.

Turning once again back to FIG. 42, as indicated previously, in some embodiments, system 42000 can comprise index member(s) 42012. Index member(s) 42012 can comprise one or more longitudinal index members 42035 (e.g., longitudinal index member 42037) and/or one or more lateral index members 42036. Index member(s) 42012 can be coupled (e.g., selectively) to support structure 42026 and/or work table 42027. Meanwhile, when index member(s) 42012 are coupled to support structure 42026 and/or work table 42027, index member(s) 42012 can be used to index (e.g., orient) a work piece at working plane 42006.

Specifically, longitudinal index member(s) 42035 (e.g., longitudinal index member 42037) can be similar or identical to longitudinal index member(s) 714 (FIGS. 12, 14, 15, 16, 17A, 17B, 22A, & 22B) and/or the longitudinal index member(s) described above with respect to work table 26048 (FIG. 26); and lateral index member(s) 42036 can be similar or identical to lateral index member(s) 712 (FIGS. 12, 14, 15, 17A, & 17B) and/or the lateral index member(s) described above with respect to work table 26048 (FIG. 26). Accordingly, index member(s) 42012 (e.g., longitudinal index member(s) 42035 and/or lateral index member(s) 42036) can be adjusted (e.g., selectively) so that index member(s) 42012 extend through working plane 42006 in an operational configuration and so that index member(s) 42012 do not extend through working plane 42006 in a non-operational configuration. Index member(s) 42012 (e.g., longitudinal index member(s) 42035 and/or lateral index member(s) 42036) can be operable to index (e.g., orient) a work piece when configured in the operational configuration. In particular, longitudinal index member(s) 42035 can be configured to index (e.g., orient) the work piece relative to (e.g., parallel to) y-axis 42009, and lateral index member(s) 42036 can be configured to index (e.g., orient) the work piece relative to (e.g., parallel to) x-axis 42008.

By using index member(s) 42012 to index the work piece, an operator of system 42000 and/or tool guide 42011 can be confident that the work piece is oriented in a predetermined manner. The ability to index the work piece can be particularly advantageous when the operator is operating tool guide 42011 as a chop saw to quickly form multiple 90 degree cuts in the work piece.

Meanwhile, index member(s) 42012 can be coupled to support structure 42026 and/or work table 42027 in any suitable manner. For example, in many embodiments, index member(s) 42012 can be coupled to support structure 42026 and/or work table 42027 in a manner similar or identical to the manner in which tool guide 42011 is coupled to support structure 42026 and/or work table 42027. Likewise, index member(s) 42012 can be configured to move (e.g., translate) along support structure 42026 and/or work table 42027 in a manner similar or identical to the manner in which base member 43001 (FIG. 43) moves along support structure 42026, such as, for example, via the coupling receiver(s) of support structure 42026.

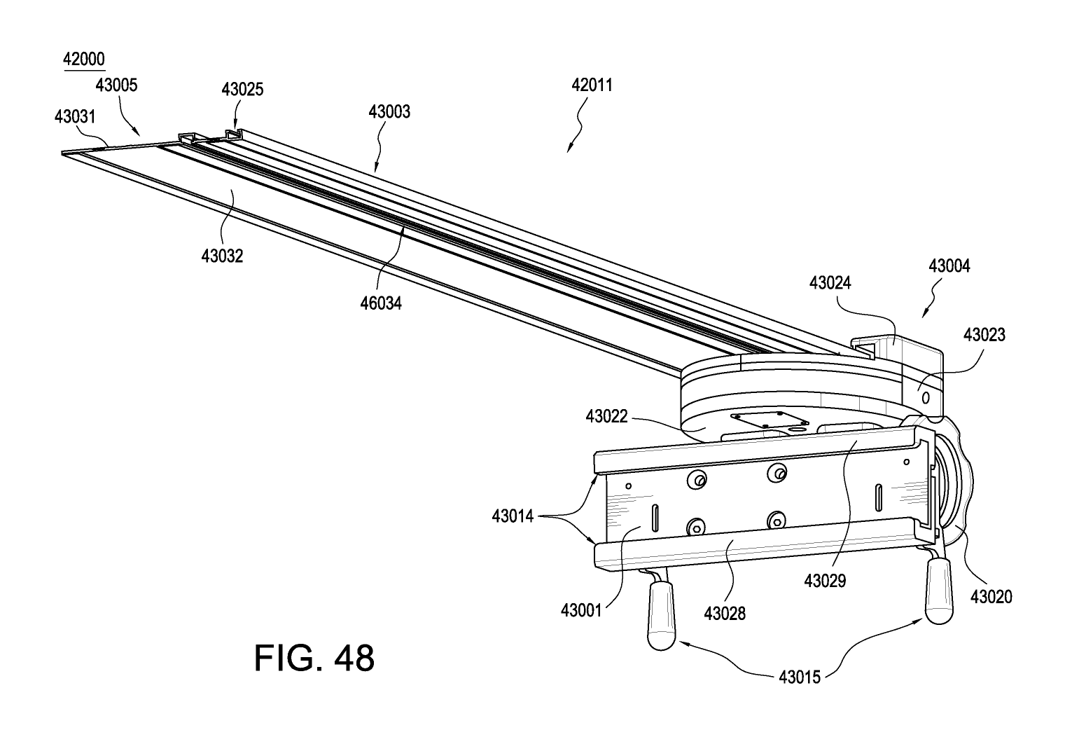

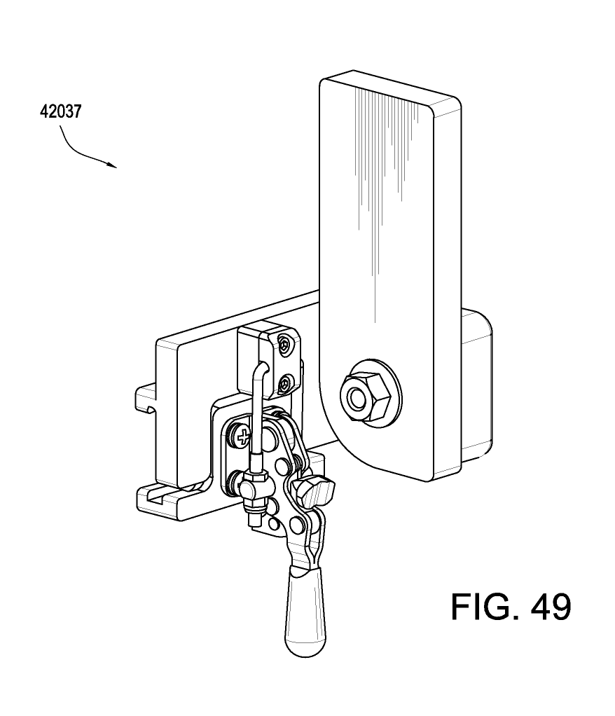

Turning forward in the drawings, for purposes of further illustration, FIG. 48 illustrates a rear, bottom, left side view of tool guide 42011 when tool guide 42011 is decoupled from support structure 42026 (FIG. 42), according to the embodiment of FIG. 42. Further, FIG. 49 illustrates a front, top, left side view of longitudinal index member 42037 when longitudinal index member 42037 is decoupled from support structure 42026 (FIG. 42), according to the embodiment of FIG. 42.

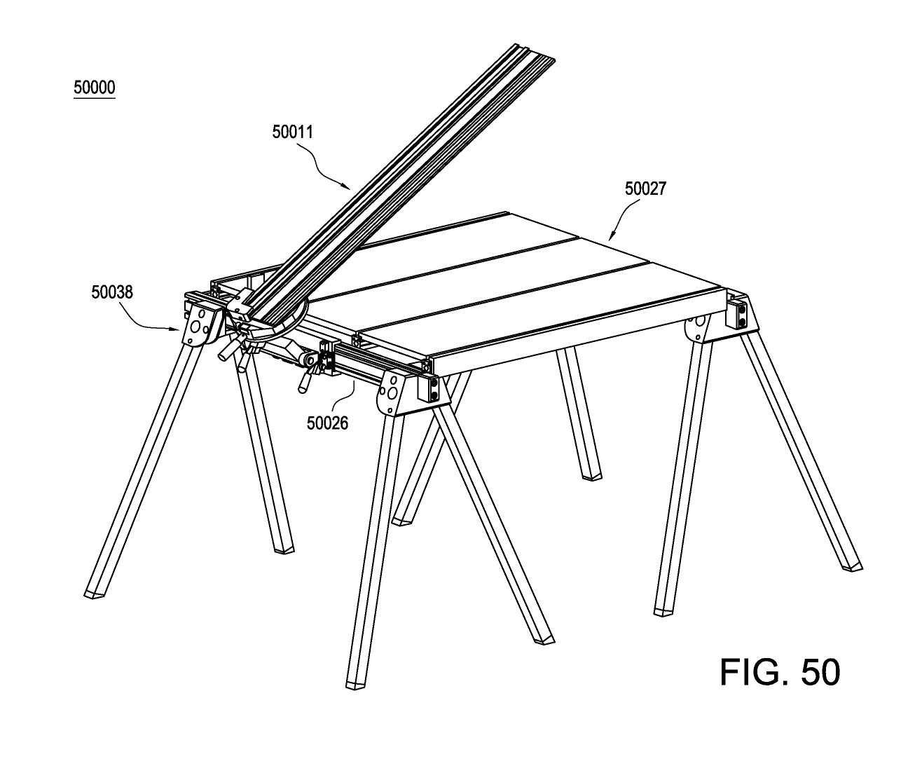

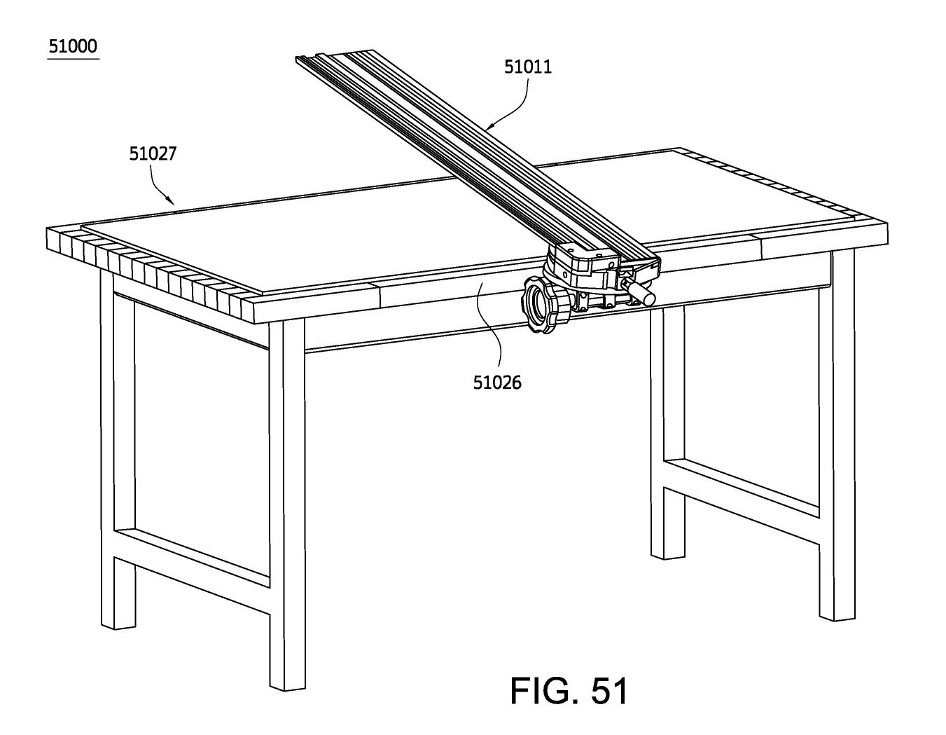

As discussed previously, tool guide 42011 (FIG. 42) and/or index member(s) 42012 (FIG. 42) can be coupled to any suitable structure. Accordingly, FIG. 50 illustrates tool guide 50011 of system 50000 coupled to support structure 50026 of saw horse 50038, according to an embodiment. System 50000 can be similar or identical to system 42000 (FIG. 42); tool guide 50011 can be similar or identical to tool guide 42011 (FIG. 42); and/or support structure 50026 can be similar or identical to 42026 (FIG. 42). Saw horse 50038 can be part of work table 50027, which can be similar or identical to work table 42027 (FIG. 42). Meanwhile, FIG. 51 illustrates tool guide 51011 of system 51000 coupled to support structure 51026 of work table 51027, according to an embodiment. System 51000 can be similar or identical to system 42000 (FIG. 42); and tool guide 51011 can be similar or identical to tool guide 42011 (FIG. 42). Meanwhile, support structure 51026 can be similar to 42026 (FIG. 42); and work table 51027 can be similar to work table 42027 (FIG. 42). Notably however, support structure 51026 and/or work table 51027 can be devoid of coupling receiver(s) like those described above with respect to support structure 42026 (FIG. 42) and/or work table 42027 (FIG. 42).

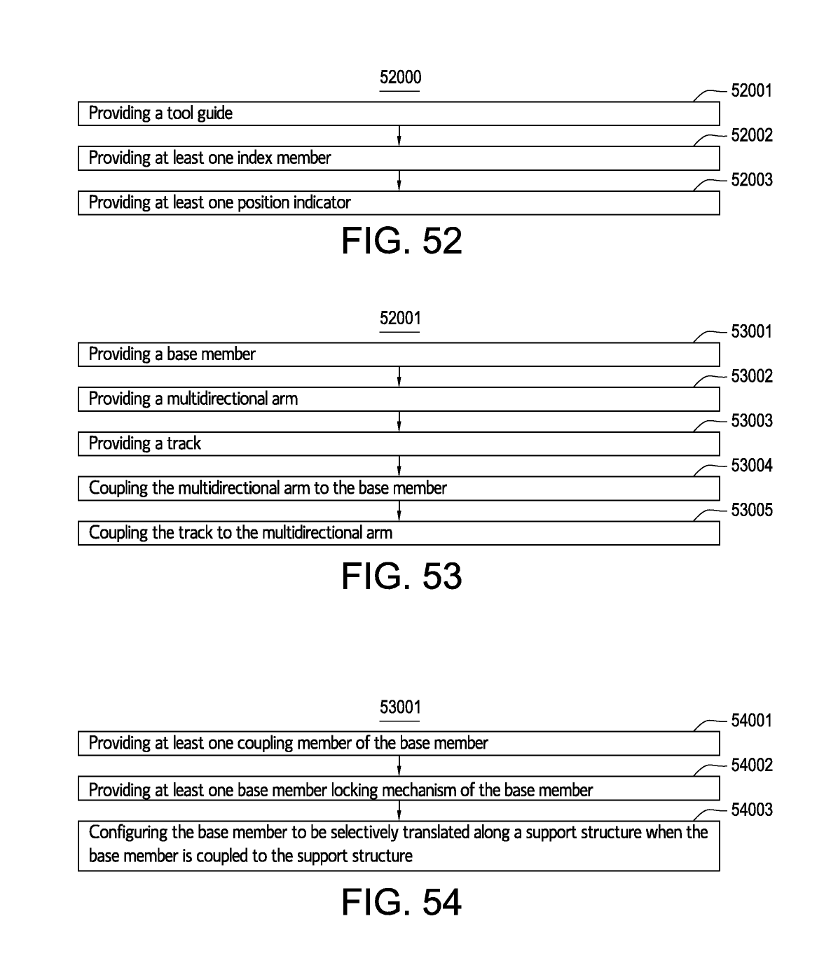

Now, turning ahead again in the drawings, FIG. 52 illustrates a flow chart for an embodiment of method 52000 of providing a system. Method 52000 is merely exemplary and is not limited to the embodiments presented herein. Method 52000 can be employed in many different embodiments or examples not specifically depicted or described herein. In some embodiments, the activities, the procedures, and/or the processes of method 52000 can be performed in the order presented. In other embodiments, the activities, the procedures, and/or the processes of method 52000 can be performed in any other suitable order. In still other embodiments, one or more of the activities, the procedures, and/or the processes in method 52000 can be combined or skipped.

The system can be similar or identical to system 42000 (FIG. 42), system 50000 (FIG. 50) and/or system 51000 (FIG. 51) For example, the system can comprise a working plane and a reference frame. The working plane can be similar or identical to working plane 42006 (FIG. 42) and/or the reference frame can be similar or identical to reference frame 42007 (FIG. 42). For example, the reference frame can comprise an x-axis similar or identical to x-axis 42008 (FIG. 42), a y-axis similar or identical to y-axis 42009 (FIG. 42), and a z-axis similar or identical to z-axis 42010 (FIG. 42).

Method 52000 can comprise activity 52001 of providing a tool guide. The tool guide can be similar or identical to tool guide 42011 (FIG. 42), tool guide 50011 (FIG. 50), and/or tool guide 51011 (FIG. 51). FIG. 53 illustrates an exemplary activity 52001, according to the embodiment of FIG. 52.

For example, activity 52001 can comprise activity 53001 of providing a base member. The base member can be similar or identical to base member 43001 (FIG. 43). FIG. 54 illustrates an exemplary activity 53001, according to the embodiment of FIG. 52.

For example, activity 53001 can comprise activity 54001 of providing at least one coupling member of the base member. The coupling member(s) can be similar or identical to coupling member(s) 43014 (FIG. 43).

Further, activity 53001 can comprise activity 54002 of providing at least one base member locking mechanism of the base member. The base member locking mechanism(s) can be similar or identical to base member locking mechanism(s) 43015 (FIG. 43). In some embodiments, activity 54002 can be omitted.

Further still, activity 53001 can comprise activity 54003 of configuring the base member to be selectively translated along a support structure when the base member is coupled to the support structure. The support structure can be similar or identical to support structure 42026 (FIG. 42), support structure 50026 (FIG. 50), and/or support structure 51026 (FIG. 51). In some embodiments, activity 54003 can be omitted.

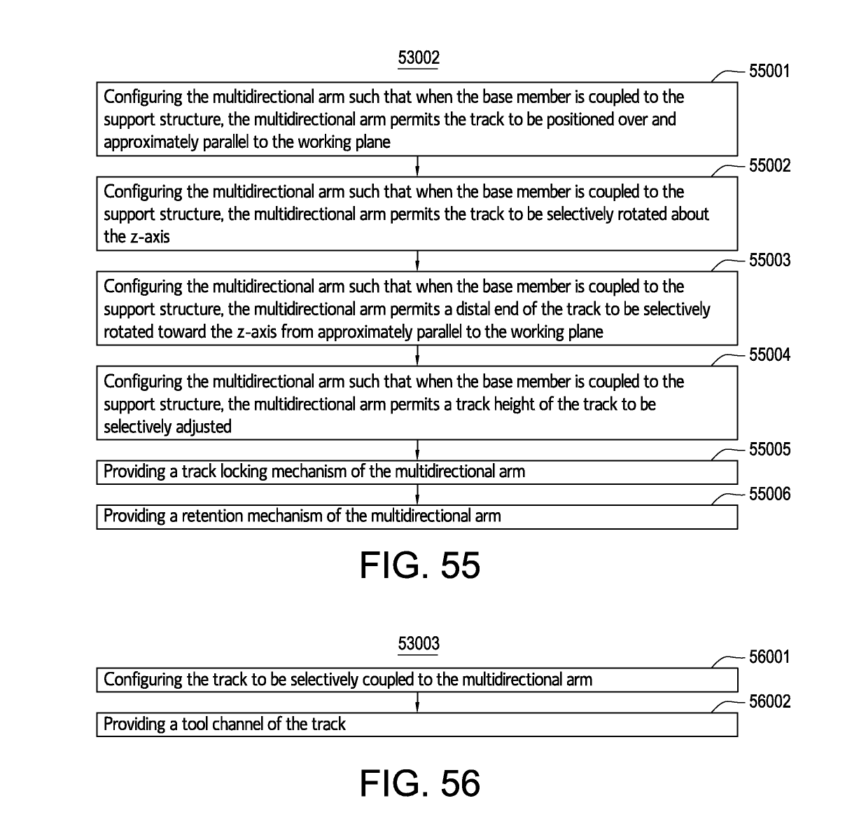

Referring now back to FIG. 53, activity 52001 can comprise activity 53002 of providing a multidirectional arm. The multidirectional arm can be similar or identical to multidirectional arm 43002 (FIG. 42). FIG. 55 illustrates an exemplary activity 53002, according to the embodiment of FIG. 52.

For example, activity 53002 can comprise activity 55001 of configuring the multidirectional arm such that when the base member is coupled to the support structure, the multidirectional arm permits the track to be positioned over and approximately parallel to the working plane.

Further, activity 53002 can comprise activity 55002 of configuring the multidirectional arm such that when the base member is coupled to the support structure, the multidirectional arm permits the track to be selectively rotated about the z-axis.

Further still, activity 53002 can comprise activity 55003 of configuring the multidirectional arm such that when the base member is coupled to the support structure, the multidirectional arm permits a distal end of the track to be selectively rotated toward the z-axis from approximately parallel to the working plane. The distal end can be similar or identical to distal end 43005 (FIG. 43).

In some embodiments, activity 53002 also can comprise activity 55004 of configuring the multidirectional arm such that when the base member is coupled to the support structure, the multidirectional arm permits a track height of the track to be selectively adjusted. The track height can be similar or identical to the track height described above with respect to system 42000 (FIG. 42). In some embodiments, activity 55004 can be omitted.

In various embodiments, activity 53002 can comprise activity 55005 of providing a track locking mechanism of the multidirectional arm. The track locking mechanism can be similar or identical to track locking mechanism 46033 (FIG. 46). In some embodiments, activity 55005 can be omitted.

In further embodiments, activity 53002 can comprise activity 55006 of providing a retention mechanism of the multidirectional arm. The retention mechanism can be similar or identical to retention mechanism 43024 (FIG. 43). In some embodiments, activity 55006 can be omitted.

Referring now back to FIG. 53, activity 52001 can comprise activity 53003 of providing a track. The track can be similar or identical to track 43003 (FIG. 43). FIG. 56 illustrates an exemplary activity 53003, according to the embodiment of FIG. 52.

For example, activity 53003 can comprise activity 56001 of configuring the track to be selectively coupled to the multidirectional arm, such as, for example, by the track locking mechanism. In some embodiments, activity 56001 can be omitted.

Further, activity 53003 can comprise activity 56002 of providing a tool channel of the track. The tool channel can be similar or identical to tool channel 43025 (FIG. 43).

Meanwhile, referring once again to FIG. 53, in some embodiments, activity 52001 can comprise activity 53004 of coupling the multidirectional arm to the base member. In these embodiments, activity 53004 can be performed in a manner similar or identical to the manner of coupling multidirectional arm 43002 (FIG. 43) to base member 43001 (FIG. 43), as described above.

Activities 53001 through 53003 can be performed in any suitable order and/or approximately simultaneously with each other. In some embodiments, activities 53001, 53002, and/or 53003 can be performed as part of the same activity.

Also, in some embodiments, activity 52001 can comprise activity 53005 of coupling the track to the multidirectional arm. In these embodiments, activity 53005 can be performed in a manner similar or identical to the manner of coupling track 43003 (FIG. 43) to multidirectional arm 43002 (FIG. 43), as described above. In some embodiments, activity 53004 and/or activity 53005 can be omitted. In further embodiments, activity 53004 can be performed before, after, or approximately simultaneously with activity 53005.

Turning now back to FIG. 52, in some embodiments, method 52000 can comprise activity 52002 of providing at least one index member. The index member(s) can be similar or identical to index member(s) 42012 (FIG. 42). In some embodiments, activity 52002 can be omitted.

Further, method 52000 can comprise activity 52003 of providing at least one position indicator. The position indicator(s) can be similar or identical to the position indicator(s) described above with respect to system 42000 (FIG. 42). In some embodiments, activity 52003 can be performed as part of activity 52001. In some embodiments, activity 52003 can be omitted.

Methods of providing and/or using the work tables (e.g., work table 100 (FIG. 1), work table 700 (FIG. 6), work table 2300 (FIG. 23), and/or work table 26048 (FIG. 26)), cross members (e.g., cross member 120A-120E (FIGS. 2-6), cross member 27052), base structures (e.g., base structure 39099) and/or systems (e.g., system 24000 (FIG. 24) and/or system 40000 (FIG. 40) described herein, and any of their constituent elements, are also disclosed. Further, methods of providing systems 42000 (FIG. 42), 50000 (FIG. 50), and/or 51000 (FIG. 51) described herein, and any of their constituent elements, are also disclosed. These methods can be employed in many different embodiments or examples not specifically depicted or described herein. In some embodiments, the activities, the procedures, and/or the processes of these methods can be performed in any other suitable order. In further embodiments, one or more of the activities, the procedures, and/or the processes in these methods can be combined or skipped.

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that the methods described herein may be comprised of many different activities, procedures, and/or processes, be performed by many different modules, and in many different orders, that any element of FIGS. 1-56 may be modified, and that the foregoing discussion of certain of these embodiments does not necessarily represent a complete description of all possible embodiments.

All elements claimed in any particular claim are essential to the embodiment claimed in that particular claim. Consequently, replacement of one or more claimed elements constitutes reconstruction and not repair. Additionally, benefits, other advantages, and solutions to problems comprise been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
a base member configured to be coupled to a support structure;
a multidirectional arm coupled to the base member; and
a track coupled to the multidirectional arm, the track being configured to receive a tool and comprising a proximal end and a distal end opposite the proximal end;
a working plane; and
a reference frame comprising an x-axis, a y-axis, and a z-axis;
wherein:
the x-axis and the y-axis are approximately perpendicular to each other and approximately parallel to the working plane;
the z-axis is approximately perpendicular to the x-axis, the y-axis, and the working plane; and
when the base member is coupled to the support structure:
the multidirectional arm permits the track to be positioned over and approximately parallel to the working plane;
the multidirectional arm permits the track to be selectively rotated about the z-axis; and
the multidirectional arm permits the distal end of the track to be selectively rotated toward the z-axis from approximately parallel to the working plane.

2. The system of claim 1 wherein:
when the base member is coupled to the support structure, the multidirectional arm permits a track height of the track to be selectively adjusted, the track height approximately being a distance of the track over the working plane when the track is approximately parallel to the working plane.

3. The system of claim 1 wherein:
the base member comprises at least one coupling member; and
the support structure comprises at least one coupling receiver configured to receive the at least one coupling member to couple the base member to the support structure.

4. The system of claim 3 wherein at least one of:
the base member comprises at least one base member locking mechanism configured to selectively secure the at least one coupling member in the at least one coupling receiver; or
the base member is configured to be selectively translated along the support structure when the base member is coupled to the support structure.

5. The system of claim 1 wherein at least one of:
the track is configured to be selectively coupled to the multidirectional arm; or
the multidirectional arm comprises a track locking mechanism configured to selectively secure the track to the multidirectional arm when the track is coupled to the multidirectional arm.

6. The system of claim 1 wherein:
the track comprises a tool channel configured to receive the tool when the track receives the tool and to permit the tool to be translated along the track.

7. The system of claim 6 wherein at least one of:
the tool channel extends from the distal end of the track toward the proximal end of the track; or
the tool channel extends substantially from the distal end of the track to the proximal end of the track.

8. The system of claim 1 further comprising:
at least one index member configured to be coupled to the support structure and to permit a work piece to be indexed with respect to the track.

9. The system of claim 1 wherein:
the tool comprises an electrical saw.

10. A method of providing a system, the system comprises a working plane and a reference frame comprising an x-axis, a y-axis, and a z-axis, the x-axis and the y-axis being approximately perpendicular to each other and approximately parallel to the working plane, and the z-axis being approximately perpendicular to the x-axis, the y-axis, and the working plane, the method comprising:
providing a base member configured to be coupled to a support structure;
providing a multidirectional arm;
coupling the multidirectional arm to the base member;
providing a track, the track being configured to receive a tool and comprising a proximal end and a distal end opposite the proximal end; and
coupling the track to the multidirectional arm;
wherein:
providing the multidirectional arm comprises configuring the multidirectional arm such that when the base member is coupled to the support structure:
the multidirectional arm permits the track to be positioned over and approximately parallel to the working plane;
the multidirectional arm permits the track to be selectively rotated about the z-axis; and
the multidirectional arm permits the distal end of the track to be selectively rotated toward the z-axis from approximately parallel to the working plane.

11. The method of claim 10 wherein:
providing the multidirectional arm comprises configuring the multidirectional arm such that when the base member is coupled to the support structure, the multidirectional arm permits a track height of the track to be selectively adjusted, the track height approximately being a distance of the track over the working plane when the track is approximately parallel to the working plane.

12. The method of claim 10 wherein:
providing the base member comprises providing at least one coupling member of the base member, the at least one coupling member being configured to be received by at least one coupling receiver of the support structure to couple the base member to the support structure.

13. The method of claim 10 wherein:
providing the base member comprises providing at least one base member locking mechanism of the base member, the at least one base member locking mechanism being configured to selectively secure the at least one coupling member in the at least one coupling receiver.

14. The method of claim 10 wherein:
providing the base member comprises configuring the base member to be selectively translated along the support structure when the base member is coupled to the support structure.

15. The method of claim 10 wherein at least one of:
providing the track comprises configuring the track to be selectively coupled to the multidirectional arm; or
providing the multidirectional arm comprises providing a track locking mechanism of the multidirectional arm, the track locking mechanism being configured to selectively secure the track to the multidirectional arm when the track is coupled to the multidirectional arm.

16. The method of claim 10 wherein:
providing the multidirectional arm comprises providing a retention mechanism of the multidirectional arm, the retention mechanism being operable to substantially maintain the tool at the track when the distal end of the track is rotated toward the z-axis and the tool is received at the track.

17. The method of claim 10 wherein:
providing the track comprises providing a tool channel of the track, the tool channel being configured to receive the tool when the track receives the tool and to permit the tool to be translated along the track.

18. The method of claim 10 further comprising:
providing at least one index member configured to be coupled to the support structure and to permit a work piece to be indexed with respect to the track.

19. A system comprising:
a tool guide, the tool guide comprising:
a base member configured to be coupled to a support structure, the base member comprises at least one coupling member and the support structure comprises at least one coupling receiver configured to receive the at least one coupling member to couple the base member to the support structure;
a multidirectional arm coupled to the base member; and
a track coupled to the multidirectional arm, the track being configured to receive a tool and comprising a proximal end and a distal end opposite the proximal end;
a working plane; and
a reference frame comprising an x-axis, a y-axis, and a z-axis;
wherein:
the x-axis and the y-axis are approximately perpendicular to each other and approximately parallel to the working plane;
the z-axis is approximately perpendicular to the x-axis, the y-axis, and the working plane; and
when the base member is coupled to the support structure:
the multidirectional arm permits the track to be positioned over and approximately parallel to the working plane;
the multidirectional arm permits the track to be selectively rotated about the z-axis;
the multidirectional arm permits the distal end of the track to be selectively rotated toward the z-axis from approximately parallel to the working plane;
the multidirectional arm permits a track height of the track to be selectively adjusted, the track height approximately being a distance of the track over the working plane when the track is approximately parallel to the working plane; and
the base member is configured to be selectively translated along the support structure.

20. The system of claim 19 further comprising:
at least one position indicator;
wherein the at least one position indicator comprises at least one of:
a first position indicator configured to indicate a first angular orientation of the track about the z-axis;
a second position indicator configured to indicate a second angular orientation of the track about the x-axis;
a third position indicator configured to indicate the track height; or
a fourth position indicator configured to indicate a translational position of the base member with respect to the support structure.
